(19) United States
(12) Patent Application Publication
(10) Pub. No.: US 2020/0233504 A1
(43) Pub. Date: Jul. 23, 2020

(54) METHOD AND DEVICE AND SYSTEM FOR PROVIDING DUAL MOUSE SUPPORT

(71) Applicant: INVENTRANS BVBA, Bilzen Limburg (BE)

(72) Inventor: Lambert JACOBS, Bilzen Limburg (BE)

(21) Appl. No.: 16/650,085

(22) PCT Filed: Sep. 24, 2018
(86) PCT No.: PCT/EP2018/075838

§ 371 Date: Mar. 24, 2020

(30) Foreign Application Priority Data
Sep. 29, 2017 (BE) 2017/5694
Sep. 29, 2017 (BE) 2017/5695
Dec. 4, 2017 (BE) 2017/5895
Dec. 4, 2017 (BE) 2017/5896
Dec. 4, 2017 (BE) 2017/5897
Dec. 4, 2017 (BE) 2017/5899
Feb. 21, 2018 (EP) 18157956.6
Mar. 11, 2018 (EP) 18161127.8
Mar. 25, 2018 (EP) 18163824.8

(51) Int. Cl. G06F 3/0354; G06F 3/038; G06F 9/451

(52) U.S. Cl. CPC G06F 3/03543; G06F 2203/0382; G06F 9/451; G06F 3/038

(57) ABSTRACT

A computer implemented method for providing at least a first visible object movable by a first pointer device, and at least one other visible object separately movable by a second pointer device, said first and second pointer device being connected to a computer device running an operating system O/S with a graphical user interface GUI that provides a native mouse cursor, the method comprising: a) configuring the O/S and GUI to provide said native mouse cursor as the first visible object; b) providing a graphical overlay window comprising said at least one other visible object; c) configuring said graphical overlay window in click-through mode; e) adjusting a position of the first/second visible object in accordance with movements of the first/second pointer device. A computer program product for performing said method. A computer device comprising said computer program product. A computer system.

### FIELD OF THE INVENTION

The present invention relates in general to the field of computers with a Graphical User Interface and multiple pointer devices. More particularly, the present invention relates to a computer system, a computer device, a computer implemented method, and a computer program product for providing dual mouse support, and to a mouse device, and an adaptor or hub or dongle, and to a display device, and to a video interface device, and to a kit of parts.

### Background of the Invention

FIG. 1 shows a schematic block diagram of a classical computer system 100 comprising a computer device 101 (e.g. a desktop computer) having a keyboard input connected to a keyboard device 102, and having a mouse input connected to a mouse device 103, and having a video output connected to a display or monitor or screen 104. The computer device 101 of FIG. 1 comprises one or more Central Processing Units (CPU) running an operating system O/S with a Graphical User Interface GUI, such as for example Windows 7 or Windows 10 from Microsoft Corporation, or macOS 10.12 Sierra or macOS 10.13 High Sierra from Apple Inc. In the example of FIG. 1, the computer 101 is also running two applications: a PDF document viewer 107a (e.g. Acrobat Reader) shown on the left side of the screen 104, and a text editor 107b (e.g. Microsoft Word) shown on the right side of the screen 104.

Such a system 100 can for example be used by a translator or a proofreader for simultaneously viewing a source document, for example a granted European patent document having English, French and German claims, and a translation of the claims into another language (e.g. Dutch or Spanish or Italian). Although the translation itself would typically be performed using a CAT tool (Computer Aided Translation), the step of final proofreading is preferably performed by comparing the original PDF-document and the final text document, or if the final document is also converted into a PDF document, by comparing the two PDF documents.

When proofreading (or verifying and/or correcting the translation), the translator or proofreader needs to constantly shift his focus back and forth between the visual representations of the two documents 107a, 107b, and needs to constantly re-acquire the current context in each of these documents, which is time consuming and mentally demanding. This cognitive burden can be lowered for example by physically pointing to the words of the source text using a finger of the non-dominant hand, and by pointing to corresponding words of the target text using the mouse cursor 105, which can be moved on the screen by physically moving the mouse device 103 held in the dominant hand, as shown in FIG. 1 for a right handed person. A left handed person would typically move the mouse with his left hand, and point to the screen with his right hand.

But this process is not ideal, inter alia because the arm cannot always rest on the table, especially with larger screen sizes, or with screens mounted above the table. Furthermore, when a translation error is found, and a correction needs to be made, both hands are typically brought to the keyboard 102 for typing, so that the context is lost again and needs to be re-acquired after the correction is made. It would be advantageous if the computer system 100 would provide a mechanism that allows a user to easily switch focus between two reading locations on the screen 104, which locations can easily and intuitively be moved.

FIG. 2 illustrates another problem. When reading a document, a user typically uses the mouse cursor to point to the words he is currently reading. When the person wants to highlight or underline some words or add comments, the mouse cursor typically needs to be moved to the top of the screen, where the user needs to click in order to select a highlighting color, or a typewriter tool, or a comment box, etc., but by doing so, the context of where he was reading is lost, and the context needs to be re-acquired, which is time consuming. It would be advantageous if the computer system 200 would provide a mechanism that allows a user to easily switch focus between a reading location and a working location, which locations can easily and intuitively be moved.

FIG. 3 illustrates another problem. When writing or reviewing certain texts (for example claims of a patent application), it may be desirable to compare two different portions of a single text document, for example a first portion containing product claims and a second portion containing method claims. In practice, the user may want to amend either text portion, which is relatively easy for the lower text portion of the example shown in FIG. 3, because that is where the mouse cursor 305 is situated, but is not easy for the upper text portion, where the finger is situated. The user may swap the position of the finger and the mouse cursor, but that is not easy in practice without re-acquiring the context at both locations, which is time consuming. It would be advantageous if the computer system 300 would provide a mechanism that allows a user to easily switch between two different locations on screen, for reading and/or for editing, which locations can easily and intuitively be moved.

FIG. 4 illustrates another problem. When transcribing an audio fragment (i.e. converting spoken text into a written document), a user may use an audio player application (e.g. VLC Media Player) to play an audio fragment using a start/stop button, and a text editor application for typing the corresponding text information. Using known computers, the user would typically move the mouse cursor to the audio player, click on the audio player window 417 to activate the audio player application, click on the start button, allow the audio player to play for a few seconds, click on the start/pause button to pause the audio player, move the mouse cursor to the text editor, click the text editor window to activate the text editor application, optionally click again to reposition the mouse cursor in the text document, type the corresponding text using the keyboard, move the mouse cursor 405 back to the audio player, and repeat the same steps again and again until the audio fragment is completely transcribed. Moving the mouse cursor 405 back and forth between the start/stop button of the audio player 417 and the current position in the text editor 407 is time consuming, especially since the mouse cursor needs to be positioned accurately in order not to click on the wrong button, for example a rewind button, because an accidental click on this button would cost even more time, because the user would have to find the audio fragment back. It would be advantageous if the computer system 400 would provide a mechanism that allows the user to work at two different screen locations using his both hands, especially if one of these locations has a substantially fixed position on the screen.

### SUMMARY OF THE INVENTION

It is an object of the present invention to provide a computer system that supports two pointer devices, and/or parts thereof, such as e.g. an overlay application, a computer program product, a computer device, a kit of parts, a pointer device, a hub, a display device and a video adapter device.

It is an object of embodiments of the present invention to provide a mechanism to enhance or extend the functionality of a computer device running an operating system (O/S) with a graphical user interface (GUI) so as to support two pointer devices instead of only one.

It is an object of embodiments of the present invention to provide a computer implemented method for enhancing or extending the functionality of an O/S and GUI, for example an existing O/S and GUI that provides a single native mouse cursor or mouse pointer and maintains a single native cursor position, so as to show two visible objects and to maintain two object positions, which objects are individually movable by means of two pointer devices.

It is an object of embodiments of the present invention to provide a computer implemented method for enhancing or extending the functionality of an O/S and GUI, for example an existing O/S and GUI that provides a single native mouse cursor or mouse pointer and maintains a single native cursor position, so as to show at least two visible objects and to maintain at least two object positions, which objects are individually movable by means of at least two pointer devices.

It is an object of particular embodiments of the present invention to provide such a computer implemented method, where one of said visible objects is the native mouse cursor or mouse pointer provided by the O/S and GUI.

It is an object of particular embodiments of the present invention to provide such a computer implemented method which is responsive to movements of said at least two pointer devices.

It is an object of particular embodiments of the present invention to provide such a computer implemented method which is responsive to movements of said at least two pointer devices, and/or to button presses and button releases and button clicks of one or both of said pointer devices, and/or to scrollwheel movements of one or both of said pointer devices.

It is an object of particular embodiments of the present invention to provide such a computer implemented method for enhancing the functionality of the Windows operating system from Microsoft Corporation, headquartered in Redmond, Wash., e.g. Windows 7 or Windows 10 or later versions of Windows having the same or similar functionality regarding graphical overlay.

It is an object of particular embodiments of the present invention to provide such a computer implemented method for enhancing the functionality of the macOS from Apple Inc. headquartered in Cupertino, Calif., US, e.g. macOS Sierra or macOS High Sierra or later versions of mac OS having the same or similar functionality regarding graphical overlay.

It is an object of particular embodiments of the present invention to provide such a computer implemented method, wherein the dual mouse functionality is provided as a graphical overlay application.

It is also an object of the present invention to provide a computer program product for performing said method, and to provide a computer device comprising such a computer program product and/or performing such a method, and to provide a computer system comprising such a computer device, and to provide a pointer device (e.g. a USB mouse device or an RF mouse device) particularly suitable for use in such a computer system, and to provide an adaptor or a hub or a dongle (e.g. a USB hub or RF dongle) particularly suitable for use in such a computer system.

It is also an object of particular embodiments of the present invention to provide a computer system comprising a computer device operatively connected to a first pointer device, and a display device operatively connected to a second pointer device.

It is also an object of particular embodiments of the present invention to provide a computer system comprising a computer device operatively connected to a first pointer device, and a display device, and a video adapter device operatively connected to a second pointer device.

It is also an object of particular embodiments of the present invention to provide a computer implemented method, wherein dual mouse functionality is provided to an application, running on a computer having an operating system that supports only a single native mouse cursor, and having classical mouse drivers which route all mouse events to the single native mouse cursor.

It is also an object of particular embodiments of the present invention to provide a computer implemented method, running on a computer device operatively connected to two display panels, and operatively connected to at least one pointer device, which allows easier movement of the mouse cursor from one display panel to the other display panel.

It is also an object of particular embodiments of the present invention to provide a computer program product for performing such a method, and to a computer device comprising such computer program product, and to a computer system comprising such a computer device.

These and other objectives are accomplished by a computer implemented method, a computer program product, a computer device, a computer system, a pointer device, an adaptor or hub or dongle, a display device and a video adapter device according to embodiments of the present invention.

According to a 1st aspect, the present invention provides a computer implemented method for providing at least two visible objects comprising a first visible object and at least one other visible object, the first visible object movable by a first pointer device and the at least one other visible object separately movable by a second pointer device, said first pointer device and said second pointer device being connected to a computer device running an operating system with a graphical user interface that provides a native mouse cursor; the method comprising the steps of: a) configuring the operating system with the graphical user interface to provide said native mouse cursor as the first visible object; b) providing a graphical overlay window comprising said at least one other visible object; c) configuring said graphical overlay window in click-through mode; e) adjusting a position of the first visible object in accordance with movements of the first pointer device; and adjusting a position of the at least one other visible object in accordance with movement of the second pointer device.

The first pointer device may be operable by a dominant hand of a user, the second pointer device may be operable by a non-dominant hand of the same user.

Configuring the O/S to provide said single native mouse cursor may comprise allowing the O/S to provide said single native mouse cursor, e.g. by not hiding the native mouse cursor.

It is an advantage that this method in combination with an O/S and GUI (with only a single native mouse cursor or pointer) provide two (or more) visible objects individually or separately movable by two separate pointer devices. In other words, it is an advantage that this method extends the functionality of an O/S and GUI to support two pointer devices.

Providing an “overlay window” means that said window is to be located substantially “on top” of other applications (such as most desktop applications) which are not configured as being “on top”.

The overlay window is configured in “click through mode” meaning that the O/S is instructed not to provide pointer events such as e.g. mouse movements and mouse clicks to the overlay application, but to an “underlying application”, i.e. to an application having a window with a lower Z-order than the overlay window. This offers the advantage that the underlying application(s) react to mouse events as if the overlay window was not there.

It is an advantage of showing the native mouse cursor as one of the visible objects and that the graphical overlay window is configured in click-through mode, because doing so allows backwards compatible behaviour for most or all existing applications that change the look & feel of the native mouse cursor. For example, as is known in the art, the mouse cursor can assume different shapes depending on the context, for example as an “arrow” when moving over a picture, or as a so called “crosshair” (looking like a roman number “I”) when moving over a text area, or as a “hand” when moving over an object that can be dragged, etc. This is a huge advantage over an application that would hide the native mouse cursor or replace that cursor with another object having a fixed shape.

It is a huge advantage that this method works with an existing O/S with GUI (e.g. windows 7 or windows 10), and that no special O/S and GUI needs to be provided.

It is an advantage that this method does not require a special mouse driver.

It is an advantage that this method works with existing applications (such as text editors, spreadsheets, web-browsers, etc.), and that these applications need not be modified in any way.

Given the vast amount of computer users, and the large amount of software companies, it is amazing that a relatively simple method can transform a computer device with an O/S and GUI developed for only a single mouse cursor into a computer device with an O/S and GUI with dual mouse support, which can help make life easier for many professional users, such as e.g. translators, transcribers, reviewers, proofreaders, technical writers, teachers, etc., by offering a technical solution to re-acquire the current context when switching back and forth between two documents, or when switching between two different locations inside a single document.

The idea of attaching multiple pointer devices to a single computer is known for more than two decades, and many people have tried to solve this problem in different ways. However, only few of them succeeded, and those that succeeded seem to have solved the problem at the device layer, not at the application layer. There seems to be prejudice in the field that this problem must be solved at the device layer, and cannot be solved at the application layer, or at least that a good and satisfactorily solution cannot be found at the application layer.

This method is particularly useful for professional computer users working with both hands on a single computer device.

Some embodiments of the method provide a mechanism that allows a user to easily switch focus between two reading locations on one or more screens, which locations can easily and intuitively be moved

Some embodiments of the method provide a mechanism that allows a user to easily switch focus between a reading location and a working location on one or more screens, which locations can easily and intuitively be moved

Some embodiments of the method provide a mechanism that allows a user to easily switch focus between two different locations on screen, for reading and/or for editing, which locations can easily and intuitively be moved

Some embodiments of the method provide a mechanism that allows the user to work at two different screen locations using both hands where “reading” means that the user only needs to easily see and/or find and/or move this location by moving the pointer device(s), and where “working” means that the user not only needs to be able to move the pointer device(s) but also needs to be able to click and/or scroll one or both pointer device(s).

In other words, games allowing simultaneously use of two pointer devices is not the main purpose of the present invention, and neither are network applications where multiple users each control a respective pointer device. The present invention is primarily intended for a “single user using both hands”, where typically one hand is the dominant hand, and the other hand is the non-dominant hand.

This method can for example be implemented as a stand-alone overlay application comprising said graphical overlay window, and optionally further comprising a user-interface window, although the latter is not absolutely required.

It is known that some versions of the Windows operating system (Windows 10 or lower) allow multiple USB mice to be connected to the computer, e.g. two USB-mice, if the computer device has at least two USB-ports, but these Windows versions provide only a single mouse cursor. If multiple pointer devices are connected to the computer, the Windows O/S directs all movement events from any pointer device to the same mouse cursor. However, when combined with the method of the present invention, it appears for a user that the Windows O/S support two pointer devices. Thus the method of the present invention can be used as an extension or as an add-on application for providing “dual mouse functionality”, not just for one specific application (such as a game application), but to most existing desktop applications.

It is an advantage that this overlay application only needs to adjust the position of the native mouse cursor of the O/S, but does not have to implement other functionality, such as clicking, dragging, scrolling the mouse wheel, etc.

It is an advantage that the switching between the two locations happens automatically by merely moving the corresponding pointer device, without having to take special actions. This make the switching very fast and very intuitive.

In an embodiment, the present invention provides a computer implemented method for providing a first visible object movable by a first pointer device, and a second visible object separately movable by a second pointer device.

In this embodiment, the second visible object can be seen as the at least one other visible object.

In this embodiment, the first visible object is preferably moved substantially independent of movements of the second pointer device, apart from some transient effects. Likewise, the second visible object is preferably moved substantially independent of movements of the first pointer device, apart from some transient effects.

In an embodiment, the present invention provides a computer implemented method for providing a first visible object and a second visible object and a third visible object, the third visible object movable by a first pointer device; the second visible object separately movable by a second pointer device; the first visible object selectively movable by any of the first pointer device and the second pointer device whichever is most recently moved and/or asserted; and wherein step b) comprises: providing a graphical overlay window comprising said second visible object and said third visible object.

With movements is meant for example horizontal and/or vertical movements of the pointer device. With assertion is meant for example a button of the pointer device being pressed or released, or a scrollwheel of the pointer device being scrolled.

In an embodiment, step e) comprises: adjusting a position of the first visible object in accordance with movements and/or assertions of any of the first pointer device and the second pointer device, whichever is most recently moved or asserted; and adjusting a position of the second visible object in accordance with movement of the second pointer device; and adjusting a position of the third visible object in accordance with movements of the first pointer device.

In this embodiment, the first and third visible object are preferably moved substantially independent of movements of the second pointer device, apart from some transient effects. Likewise, the second visible object is preferably moved substantially independent of movements of the first pointer device, apart from some transient effects.

In an embodiment, the method further comprises step d) of: configuring the Operating System to send raw input messages related to the first and second pointer device, and providing a message handler to process these raw input messages; and step e) comprises: adjusting a position of the first visible object based on said raw input messages; and adjusting a position of the at least one other visible object based on said raw input messages.

Thanks to the message handler, the overlay window also receives the mouse events, allowing it to extract movement information of each mouse device. While this approach has advantages, it also has disadvantages, such as for example not being able “to block” click events.

In an embodiment, the positions of the native mouse cursor as well as the second and optionally further visible object(s) is updated inside the message handling routine.

This offers the advantage of a very low response time between movements of the pointer devices and the actual rendering on the screen, however, at the cost of higher CPU load.

In an embodiment, only the position of the native mouse cursor is updated in the message handling routine itself, while the position of the second and/or further visible object is performed outside of the message handling routine, thus asynchronously, e.g. based on a timer interrupt.

In this way the response time of movements of the native mouse cursor is very low, while the response time between movements of the pointer devices and the other visible object(s) is somewhat larger. This offers the advantage of a reduced CPU load, which may be especially advantageous if the second and/or further visible object(s) occupies more than about 50×50=2500 pixels on the screen, or more than 70×70=4900 pixels, or more than 100×100=10000 pixels on the screen.

In an embodiment, step e) comprises:

receiving an input message;
if the received input message is related to the first pointer device, updating a first pointer position; and if the received input message is related to the second pointer device, updating a second pointer position;
adjusting a position of the native mouse cursor and a position of the at least one other visible object in one of the following ways:
α) adjusting the position of the native mouse cursor in accordance with the first position, and adjusting the position of the at least one other visible object in accordance with the second position; or
β) adjusting the position of the native mouse cursor in accordance with the second position, and adjusting the position of the at least another visible object in accordance with the first position; or
γ) depending on whether the input message is related to the first pointer device or the second pointer device:
   adjusting the position of the native mouse cursor in accordance with the first position and adjusting a position of the at least one other visible object in accordance with the second position if the received input message is related to the first pointer device;
   adjusting the position of the native mouse cursor in accordance with the second position and adjusting a position of the at least one other visible object in accordance with the first position if the received input message is related to the second pointer device.

This embodiment described in more detail how input messages are handled to update a first position associated with the first visible object, and the second position associated with the second or third visible object. The input message may be a raw input message related to a movement event, or related to a button being pressed event, or a button being released event, or related to a scrollwheel rotation event.

In an embodiment, step e) comprises: receiving an input message, and in case the input message is a movement message, obtaining displacement values related to said movement message.

In an embodiment, the computer implemented method further comprises: configuring said graphical overlay window as a semi-transparent window having an alpha-blending value (or alpha-transparency value) in the range from 1% to 99% or from 2% to 98% or from 5% to 95%.

In this embodiment the second (and/or further) visible object is semi-transparent, which means that the user can “see through” the object (e.g. a line or a cross or a rectangle or a hand), and thus can see the underlying information (e.g. textual or alphanumerical or graphical information rendered by an underlying text application or spreadsheet application or PDF-document viewer or web-browser, etc.).

It is an advantage that the second (and/or further) visible object does not completely obscure underlying text or numerical information, which typically makes it easier for a user to read said the underlying information, and does not require accurate movements of the pointer device, which is typically more difficult for the non-dominant hand.

In an embodiment, only a minor portion of the area of the overlay window is occupied by the second visible object, and a major portion of the area of the overlay window is occupied by fully transparent pixels.

The second visible object may for example occupy less than 20% or less than 10% or less than 5% of the area of the overlay window.

The second visible object may be or may contain an opaque image.

The second visible object may contain a bitmap with a first plurality of pixels which are opaque and a second plurality of pixels which are fully transparent, the first and second plurality of pixels being interleaved, for example according to a regular pattern, for example according to a checkerboard pattern (as described in more detail in the co-pending “perforated bitmap” application, see e.g. FIG. 37 and FIG. 39 thereof).

A major portion of the pixels of the overlay window, for example at least 70% of these pixels may be fully transparent pixels. In an embodiment where the overlay window only contains the second visible object (and no further visible objects), preferably all pixels which do not belong to the second visible object are fully transparent pixels.

In an embodiment, the method is implemented in an overlay application, and the overlay application has an input mode selected from or selectable from a first input mode (e.g. RightHanded) and/or a second input mode (e.g. LeftHanded) and/or a third input mode (e.g. BothHanded); and step e) comprises one or two or all of the following options:

in case the overlay application is configured in the first input mode (e.g. RightHanded) adjusting a position of the native mouse cursor in accordance with the first position;
in case the overlay application is configured in the second input mode (e.g. LeftHanded) adjusting a position of the native mouse cursor in accordance with the second position;
in case the overlay application is configured in the third input mode (e.g. BothHanded) selectively adjusting a position of the native mouse cursor in accordance with the first position if the received input message is related to a movement message from the first pointer device, and adjusting said position in accordance with the second position if the received input message is related to a movement message from the second pointer device.

In some embodiments, the input mode may be predefined, for example hardcoded for right-handed people or for left-handed people.

In some embodiments, the input mode may be configurable, for example selectable by a user, explicitly (see e.g. FIG. 31) or implicitly (see e.g. FIG. 28(a) and FIG. 30).

The first input mode may be especially suitable for right-handed users. Stated in simple terms, in this mode the native mouse cursor follows movements of the first pointer device, e.g. the pointer device indicated by the user as the right pointer device, typically controlled by the right hand. In this mode the native mouse cursor does not jump between the first and second position.

The second input mode may be especially suitable for left-handed users. Stated in simple terms, in this mode the native mouse cursor follows movements of the second pointer device, e.g. the pointer device indicated by the user as the left pointer device, typically controlled by the left hand. In this mode the native mouse cursor does not jump between the first and second position.

The third input mode may be especially suitable for users desiring to click and/or scroll with both pointer devices. Stated in simple terms, in this mode the native mouse cursor follows movements of the pointer device which is most recently moved and/or clicked and/or scrolled. In this mode the native mouse cursor jumps between the first and second position.

In an embodiment, the overlay application has a display mode selected from or selectable from a first group of display modes associated with the first input mode (e.g. RightHanded), and/or a second group of display modes associated with the second input mode (e.g. LeftHanded), and a third group of display modes associated with the third input mode (e.g. BothHanded);

and step e) comprises performing at least one of the following steps:
in case the overlay application is configured in a display mode selected from the first or third group of display modes, adjusting a position of the second visible object in accordance with the second position;
in case the overlay application is configured in a display mode selected from the second group of display modes adjusting a position of the second visible object in accordance with the first position.

The first group of display modes may e.g. comprise a mode with only two visible objects: the native mouse cursor as the first visible object movable by the right pointer device, and a second visible object movable by the left pointer device, and e.g. having the form of a black arrow (see icon 2860a of FIG. 28) or an image of a left hand (see icon 2860b) or a square (see icon 2860c) or a line (see icon 2860d) or a cross (see icon 2860e), but other modes are also contemplated.

The second group of display modes may e.g. comprise a mode with only two visible objects: the native mouse cursor as the first visible object movable by the left pointer device, and a second visible object movable by the right pointer device, and e.g. having the form of a black arrow (see icon 2850a of FIG. 28) or an image of a right hand (see icon 2850b) or a square (see icon 2850c) or a line (see icon 2850d) or a cross (see icon 2850e), but other modes are also contemplated.

The third group of display modes may e.g. comprise a mode with only two visible objects: the native mouse cursor as the first visible object, and a second visible object e.g. having the form of a black arrow (see icon 2870a of FIG. 28), where the first visible object is selectively movable by the right pointer device or the left pointer device, whichever is being moved, and the second visible object is at the other maintained position.

In an embodiment, step b) comprises: providing a third visible object comprised in the graphical overlay window; and step e) comprises performing the following steps at least once, or repeatedly: * adjusting a position of the second visible object in accordance with the second position, and adjusting a position of the third visible object in accordance with the first position.

The first group, second group and third group of display modes may e.g. comprise a mode with three visible objects: the native mouse cursor as the first visible object, and a second and third visible object each having the form of a square (see icons 2860g, 2850g, 2870g) or a line (see icon 2860h, 2850h, 2870h) or a cross (see icon 2860i, 2850i, 2870i), one of which is movable by the left pointer device, the other by the right pointer device.

The third group of display modes may e.g. comprise a mode with three visible objects: the native mouse cursor as the first visible object selectively movable by the right or left pointer device, depending on which pointer device is most recently being moved and/or clicked and/or scrolled, and a second visible object (e.g. having an image of a left hand) movable by the left pointer device, and a third visible object (e.g. having an image of a right hand) movable by the right pointer device (see icon 2870b), but other modes are also contemplated.

In an embodiment, step b) further comprises: providing a vertical visible line comprised in the graphical overlay window; and step c) comprises: repeatedly performing the following steps: testing whether a position of the native mouse cursor is located on the vertical visible line, and if an outcome of the test is false, configuring said graphical overlay window in click-through mode; and if an outcome of the test is true, configuring the graphical overlay window in non-click-through mode.

The vertical visible line allows to split the screen in two parts: a left part and a right part. By repeatedly testing where the native mouse cursor is located, and by dynamically configuring the overlay window in “click through mode” or “non-click-through mode”, dragging of the vertical line can be implemented, which is a very convenient and intuitive way of moving the vertical line. No applications are known where a window is dynamically configured in and out of “click-through mode” depending on a position of the native mouse cursor.

The second visible object may be a horizontal line which extends over the width of the left part of the screen, or the right part of the screen.

If both a second and third visible object are available, the second object may be a left horizontal line, and the third object may be a right horizontal line. The vertical line can conveniently be used to define the width of a left horizontal line and the right horizontal line.

In an embodiment, the graphical overlay window occupies at least 80% or at least 90% of the area occupied by the graphical user interface (GUI).

In an embodiment, the graphical overlay window occupies substantially the entire screen area, e.g. the entire screen area.

In an embodiment, the graphical overlay window occupies substantially the entire work area, e.g. the entire work area, which in a Microsoft Windows context may mean the area of the desktop minus the area of a taskbar.

In an embodiment, the second visible object and/or each further visible object each occupies 1000 to 20000 pixels, or 1500 to 15000 pixels, or 2000 to 12000 pixels, or 2500 to 10000.

It is an advantage that updating only a tiny part of the screen can be performed relatively fast, and does not have a significant impact on CPU performance. At the same time, it is an advantage of showing a relatively large visible object, because such object is far more easy to find on the screen. As an example, the native mouse cursor (in the form of an arrow) typically occupies only about 10×10 or about 100 pixels, but is barely visible, and difficult to find on a screen. Showing a bitmap of a hand having about 20×20 pixels or about 400 pixels is better, but still relatively small, especially on a screen having a resolution of about 1920×1080 pixels or more. On such a screen of this resolution, it is much easier to locate the visible object(s) if they are about 30×30 or 50×50 to about 100×100 pixels, thus about 900 pixels or about 2.5K to about 10K pixels large.

It is a major advantage of embodiments showing three visible objects: a first visible object being the native mouse cursor having a size of about 100 to 400 pixels (e.g. an arrow of about 10×10 pixels, or an arrow of about 16×25 pixels) because this can be used for accurate positioning, and at the same time a second and a third object, one being located at substantially the same position as the native mouse cursor, optionally with a constant offset, each having a much larger size, e.g. each occupying about 1.5K to 15K pixels (e.g. a hand of about 34×44 pixels, or about 68×88 pixels, or about 102×132 pixels). Especially the combination of a relatively large hand and a relatively small native mouse cursor is extremely useful, because it offers the best of both worlds: good visibility and accurate positioning.

In an embodiment, the first pointer device comprises at least one button which can be pressed or released by a user, and the second pointer device comprises at least one button which can be pressed or released by a user, and step e) comprises:

testing if the received input message is related to a movement message from the first pointer device, and if an outcome of this test is true, obtaining displacement information and updating a first pointer position; and
testing if the received input message is related to a movement message from the second pointer device, and if an outcome of this test is true, obtaining displacement information and updating a second pointer position; and
testing if the received input message is related to the at least one button of the first pointer device being pressed or released, and if an outcome of this test is true, setting a first button-state-variable to TRUE or FALSE respectively, and
testing if the received input message is related to the at least one button of the second pointer device being pressed or released, and if an outcome of this test is true, setting a second button-state variable to TRUE or FALSE respectively;
and wherein step e) further comprises:
in case the overlay application is configured in the first input mode (e.g. RightHanded), adjusting a position of the native mouse cursor in accordance with the first position;
in case the overlay application is configured in the second input mode (e.g. LeftHanded), adjusting a position of the native mouse cursor in accordance with the second position;
in case the overlay application is configured in the third input mode (e.g. BothHanded) and if the received input message is related to a movement of the first pointer device and if the second button-state-variable is FALSE, adjusting a position of the native mouse cursor in accordance with the first position, otherwise ignoring the input message;
in case the overlay application is configured in the third input mode (e.g. BothHanded) and if the received input message is related to a movement of the second pointer device and if the first button-state variable is FALSE, adjusting a position of the native mouse cursor in accordance with the second position, otherwise ignoring the input message.

This behaviour is expressed in pseudo-code in FIG. 18(a). This algorithm is an improvement of the first algorithm described above. Stated in simple terms for two mouse devices: the method forces the native mouse cursor to “jump” according to the most recent mouse movement (left mouse or right mouse), except if a button of the other mouse device is being pressed. The attentive reader will notice that this algorithm allows “dragging” using the pointer device of which the button is being pressed.

It is noted that simply ignoring the movement event is not a good solution, because the O/S with GUI will move the mouse cursor anyway. The method of the present invention corrects this behaviour to make the behaviour intuitive to the user. For example, if a user presses a button on the “right mouse device”, the “windows cursor” should not move even if the “left mouse device” is being moved”, for as long as the button of the “right mouse” is being pressed. Neither this problem, hence neither the requirement and neither the solution is known in the art.

In an embodiment, step e) comprises: under predefined conditions, transforming the displacement values so as to correspond with a displacement in a direction selected from a limited group of directions, for example containing less than nine directions, for example containing only four directions (North, West, South, East), or containing only eight directions (N, W, S, E, NW, SW, SE, NE), or containing only two horizontal directions (West, East).

It is a major advantage of this feature that it can dramatically help the user to better control movements of at least one of the pointer devices, when performing certain tasks. This is particularly helpful for the pointer device controlled by the non-dominant hand when performing text based tasks (such as reading a text document, proofreading a translation, pointing to individual words on a same line during a webinar or presentation, etc.)

In an embodiment, step e) comprises: under predefined conditions, transforming the displacement values so as to correspond with a horizontal displacement or a vertical displacement.

In an embodiment, step e) comprises: under predefined conditions, transforming the displacement values so as to correspond with a horizontal displacement or a vertical displacement, or a displacement under a predefined angle in the range from 30° to 60°, e.g. equal to about 45°.

In an embodiment, step e) comprises: testing whether an angle or an angular distance between a displacement vector defined by the displacement values and a horizontal line is smaller than a predefined angle (for example smaller than 30°, or smaller than 40°) and if an outcome of this test is true, transforming the displacement values into horizontal displacement values; or testing whether a ratio of the vertical displacement value and the horizontal displacement value is smaller than a predefined value, and if an outcome of this test is true, transforming the displacement values into horizontal displacement values.

The predefined value may be a constant value chosen in the range from 0.2 to 0.75, for example equal to about 0.20=⅕ or 0.25=¼ or 0.33=⅓ or 0.50=½ or 0.66=⅔ or 0.75=¾.

Transforming the displacement values into horizontal displacement values can mean for example setting the vertical displacement value dy to 0.

In an embodiment, the first and second pointer device are HID compatible devices, and step d) comprises: configuring the Operating System to send raw input data to the overlay application.

More specifically (in case of a Microsoft Windows environment), step d) may comprise configuring the application to receive raw input messages of the type WM_INPUT using the WinAPI function “RegisterRawInputDevices”.

The term “HID” is a well-known term and stands for “Human Interface Device”.

In an embodiment, the operating system is Windows 7 or Windows 10 from Microsoft Corporation.

Methods of the present invention are particularly suitable to be used in conjunction with the Microsoft Windows operating system.

In an embodiment, the operating system is mac OS Sierra or mac OS High Sierra or a later mac OS version from Apple Inc.

Methods of the present invention can also be advantageously used in conjunction with operating systems for a mac computer.

The present invention is also directed to the use of a method according to the first aspect, by a single user, for pointing at two different locations on a single screen, or on multiple screens connected to a single computer device, using two pointer devices.

The present invention is also directed to the use of this method by a single user, for underlining alphanumerical information at two different locations on one or more screen connected to a single computer device, using two pointer devices.

The present invention is also directed to the use of this method by a single user, for working at two different locations on one or more screen connected to a single computer device, using two pointer devices, which can both be clicked and/or scrolled.

Such use is particularly suitable for professional users, in particular translators, proofreaders, technical writers, attorneys, patent attorneys, transcribers, and teachers.

According to a 2nd aspect, the present invention provides a computer program product containing executable instructions which perform the method according to the first aspect, when being executed on a computer device having or being connected to a display, and having or being connected to a first pointer device and having or being connected to a second pointer device, the computer device comprising an operating system with a graphical user interface that provides said native mouse cursor.

The O/S with GUI may be Windows 7 or Windows 10 or later, from Microsoft Corporation, or may be mac OS Sierra or mac OS High Sierra or a later mac OS version from Apple Inc.

According to a 3rd aspect, the present invention provides a computer device comprising: an operating system with a graphical user interface providing a native mouse cursor, and a computer program product according to the second aspect.

The computer device may be a personal computer (PC) or a desktop computer or a laptop computer or a server computer or the like.

The computer device may have at least one processor, and a storage medium or a memory storing an overlay application for performing the overlay method described above.

The computer device may comprise two pointer devices, or may comprise one pointer device (e.g. a touchpad) and be connected to one pointer device (e.g. a mouse device), or may be connected to two pointer devices (e.g. two mouse devices).

The computer device may have an internal display or may be connectable to an external display.

The computer may have an integrated keyboard or be connectable to an external keyboard.

The computer device may further comprise one or more applications selected from the group consisting of: a text editor, a PDF document viewer, a PDF document editor, a web-browser, a spreadsheet application, a PowerPoint application, an audio player, a video player, etc.

The computer program product enhances the functionality of the Operating System, so as to provide support for two visible objects individually movable by two pointer devices.

According to a 4th aspect, the present invention provides a pointer device comprising: a movement detection mechanism for detecting a movement e.g. a two-dimensional movement; a controller connected to said movement detection mechanism and adapted for sending a movement message when a movement is detected; at least one button pressable and releasable by a user; and a button detection mechanism for detecting if said at least one button is being pressed or being released; the controller being connected to said button detection mechanism and adapted for sending a button-press message when it is detected that the at least one button is being pressed, and for sending a button-release message when it is detected that the at least one button is being released; and wherein the controller is adapted for, when it is detected that the at least one button is being pressed, for (first) sending a dummy movement message, and for sending (thereafter) the button press message a predefined period after sending the dummy movement message.

This pointer device is particularly suitable for use in combination with a method according to the first aspect, or in combination with a computer program product of the second aspect, or in combination with a computer device according to the third aspect.

The controller may comprise a programmable processor programmed for sensing the movement detection mechanism and/or the button detection mechanism and/or a scrollwheel mechanism (if present), and for sending a corresponding message to the computer device (host).

It is an advantage of this pointer device that the dummy movement message will cause the overlay application described above, to make the native mouse cursor jump if it was located at the position associated with the other pointer device (not being clicked), thereby reducing the risk that the native mouse cursor is at the incorrect position at the time when the actual button-press message arrives at the computer device, as illustrated in FIG. 22. Or stated in other words, it is an advantage of this pointer device that the risk of the native mouse position not corresponding to the position of the mouse device being clicked, is drastically reduced. It is noted that this problem does not exist in the prior art, because the operating system routes all pointer messages to the same cursor position.

Or stated in yet other words, it is an advantage of this pointer device that the user does not have to manually “move the pointer device before clicking”, but this is done automatically.

This pointer device is preferably backwards compatible, so that it can also be used in classical computer devices not running the overlay application according to the first aspect, albeit with a small latency when clicking a button, which is believed to be perfectly acceptable for desktop applications, but probably unacceptable for “gaming applications”.

The delay may be based on a timer, an internal clock signal, an external clock signal, etc.

In an embodiment, the processor is further adapted for, when it is detected that the at least one button is being released, for (first) sending a dummy movement message, and for sending (thereafter) the button release message a predefined period after sending the dummy movement message.

This pointer device is particularly useful in combination with a position update routine as illustrated in FIG. 18(b), where movement messages from one pointer device are processed, even if a button of the other pointer device is being pressed.

In an embodiment, the pointer device further comprises at least one scrollwheel rotatable by a user; and a scrollwheel detection mechanism for detecting if the at least one scrollwheel has rotated; and the controller being connected to said scrollwheel detection mechanism, and being adapted for sending a scrollwheel-rotation message when it is detected that the at least one scrollwheel has rotated; and wherein the controller is adapted for, when it is detected that the at least one scrollwheel has rotated, for sending a dummy movement message, and for sending the scrollwheel-rotation message a predefined period after sending the dummy movement message.

This pointer device is particularly suitable for use in combination with a method according to the first aspect, or in combination with a computer program product of the second aspect, or in combination with a computer device according to the third aspect.

In practice the scrollwheel-rotation message would typically comprise a value indicative of how much the scrollwheel has rotated.

In a similar way as for the button-press message, it is an advantage that, instead of immediately sending the scrollwheel rotation message to the host, this pointer device first sends a dummy movement message and then waits for a certain time, so that the overlay application of the first aspect has time to force the native mouse cursor to jump, if it was located at the location associated with the other pointer device. Again, this drastically reduces the risk of the wheel_rotation_command being interpreted at the incorrect location.

In an embodiment, the predefined period is a value in the range from 1 to 250 ms or in the range from 1 to 100 ms; in combination with one of the following options:

wherein the dummy movement message has a horizontal displacement value in the range from −5 to +5 and has a vertical displacement value in the range from −5 to +5; or
wherein the dummy movement message has a horizontal displacement value in the range from −1 to +1 and has a vertical displacement value in the range from −1 to +1, or
wherein the dummy movement message has a horizontal displacement value equal to −1 or equal to +1 (but not zero) and has a vertical displacement value in the range from −1 to +1, or
wherein the dummy movement message has a vertical displacement value equal to −1 or equal to +1 (but not zero) and has a horizontal displacement value in the range from −1 to +1, or
wherein the dummy movement message has a horizontal displacement value equal to zero and has a vertical displacement value equal to zero.

It is an advantage of using a relatively small displacement value, in order not to move the native mouse cursor a lot. The smaller the displacement, the better.

The predefined period is a period in the range from 1 ms to 250 ms, or in the range from 5 ms to 200 ms, for example may be equal to about 8 ms, or about 16 ms, or about 24 ms, or about 32 ms, or about 40 ms, or about 48 ms, or about 56 ms, or about 64 ms, or about 72 ms, or about 80 ms, or about 88 ms, or about 96 ms, or about 104 ms, or about 112 ms, or about 120 ms, or about 128 ms, or about 136 ms, or about 144 ms, or about 152 ms, or about 160 ms, or about 168 ms, or about 176 ms, or about 184 ms, or about 192 ms, or about 200 ms, or about 208 ms, or about 216 ms, or about 224 ms, or about 232 ms, or about 240 ms, or about 248 ms. About 8 ms is a typical time between two HID-messages, thus a delay of about 8 ms would mean that the dummy movement message and the button-press message are sent in two adjacent time-slots.

In an embodiment, the controller is configured for sending a subsequent dummy movement message upon a subsequent detection of the at least one button being pressed, or upon a subsequent detection of the at least one scrollwheel being rotated, wherein the dummy movement message comprises displacement values chosen such that a cumulative horizontal displacement and a cumulative vertical displacement is a value in the range from −5 to +5, or in the range from −1 to +1, optionally wherein one or both of the horizontal displacement value (dx) and the vertical displacement value (dy) is non-zero.

Simply stated, rather than sending each time the at least one button is clicked the same dummy movement message, for example with (dx=+1 and dy=0), it is better to send a different dummy movement message the next time the button is clicked, for example containing displacement values dx, dy in the opposite direction, for example with (dx=−1 and dy=0).

It is an advantage of this embodiment that the pointer position does not drift away, even if the button is clicked multiple times.

The same effect can also be obtained by not sending dummy movement messages with a dummy displacement back and forth, but by sending dummy movement messages with a dummy displacement forming a small loop.

In an embodiment, the pointer device further comprises an RF transceiver connected to the controller, and the controller is further configured for sending messages to a computer device and for receiving messages from the computer device via said RF transceiver, optionally via a dongle connected to the computer device.

This embodiment is directed to a “wireless pointer device”, such as e.g. a “wireless mouse”.

The messages may be received by an internal RF transceiver present inside the computer-device, or via an external RF transceiver, also known as a dongle. The dongle may have a male USB connector to be plugged in a female USB slot of a computer device.

In an embodiment, the pointer device is a USB HID-class device or is compatible with USB HID class devices.

According to a 5th aspect, the present invention also provides a computer system comprising a computer device according to the third aspect; and a first and a second pointer device according to the fourth aspect; and optionally also a display device; and optionally also a keyboard.

In an embodiment of this computer system, the first and the second pointer device are USB HID-class devices or compatible with USB HID class devices; and the computer device comprises at least a first USB port for connection with the first pointer device, and a second USB port for connection with the second pointer device.

According to a 6th aspect, the present invention also provides a kit of parts comprising: a computer program product according to the second aspect; and two pointer devices according to the fourth aspect.

This kit of parts (or package) may be very suited for users already having a computer device with an operating system and a keyboard and a display. By using the computer program product of the second aspect in combination with two special pointer devices, the risk of inadvertently clicking or scrolling at the wrong location, is strongly reduced, without the user having to physically moving the pointer device before clicking or scrolling.

According to a 7th aspect, the present invention provides a hub, comprising: a first interface for communicating with a first pointer device, and a second interface for communicating with a second pointer device, and a third interface for communicating with a computer device; and a controller being connected to said first interface and adapted for receiving first messages from the first pointer device; the controller being connected to said second interface and adapted for receiving second messages from the second pointer device; the controller being connected to said third interface and adapted for transmitting said first and second messages to said computer device; and wherein the controller is further adapted for:

upon receipt of a button-press message from the first pointer device via the first interface, to (first) send a first dummy movement message to the computer device via the third interface, and a predefined period later to send the button-press message to the computer device via the third interface;
upon receipt of a button-press message from the second pointer device via the second interface, to send a second dummy movement message to the computer device via the third interface, and a predefined period later to send the button-press message to the computer device via the third interface.

Or stated in other words, in this way the hub prevents that the message stream sent to the computer device contains a button-press message or a scrollwheel rotation message from the first pointer device being preceded by a message from the second pointer device, and vice versa.

This hub is particularly suitable for use in combination with a method according to the first aspect, or in combination with a computer program product of the second aspect, or in combination with a computer device according to the third aspect, although the hub may also be used with other applications with dual mouse support, for example educational games or the like, not configured in click-through mode.

With “first/second dummy movement message” is meant a dummy movement message formatted as if it was sent by the first/second pointer device.

Use of this hub offers at least the same advantages as using the special pointer devices according to the fourth aspect, and in some embodiments may offer even further advantages, because the hub can see (and optionally block or delay or modify) the messages from other pointer devices.

In an embodiment, the controller is further adapted for:

upon receipt of a button-release message from the first pointer device via the first interface, to send a first dummy movement message to the computer device via the third interface, and a predefined period later to send the button-release message to the computer device via the third interface;
upon receipt of a button-release message from the second pointer device via the second interface, to send a second dummy movement message to the computer device via the third interface, and a predefined period later to send the button-release message to the computer device via the third interface.

This hub is especially advantageous when used in combination with an overlay method having a position update routine (as illustrated for example in FIG. 18b) where movement messages from one pointer device are not simply discarded, but are processed even if a button of the other pointer device is being pressed.

In an embodiment, the controller is further adapted for:

upon receipt of a scrollwheel-rotation message from the first pointer device via the first interface, to send a first dummy movement message to the computer device via the third interface, and a predefined period later to send the scrollwheel-rotation message to the computer device via the third interface;
upon receipt of a scrollwheel-rotation message from the second pointer device via the second interface, to send a second dummy movement message to the computer device via the third interface, and a predefined period later to send the scrollwheel-rotation message to the computer device via the third interface.

In a variant of the 7th aspect, the present invention provides a hub, comprising: a first interface for communicating with a first pointer device, and a second interface for communicating with a second pointer device, and a third interface for communicating with a computer device; and a controller being connected to said first interface and adapted for receiving first messages from the first pointer device; the controller being connected to said second interface and adapted for receiving second messages from the second pointer device; the controller being connected to said third interface and adapted for transmitting said first and second messages to said computer device; and wherein the controller is further adapted for:

upon receipt of a first button-press message, determining whether a most recent movement related or button related or scrollwheel message sent to the computer device via the third interface was a message related to the first pointer device, and if the outcome of this test is true, transmitting the first button-press message to the computer device via the third interface without prior transmission of a dummy movement message, and if the outcome of this test is false, sending a first dummy movement message to the computer device via the third interface, and a predefined period later sending the first button-press message to the computer device via the third interface;
upon receipt of a second button-press message, determining whether a most recent movement related or button related or scrollwheel message sent to the computer device via the third interface was a message related to the second pointer device, and if the outcome of this test is true, transmitting the second button-press message to the computer device via the third interface without prior transmission of a dummy movement message, and if the outcome of this test is false, sending a second dummy movement message to the computer device via the third interface, and a predefined period later sending the second button-press message to the computer device via the third interface;
upon receipt of a first scrollwheel-rotation message, determining whether a most recent movement related or button related or scrollwheel message sent to the computer device via the third interface was a message related to the first pointer device, and if the outcome of this test is true, transmitting the first scrollwheel-rotation message to the computer device via the third interface without prior transmission of a dummy movement message, and if the outcome of this test is false, sending a first dummy movement message to the computer device via the third interface, and a predefined period later sending the first scrollwheel-rotation message to the computer device via the third interface;
upon receipt of a second scrollwheel-rotation message, determining whether a most recent movement related or button related or scrollwheel message sent to the computer device via the third interface was a message related to the second pointer device, and if the outcome of this test is true, transmitting the second scrollwheel-rotation message to the computer device via the third interface without prior transmission of a dummy movement message, and if the outcome of this test is false, sending a second dummy movement message to the computer device via the third interface, and a predefined period later sending the second scrollwheel-rotation message to the computer device via the third interface.

Stated in simple terms, when a button-press message arrives, the hub verifies whether the most recent message sent to the computer device came from the same pointer device, and if that is the case, the button-press message can be transmitted without first sending a dummy movement message, otherwise, the hub first sends a dummy movement message and some time later, sends the button-press message.

This can be seen as an improved version of the hub described above, in that a dummy movement message is not always sent unconditionally, but is only sent when needed.

In another variant of the 7th aspect, the present invention provides a hub, comprising: a first interface for communicating with a first pointer device, and a second interface for communicating with a second pointer device, and a third interface for communicating with a computer device; and a controller being connected to said first interface and adapted for receiving first messages from the first pointer device; the controller being connected to said second interface and adapted for receiving second messages from the second pointer device; the controller being connected to said third interface and adapted for transmitting said first and second messages to said computer device; and wherein the controller further maintains a first button-state-variable indicative of whether a button of the first pointer device is being pressed, and a second button-state-variable indicative of whether a button of the second pointer device is being pressed; and wherein the controller is further configured for:

upon receipt of a first movement message from the first pointer device, to test whether the second button-state variable is TRUE, and if the outcome of this test is TRUE, to discard or delay the first movement message, and if the outcome of this test is FALSE, to transmit the first movement message to the computer device via the third interface;

upon receipt of a second movement message from the second pointer device, to test whether the first button-state variable is TRUE, and if the outcome of this test is TRUE, to discard or delay the second movement message, and if the outcome of this test is FALSE, to transmit the second movement message to the computer device via the third interface;
upon receipt of a first scrollwheel-rotation message from the first pointer device, to test whether the second button-state variable is TRUE, and if the outcome of this test is TRUE, to discard or delay the first scrollwheel-rotation message, and if the outcome of this test is FALSE, to transmit the first scrollwheel-rotation message to the computer device via the third interface;
upon receipt of a second scrollwheel-rotation message from the second pointer device, to test whether the first button-state variable is TRUE, and if the outcome of this test is TRUE, to discard or delay the second scrollwheel-rotation message, and if the outcome of this test is FALSE, to transmit the second scrollwheel-rotation message to the computer device via the third interface;
upon receipt of a first button-press message from the first pointer device, to test whether the second button-state variable is TRUE, and if the outcome of this test is TRUE, to discard or delay the first button-press message, and if the outcome of this test is FALSE, to perform the following steps:
to set the first button-state variable to TRUE,
to send a first dummy movement message to the computer device via the third interface,
and a predefined period later, to send the first button-press message to the computer device via the third interface;
   upon receipt of a first button-release message from the first pointer device, to test whether the second button-state variable is TRUE, and if the outcome of this test is TRUE, to discard or delay the first button-release message, and if the outcome of this test is FALSE, to perform the following step:
to set the first button-state variable to FALSE,
to send the first button-release message to the computer device via the third interface;
   upon receipt of a second button-press message from the second pointer device, to test whether the first button-state variable is TRUE, and if the outcome of this test is TRUE, to discard or delay the second button-press message, and if the outcome of this test is FALSE, to perform the following steps:
to set the second button-state variable to TRUE,
to send a second dummy movement message to the computer device via the third interface,
and a predefined period later, to send the second button-press message to the computer device via the third interface;
   upon receipt of a second button-release message from the second pointer device, to test whether the first button-state variable is TRUE, and if the outcome of this test is TRUE, to discard or delay the second button-release message, and if the outcome of this test is FALSE, to perform the following step:
to set the second button-state variable to FALSE;
to send the second button-release message to the computer device via the third interface.

Stated in simple terms, this hub keeps track of whether the at least one button of the first and second pointer device is being pressed, and if that is the case, to discard or ignore messages sent by the other pointer device, as illustrated for example in FIG. 26 and FIG. 27.

In an embodiment, the predefined period is a value in the range from 1 to 250 ms or in the range from 2 to 100 ms; and the dummy movement message has a horizontal displacement value in the range from −5 to +5 and has a vertical displacement value in the range from −5 to +5; or the dummy movement message has a horizontal displacement value in the range from −1 to +1 and has a vertical displacement value in the range from −1 to +1; or the dummy movement message has a horizontal displacement value equal to −1 or equal to +1, and has a vertical displacement value in the range from −1 to +1; or the dummy movement message has a vertical displacement value equal to −1 or equal to +1, and has a horizontal displacement value in the range from −1 to +1, or the dummy movement message has a horizontal displacement value equal to zero and has a vertical displacement value equal to zero.

This offers the same advantages as a pointer device according to the fourth aspect having the same or corresponding features.

In an embodiment, the controller is configured for sending subsequent first dummy movement messages with displacement values chosen such that a first cumulative horizontal displacement and a first cumulative vertical displacement are values in the range from −5 to +5, or in the range from −4 to +4, or in the range from −3 to +3, or in the range from −2 to +2, or in the range from −1 to +1, optionally one or both of the horizontal displacement value (dx) and the vertical displacement value (dy) being non-zero; and the controller is configured for sending subsequent second dummy movement messages with displacement values chosen such that a second cumulative horizontal displacement and a second cumulative vertical displacement are values in the range from −5 to +5, or in the range from −4 to +4, or in the range from −3 to +3, or in the range from −2 to +2, or in the range from −1 to +1, optionally one or both of the horizontal displacement value and the vertical displacement value being non-zero.

This offers the same advantages as a pointer device according to the fourth aspect having the same or corresponding features.

In an embodiment, the first interface comprises a first connector connectable to the first pointer device, and the second interface comprises a second connector connectable to the second pointer device, and the third interface comprises a third connector connectable to the computer device.

In a preferred embodiment, the first and second connector are female USB connectors, and the third connector is a male USB connector.

In an embodiment, the hub further comprising a first RF transceiver for receiving messages from and transmitting messages to the first pointer device; and the hub further comprising a second RF transceiver for receiving messages from and transmitting messages to the second pointer device, the second RF transceiver being the same as the first RF transceiver, or being a separate RF transceiver; and the first interface comprises the first RF transceiver; and the second interface comprises the second RF transceiver; and the third interface comprises a connector connectable to the computer device.

In an embodiment, the first and second transceiver are a single RF transceiver, capable of communicating with both the first and the second pointer device, and the third interface is a male USB connector.

In an embodiment, the first and second transceiver are two physically distinct RF transceivers, and the third interface is a male USB connector.

Such a hub is typically referred to as a dongle.

It is noted that the first and second pointer device in this case would need an RF transceiver too, but do not need the special behaviour described above. They can be classical RF pointer devices.

According to an 8th aspect, the present invention provides a computer system comprising: a computer device according to the third aspect; and two pointer devices; and a hub according to the seventh aspect, the hub being operatively connected between said computer device and said first and second pointer device; and optionally also a display device; and optionally also a keyboard.

With this computer system the user can use both hands to move two visible objects.

This computer system provides a technical solution to a technical problem, which can be used to significantly lower the cognitive burden of the user, and to switch faster between different locations on a screen, which is particularly relevant for translators or reviewers or proofreaders frequently switching back and forth between two documents.

According to a 9th aspect, the present invention also provides a kit of parts comprising: a computer program product according to the second aspect, and a hub according to the seventh aspect.

Also this kit of parts (or package) may be very suited for users already having a computer device with an operating system and a keyboard and a display and two mouse devices. By using the computer program product of the second aspect in combination with the special hub, the risk of inadvertently clicking or scrolling at the wrong location, is strongly reduced or even completely eliminated, without the user having to physically moving the pointer device before clicking or scrolling.

In an embodiment, the kit of parts may further comprise one or two pointer devices.

This kit of parts (or package) may be better suited for users already having a computer device with an operating system and a keyboard and a display and a single mouse device.

According to a 10th aspect, the present invention provides a display device comprising: an input port for receiving first graphical image data from a computer device; an input buffer for storing at least a portion of said first graphical image data received at the input port; a processor connected to said input buffer, and adapted for generating second graphical image data based on said first graphical image data, and for storing at least a portion of said second graphical image data in a frame buffer; said frame buffer operatively connected to said processor, and adapted for storing at least a portion of second graphical image data to be shown on a display panel; readout circuitry for reading at least a portion of said second graphical image data from said frame buffer, and for sending said at least a portion to a display panel; said display panel for generating a visual image corresponding to said second graphical image data; wherein the display device further comprises a wired and/or a wireless interface for communicating with a wired or a wireless pointer device; the processor (of the display device) being further adapted for: * communicating with said pointer device for receiving displacement information related to movements of said pointer device; and * updating a position based on said received displacement information; and * generating a visible object; and * generating said second graphical image data by overlaying the first graphical image data with said generated visible object at said position.

In practice, the input buffer would typically store only a fraction of a video frame comprised in the first graphical image data (stream) at any moment in time, and the frame buffer would typically store at least one entire field (e.g. in an interlaced video display, such as a CRT display) or at least one entire frame (e.g. in a non-interlaced video display, such as an LCD display) at any moment in time.

In some embodiments, the frame buffer may store at least two entire fields or at least two entire frames, for allowing the processor 4233 to prepare the next field or frame to be displayed.

The pointer device may be a HID-compatible pointer device, e.g. a HID-compatible mouse device.

The input buffer and frame buffer may be part of a memory component comprised in the display device, even though they are drawn as separate blocks in FIG. 42.

This display device offers the advantage that it not only displays the graphical image provided by the computer device, but in addition provides at least one visible object, for example having the form or shape of an arrow, or a hand, or a small line, or a large line, or a square, or a rectangle, or a small cross, or a large cross, or any other suitable shape or form, which at least one visible object is movable by a pointer device operatively connected to the display device rather than to the computer device.

As can be appreciated from FIG. 41 in comparison with FIG. 5(a) and FIG. 5(b), the use of this “special” display device in conjunction with a classical computer device also solves the problem illustrated in FIG. 1 to FIG. 3.

While in hind-sight, the solution proposed in FIG. 41 and FIG. 42 may seem simple to implement, that does not mean that this embodiment is an obvious solution to solve the problem of FIG. 1 to FIG. 3. It is pointed out in this respect that there is a common believe that a software solution is always cheaper than a hardware solution, especially in consumer electronics, and therefore that the problem must be solved in the computer device, rather than in the display device.

The solution proposed in FIG. 41 and FIG. 42 solves the problem elegantly, moreover without significantly increasing the CPU load of the computer device, and without requiring the special overlay application.

The visible object may be a predefined visible object, or may have a bitmap which is obtained from a removable memory, for example from a memory-stick comprising a file comprising said bitmap. In such embodiment, the display device may have a further connector for insertion of a non-volatile memory-card or a flash-card or a memory-stick or the like.

In an embodiment, the interface for communicating with the pointer device comprises a physical connector, in particular a USB connector.

A physical connector allows direct connection of the pointer device to the display device.

In an embodiment, the interface for communicating with a pointer device comprises a wireless RF transceiver, e.g. a Bluetooth transceiver. The RF transceiver may be embedded in the display device, or may be connected externally to the display device, for example in the form of a so called dongle, e.g. a USB dongle. The dongle may be connected to the physical connector of the display device.

In an embodiment, the generated visible object comprises or consists of monochrome pixels, and the processor is adapted for overlaying the first graphical image data with the monochrome pixels by replacing pixel values of the first graphical image data by a value of the monochrome pixels.

It is an advantage of this embodiment that the “overlaying operation” can be as simple as replacing pixel values of the first graphical image by pixel values of the visible object. The result is a non-transparent visible movable object overlaid over the first graphical image data.

In an embodiment, the generated visible object comprises or consists of monochrome pixels, and the processor is adapted for overlaying the first graphical image data with the monochrome pixels by alpha-blending, for example using an alpha transparency in the range from 5% to 95% or from 25% to 75%.

It is an advantage of this embodiment that the “overlaying operation” involves alpha-blending, which is a mature technique, and while being technically somewhat more complex, the result is a semi-transparent visible movable object overlaid over the first graphical image data. This offers the advantage for the user that he can see through the movable object, and that less accurate positioning is required when for example underlining alphanumerical information, which is especially useful since this pointer device would typically be manipulated by a non-dominant hand.

It particular embodiments, the alpha-transparency is ⅛ or 2/8=¼=25% or ⅜ or 4/8=½=50% or ⅝ or 6/8=¾ or ⅞, in which case the mixing which can be performed by simple add and shift operations, and thus does not require a multiply or divide operation. This operation can be performed easily in hardware, for example in programmable logic, and does not require a powerful DSP.

In an embodiment, the generated visible object comprises a first plurality of fully transparent pixels and a second plurality of opaque pixels, the first plurality of pixels and the second plurality of opaque pixels being interleaved, and the processor is adapted for overlaying pixels from the first graphical image data with fully transparent pixels by leaving the pixel values of the first graphical image data unchanged, and for overlaying pixels from the first graphical image data with opaque pixels by replacing the pixel values of the first graphical image with the pixel values of the visible object.

In this embodiment, the visible object has a so called “perforated bitmap” as is explained in more detail in the co-pending “perforated bitmap application”.

In this way, the movable object is (spatially) partially “see-through”, giving the visual impression of “semi-transparent”, but implemented in a manner which does not require mixing of color values. It offers the same visual advantages to the user without requiring a fast DSP.

In an embodiment, the first plurality of pixels and the second plurality of pixels of the visible object are organized in a regular pattern according to one of the following options: i) the regular pattern is a 2×2 pattern, and exactly one out of four pixels is fully transparent; ii) the regular pattern is a 2×2 pattern and exactly two out of four pixels are fully transparent, the two fully transparent pixels preferably being located diagonally opposite each other; iii) the regular pattern is a 2×2 pattern and exactly three out of four pixels are fully transparent.

Tests have shown that these patterns provide a very nice (aesthetically attractive) result, without significantly reducing easily readability of underlying alphanumerical information.

In an embodiment, the generated visible object comprises or consists of monochrome or opaque pixels, and the processor is adapted for * generating the second graphical image data at first moments in time by overlaying the first graphical image data with visible object data of the generated object; and for * generating the second graphical image data at second moments in time by selecting the first graphical image data without using the visible object data.

The first moments in time may correspond to even numbered frames (T=2×N, where N is an integer number representing the frame number), and the second moments in time may correspond to odd numbered frames (T=2×N+1). Stated in simple terms, this means that at even moments in time first graphical image data is overlaid with the movable object, and at odd moments in time the first graphical image data is shown as it is, without being overlaid by the movable object, thereby obtaining a time-multiplexed overlay, giving the visual impression of being “semi-transparent”.

In an embodiment, the processor is further adapted for adjusting the displacement values such that under predefined conditions, the displacement is adjusted to be a horizontal displacement.

It is a major advantage of this feature that it can help the user to better control movements of at least one of the pointer devices, when performing certain tasks. This is particularly helpful for the pointer device controlled by the non-dominant hand when performing text based tasks (such as reading a text document, proofreading a translation, pointing to individual words on a same line during a webinar or presentation, etc.)

In an embodiment, the predefined conditions comprises: testing whether an angle or an angular distance between a displacement vector defined by the displacement values and a horizontal line is smaller than a predefined angle, (for example smaller than 30°, or smaller than 40°).

In an embodiment, the predefined conditions comprises: testing whether a ratio (rico) of the vertical displacement value and the horizontal displacement value is smaller than a predefined value.

In certain embodiments, the predefined value may be a constant value chosen in the range from 0.2 to 0.7, for example equal to about 0.2 or 0.25 or 0.3 or 0.33=⅓ or 0.35 or 0.40 or 0.50=½ or 0.60 or 0.66=⅔ or 0.7.

In other embodiments, the predefined value may be dynamically adjusted, and may for example be chosen somewhat larger (for example a value in the range from 0.5 to 0.7) if an amplitude of the horizontal displacement dx is larger than a predefined threshold, for example abs(dx)>10, and may be chosen somewhat smaller (for example a value in the range from 0.3 to 0.5) if an amplitude of the horizontal displacement dx is smaller than or equal to said predefined threshold, for example abs(dx)<=10.

According to an 11th aspect, the present invention provides a computer system comprising: a computer device; and a first pointer device connected to said computer device; and a display device according to the tenth aspect; and a second pointer device connected to said display device.

According to a 12th aspect, the present invention provides a kit of parts comprising: a computer program product according to the second aspect; and a display device according to the 10th aspect; and optionally a mouse device connectable to said display device.

According to a 13th aspect, the present invention provides a video adapter device comprising: an input port for receiving first graphical image data from a computer device; an input buffer for storing at least a portion of said first graphical image data received at the input port; an output port for providing second graphical image data to a display device; an output buffer for storing at least a portion of said second graphical image data to be provided to said output port; a processor connected to said input buffer and adapted for generating second graphical image data based on said first graphical image data; and the video adapter device further comprises a wired and/or a wireless interface for communicating with a wired or a wireless pointer device; wherein the processor is further adapted for: * communicating with said pointer device for receiving displacement information related to movements of said pointer device; * updating a position based on said received displacement information; * generating a visible object; * generating said second graphical image data by overlaying the first graphical image data with said generated visible object at said position.

A frame buffer is not absolutely required, for example if the output frame rate and output frame resolution is the same as the input frame rate and input frame resolution, and the overlaying can be performed “on the fly”, as illustrated by path “P2” in FIG. 44.

In practice, the input buffer would typically store only a fraction of a video frame comprised in the first graphical image data (stream) at any moment in time, and the output buffer would typically store only a fraction of a video frame comprised in the second graphical image data (stream) at any moment in time.

The pointer device may be a HID-compatible pointer device, e.g. a HID-compatible mouse device.

This video adapter device offers the advantage that it not only displays or passes the graphical image provided by the computer device, but in addition provides at least one visible object, for example having the form or shape of an arrow, or a hand, or a small line, or a large line, or a square, or a rectangle, or a small cross, or a large cross, or any other suitable shape or form, which at least one visible object is movable by a pointer device operatively connected to the video adapter device rather than to the computer device.

As can be appreciated from FIG. 43 in comparison with FIG. 5(a) and FIG. 5(b), the use of this “special” video adapter device in conjunction with a classical computer device also solves the problem illustrated in FIG. 1 to FIG. 3.

While in hind-sight, the solution proposed in FIG. 43 and FIG. 44 may seem simple to implement, that does not mean that this embodiment is an obvious solution to solve the problem of FIG. 1 to FIG. 3. It is pointed out in this respect that there is a common believe that a software solution is always cheaper than a hardware solution, especially in consumer electronics, and therefore that the problem must be solved in the computer device, rather than in the display device.

The solution proposed in FIG. 43 and FIG. 44 solves the problem elegantly, moreover without significantly increasing the CPU load of the computer device, and without requiring the special overlay application.

The visible object may be a predefined visible object, or may have a bitmap which is obtained from a removable memory, for example from a memory-stick comprising a file comprising said bitmap. In such embodiment, the video adapter device may have a further connector for insertion of a non-volatile memory-card or a flash-card or a memory-stick or the like.

In an embodiment, the video adapter device further comprises: a frame buffer being operatively connected to said processor, and being adapted for storing at least a portion of the first graphical image data received from the input buffer, and for storing at least a portion of the second graphical data to be transmitted to the output buffer.

In this embodiment, the video adapter device comprises a frame buffer, which may be comprised in a separate memory component, or in a same memory component that also comprises the input buffer and/or the output buffer.

The data would typically flow from the input port via the input buffer to the frame buffer (path P1a of FIG. 44), and from the frame buffer and via the output buffer to the output port (path P1b of FIG. 44). The overlay would typically be performed by the processor by reading data from and/or writing data to the frame buffer (not explicitly shown in FIG. 44).

The frame buffer may comprise a complete video frame, or more than one video frames, for example at least two video frames, for example allowing that one video frame is ready to be output via the output buffer while the other video frame is being generated, in manners known per se in the art.

In an embodiment, the interface for communicating with the pointer device comprises a physical connector, in particular a USB connector.

A physical connector allows direct connection of the pointer device to the video adapter device.

In an embodiment, the interface for communicating with a pointer device comprises a wireless RF transceiver, e.g. a Bluetooth transceiver.

The RF transceiver may be embedded in the video adapter device, or may be connected externally to the video adapter device, for example in the form of a so called dongle, e.g. a USB dongle. The dongle may be connected to the physical connector of the video adapter.

In an embodiment, the generated visible object comprises or consists of monochrome pixels, and the processor is adapted for overlaying the first graphical image data with the monochrome pixels by replacing pixel values of the first graphical image data by a value of the monochrome pixels.

It is an advantage of this embodiment that the “overlaying operation” can be as simple as replacing pixel values of the first graphical image by pixel values of the visible object. The result is a non-transparent visible movable object overlaid over the first graphical image data.

In an embodiment, the generated visible object comprises or consists of monochrome pixels, and the processor is adapted for overlaying the first graphical image data with the monochrome pixels by alpha-blending, for example using an alpha transparency in the range from 5% to 95% or from 25% to 75%.

It is an advantage of this embodiment that the “overlaying operation” involves alpha-blending, which is a mature technique, and while being technically somewhat more complex, the result is a semi-transparent visible movable object overlaid over the first graphical image data. This offers the advantage for the user that he can see through the movable object, and that less accurate positioning is required when for example underlining alphanumerical information, which is especially useful since this pointer device would typically be manipulated by a non-dominant hand.

It particular embodiments, the alpha-transparency is ⅛ or 2/8=¼=25% or ⅜ or 4/8=½=50% or ⅝ or 6/8=¾ or ⅞, in which case the mixing which can be performed by simple add and shift operations, and thus does not require a multiply or divide operation. This operation can be performed easily in hardware, for example in programmable logic, and does not require a powerful DSP.

In an embodiment, the generated visible object comprises a first plurality of fully transparent pixels and a second plurality of opaque pixels, the first plurality of pixels and the second plurality of opaque pixels being interleaved, and the processor is adapted for overlaying pixels from the first graphical image data with said fully transparent pixels by leaving the pixel values of the first graphical image data unchanged, and for overlaying pixels from the first graphical image data with opaque pixels by replacing the pixel values of the first graphical image with the pixel values of the visible object.

In this embodiment, the visible object has a so called “perforated bitmap” as is explained in more detail in the co-pending “perforated bitmap application”.

In this way, the movable object is (spatially) partially “see-through”, giving the visual impression of “semi-transparent”, but implemented in a manner which does not require mixing of color values. It offers the same visual advantages to the user without requiring a fast DSP.

In an embodiment, the first plurality of pixels and the second plurality of pixels of the visible object are organized in a regular pattern according to one of the following options: i) the regular pattern is a 2×2 pattern, and exactly one out of four pixels is fully transparent; ii) the regular pattern is a 2×2 pattern and exactly two out of four pixels are fully transparent, the two fully transparent pixels preferably being located diagonally opposite each other; iii) the regular pattern is a 2×2 pattern and exactly three out of four pixels are fully transparent.

Tests have shown that these patterns provide a very nice (aesthetically attractive) result, without significantly reducing easily readability of underlying alphanumerical information.

In an embodiment, the generated visible object comprises or consists of monochrome or opaque pixels, and the processor is adapted for * generating the second graphical image data at first moments in time by overlaying the first graphical image data with visible object data of the generated object; and for * generating the second graphical image data at second moments in time by copying the pixel values of the first graphical image data as they are.

The first moments in time may correspond to even numbered frames (T=2×N, where N is an integer number representing the frame number), and the second moments in time may correspond to odd numbered frames (T=2×N+1). Stated in simple terms, this means that at even moments in time first graphical image data is overlaid with the movable object, and at odd moments in time the first graphical image data is shown as it is, without being overlaid by the movable object, thereby obtaining a time-multiplexed overlay, giving the visual impression of being “semi-transparent”.

In an embodiment, the processor is further adapted for adjusting the displacement values such that under predefined conditions, the displacement is adjusted to be a horizontal displacement.

It is a major advantage of this feature that it can help the user to better control movements of at least one of the pointer devices, when performing certain tasks. This is particularly helpful for the pointer device controlled by the non-dominant hand when performing text based tasks (such as reading a text document, proofreading a translation, pointing to individual words on a same line during a webinar or presentation, etc.)

In an embodiment, the predefined conditions comprises: testing whether an angular distance between a displacement vector defined by the displacement values (dx, dy) and a horizontal line is smaller than a predefined angle, (for example smaller than 30°, or smaller than 40°) or wherein the predefined conditions comprises testing whether a ratio of the vertical displacement value and the horizontal displacement value is smaller than a predefined value.

In certain embodiments, the predefined value may be a constant value chosen in the range from 0.2 to 0.75, for example equal to about 0.2=⅕ or 0.25=¼ or 0.3 or 0.33=⅓ or 0.35 or 0.40 or 0.50=½ or 0.60 or 0.66=⅔ or 0.75=¾.

In other embodiments, the predefined value may be dynamically adjusted, and may for example be chosen somewhat larger (for example a value in the range from 0.5 to 0.7) if an amplitude of the horizontal displacement dx is larger than a predefined threshold, for example abs(dx)>10, and may be chosen somewhat smaller (for example a value in the range from 0.3 to 0.5) if an amplitude of the horizontal displacement dx is smaller than or equal to said predefined threshold, for example abs(dx)<=10.

According to a 14th aspect, the present invention provides a computer system comprising: a computer device; and a first pointer device connected to said computer device; and a display device; and a video adapter device according to the thirteenth aspect, operatively connected between the computer device and the display device; and a second pointer device operatively connected to said video adapter device.

The computer device may be a classical computer device, or a computer device according to the second aspect. The display device may be a classical display device, or a display device according to the 10th aspect.

According to a 15th aspect, the present invention provides a kit of parts comprising: a computer program product according to the second aspect; and a video adapter device according to the thirteenth aspect.

In an embodiment, the kit further comprises a pointer device operatively connectable to said video adapter device.

The present invention also provides a kit of parts comprising: a video adapter device according to the thirteenth aspect; and a pointer device operatively connectable to said video adapter device.

According to a 16th aspect, the present invention also provides a computer-implemented method of discovering which device handles are assigned by an Operating System to a first pointer device movable by a left hand of a user, and a second pointer movable by a right hand of a user, said first and second pointer device being connected to a computer device running said Operating System and running an overlay application performing a method according to the first aspect, the method of discovering comprising the steps of:
a) requesting the Operating System to provide a list of pointer devices;
b) filtering the list so as to keep only pointer devices;
c) requesting the Operating System to provide for each pointer device in the list a corresponding handle;
d) configuring the Operating System to send raw input messages;
e) providing a message handler to process these raw input messages, the message handler comprising a plurality of counter values, and adapted for, when a raw movement message is detected, requesting the operating system for the handle associated with said raw movement message, and for increasing a counter value associated with said handle;
f) showing a plurality of graphical elements indicative of said counter values;
g) allowing a user to indicate which graphical element represents movements of the first pointer device movable by the left hand, and considering the handle corresponding to the graphical element indicated by the user as the handle assigned by the Operating System to the first pointer device;
h) allowing a user to indicate which graphical element represents movements of the second pointer device movable by the right hand, and considering the handle corresponding to the graphical element indicated by the user as the handle assigned by the Operating System to the second pointer device.

According to a 17th aspect, the present invention also provides a computer-implemented method for providing at least a first visible object and a second visible object and a third visible object in a computer device comprising: an operating system with a graphical user interface that provides said first visible object and maintains only a single mouse position of said first visible object; said first pointer device and said second pointer device being operatively connected to the computer device; the method comprising the steps of: a) providing a graphical window comprising said said second visible object and said third visible object; b) configuring the Operating System to send raw input messages related to the first and second pointer device, and providing a message handler to process these raw input messages; c) adjusting a position of the first visible object in accordance with movements of any of the first pointer device and the second pointer device whichever is most recently moved and/or asserted based on said raw input messages, and adjusting a position of the second visible object in accordance with movement of the second pointer device based on said raw input messages, and adjusting a position of the third visible object in accordance with movement of the first pointer device based on said raw input messages.

According to a 18th aspect, the present invention provides a computer implemented method for providing at least a first visible object and a second visible object on a computer device comprising: an operating system with a graphical user interface that maintains only a single mouse position, such that the first visible object is movable by a first pointer device and the second visible object is separately movable by a second pointer device, said first pointer device and said second pointer device being operatively connected to the computer device; the method comprising the steps of: a) providing a graphical window comprising said first visible object and said second visible object; b) configuring the Operating System to send raw input messages related to the first and second pointer device, and providing a message handler to process these raw input messages; c) adjusting a position of the first visible object in accordance with movements of the first pointer device based on said raw input messages, and adjusting a position of the second visible object in accordance with movement of the second pointer device based on said raw input messages.

In an embodiment, step c) comprises: receiving an input message, and in case the input message is a movement message, obtaining displacement values (dx, dy) related to said movement message.

In an embodiment, the first and second pointer device are HID compatible devices.

In an embodiment, the operating system is Windows 7 or Windows 10 from Microsoft Corporation, or a later Windows version having the same or similar functionality.

In an embodiment, the operating system is mac OS Sierra or mac OS High Sierra or a later mac OS version from Apple Inc, or a later mac OS version having the same or similar functionality.

According to a 19th aspect, the present invention provides a computer program product containing executable instructions which perform the method according to the 18th aspect, when being executed on a computer device having or being connected to a display, and having or being connected to a first pointer device and having or being connected to a second pointer device, the computer device comprising an operating system with a graphical user interface that maintains only a single native cursor position.

According to a 20th aspect, the present invention provides a computer device comprising: an operating system with a graphical user interface supporting a single mouse cursor position; and a computer program product according to the 19th aspect.

According to a 21th aspect, the present invention provides: a computer system comprising a computer device according to the 20th aspect; a first and a second pointer device according to the fourth aspect, connected to said computer device; optionally comprising a display device; and optionally comprising a keyboard.

In an embodiment, the first pointer device and the second pointer device are USB HID-class devices or compatible with USB HID class devices, and the computer device comprises at least a first USB port for connection with the first pointer device, and a second USB port for connection with the second pointer device.

P711 According to a 22nd aspect, the present invention provides a kit of parts comprising: a computer program product according to the 19th aspect; and two pointer devices according to the 4th aspect.

According to a 23th aspect, the present invention provides a computer system comprising: a computer device according to the 20th aspect; a first and a second pointer device according to the 4th aspect; a hub according to the 7th aspect, operatively connected between said computer device and said first and second pointer device; optionally comprising a display device; optionally comprising a keyboard.

According to a 24th aspect, the present invention provides a kit of parts comprising: a computer program product according to the 19th aspect; and a hub according to the 7th aspect.

In an embodiment, the kit of parts further comprises one or two pointer devices.

According to a 25th aspect, the present invention provides a computer implemented method for allowing a smooth transition of a mouse cursor from a position on a first display panel to a second position on a second display panel, the first and second display panel being operatively connected to a computer device, the first display panel having a first vertical resolution, the second display panel having a second vertical resolution smaller than the first vertical resolution, the computer device running an operating system with a graphical user interface that provides a native mouse cursor; the method comprising the steps of: a) determining parameters of the first display panel; b) determining parameters of the second display panel; c) determining parameters of a transition zone based on the parameters of the first display panel and of the second display panel; repeating at least once: d) determining a current position of the native mouse cursor; e) testing whether the determined position is located in the transit zone, and if an outcome of the test is TRUE, performing step f); 0 adjusting the position of the native mouse cursor to a position outside the transit zone.

In an embodiment, step c) comprises choosing a rectangular transition zone having a width of 1 to 10 pixels.

In an embodiment, step c) comprises choosing a rectangular transition zone having a height equal to or larger than a difference between a height of the first display panel and a height of the second display panel.

In an embodiment, step f) comprises setting a vertical position of the native mouse cursor to a value smaller than a height of the second display.

According to a 26th aspect, the present invention provides a computer program product containing executable instructions which perform the method according to the 25th aspect, when being executed on a computer device having or being connected to two display panels, and having or being connected to at least one pointer device, the computer device comprising an operating system with a graphical user interface that provides said native mouse cursor.

According to a 27th aspect, the present invention provides a computer device, comprising: —an operating system with a graphical user interface providing a native mouse cursor; —a computer program product according to the 26th aspect.

According to a 28th aspect, the present invention provides a computer system, comprising: —a computer device according to the 27th aspect; —a first display panel having a first vertical resolution and a second display panel having a second vertical resolution smaller than the first vertical resolution, the first and second display panel being operatively connected to said computer device.

According to a 29th aspect, the present invention provides a computer implemented method for allowing a smooth transition of a mouse cursor from a first position on a first display panel to a second position on a second display panel, the first and second display panel being operatively connected to a computer device, the computer device running an operating system with a graphical user interface that provides a native mouse cursor; the method comprising the steps of: a) determining parameters of the first display panel; b) determining parameters of the second display panel; c) determining parameters of one or more transition zones based on the parameters of the first display panel and/or the parameters of the second display panel; repeating at least once: d) determining a current position of the native mouse cursor; e) testing whether the determined position is located in the one or more transition zones, and if an outcome of the test is TRUE, performing step f); f) adjusting the position of the native mouse cursor to a position outside the one or more transition zones.

In an embodiment, step c) comprises choosing at least one rectangular transition zone having a width of 1 to 10 pixels.

In an embodiment, step c) comprises choosing at least one rectangular transition zone having a height of 5 to 10 pixels.

In an embodiment, step f) comprises setting a vertical position of the native mouse cursor to a value larger than the height of the transition zone.

According to a 30th aspect, the present invention provides a computer program product containing executable instructions which perform the method according to the 29th aspect, when being executed on a computer device having or being operatively connected to two display panels, and having or being connected to at least one pointer device, the computer device comprising an operating system with a graphical user interface that provides said native mouse cursor.

According to a 31st aspect, the present invention provides a computer device, comprising: —an operating system with a graphical user interface providing a native mouse cursor; —a computer program product according to the 30th aspect.

According to a 32nd aspect, the present invention provides a computer system, comprising: —a computer device according to the 31st aspect; —a first display panel and a second display panel, both operatively connected to said computer device; —at least one pointer device operatively connected to said computer device.

Particular and preferred aspects of the present invention are set out in the accompanying independent and dependent claims. Features from the dependent claims may be combined with features of the independent claims and with features of other dependent claims as appropriate and not merely as explicitly set out in the claims.

These and other aspects of the invention will be apparent from and elucidated with reference to the embodiment(s) described hereinafter.

### BRIEF DESCRIPTION OF THE DRAWINGS

FIG. 1 shows an example of how a translator or proofreader can compare an original document and a translation thereof, using a classical computer system.

FIG. 2 shows an example of how a person reading and editing or amending or commenting an electronic text document can use his finger to “remember” the position where he is reading, when he moves the mouse cursor to the menu bar to select a tool or a color, or the like, using a classical computer system.

FIG. 3 shows an example of how a person reading or editing a single text document can use his finger to point at one position in the document, and use the mouse cursor to point at another location within that single document, using a classical computer system.

FIG. 4 shows an example of how a person can transcribe an audio file, using a classical computer system. FIG. 4(a) shows how an audio player can be started to play an audio fragment. FIG. 4(b) shows how the audio player is temporarily stopped, and text is being typed in a text document.

FIG. 5 shows a computer system according to an embodiment of the present invention, where a computer device is connected to a first and to a second pointer device, and is running an O/S and GUI providing a native mouse pointer/cursor (e.g. a white arrow), and is running an overlay application according to an embodiment of the present invention. The overlay application maintains a first pointer position in accordance with movements of the first pointer device, and maintains a second pointer position in accordance with movements of the second pointer device, and adjusts, e.g. overrides the position of the native mouse pointer/cursor in accordance with movements of the first pointer device. In addition, the overlay application provides a second visible object (e.g. a line or rectangle) which moves in accordance with movements of the second pointer device. FIG. 5(a) shows movements of the first visible object in accordance with movements of the first pointer device. FIG. 5(b) shows movements of the second visible object in accordance with movements of the second pointer device. FIG. 5(c) is a schematic representation of a so called “Z-order” of windows or image planes and a “cursor plane” as can be used in the computer system of FIG. 5(a). FIG. 5(d) is a high-level flowchart illustrating a computer implemented method according to an embodiment of the present invention, as can be used in the computer system of FIG. 5(a). FIG. 5(e) is a more detailed flowchart illustrating a computer implemented method according to an embodiment of the present invention, as can be used in the computer system of FIG. 5(a). FIG. 5(f) shows a simplified high-level block diagram of hardware and software components situated in the computer system of FIG. 5(a). FIG. 5(g) shows a few lines of pseudo-code illustrating a portion of a simplified message handler as may be used by the overlay application. FIG. 5(h) shows a few lines of pseudo-code illustrating a portion of a simplified object reposition routine as may be used by the overlay application to reposition the second visible object.

FIG. 6 shows a computer system according to an embodiment of the present invention, where a computer device is connected to a first and to a second pointer device, and is running an O/S and GUI providing a native mouse pointer/cursor (e.g. a white arrow), and is running an overlay application according to an embodiment of the present invention. The overlay application maintains a first pointer position in accordance with movements of the first pointer device, and maintains a second pointer position in accordance with movements of the second pointer device, and adjusts, e.g. overrides the position of the native mouse pointer/cursor in accordance with movements of the first pointer device. In addition, the overlay application provides a second visible object (e.g. a line or rectangle) which moves in accordance with movements of the second pointer device, and provides a third visible object, which moves in accordance with movements of the first pointer device. FIG. 6(a) shows movements of the first and third visible object in accordance with movements of the first pointer device. FIG. 6(b) shows movements of the second visible object in accordance with movements of the second pointer device. FIG. 6(c) shows a few lines of pseudo-code illustrating a portion of a simplified position-update routine as may be used by the overlay application to reposition the second and the third visible object.

FIG. 7 shows a computer system according to an embodiment of the present invention, where a computer device is connected to a first and to a second pointer device, and is running an O/S and GUI providing a native mouse pointer/cursor (e.g. a white arrow), and is running an overlay application according to an embodiment of the present invention. The overlay application maintains a first pointer position in accordance with movements of the first pointer device, and maintains a second pointer position in accordance with movements of the second pointer device, and adjusts, e.g. overrides the position of the native mouse pointer/cursor in accordance with movements of the pointer device which is most recently moved. In addition, the overlay application provides a second visible object (e.g. a line or rectangle) which moves in accordance with movements of the second pointer device, and provides a third visible object, which moves in accordance with movements of the first pointer device. FIG. 7(a) shows movements of the first and third visible object in accordance with movements of the first pointer device. FIG. 7(b) shows movements of the first and second visible object in accordance with movements of the second pointer device. FIG. 7(c) is a high-level flowchart illustrating a computer implemented method according to an embodiment of the present invention, as can be used in the computer system of FIG. 7(a). FIG. 7(d) is a more detailed flowchart illustrating a computer implemented method according to an embodiment of the present invention, as can be used in the computer system of FIG. 7(a). FIG. 7(e) shows a few lines of pseudo-code illustrating a portion of a simplified message handler as may be used by the overlay application.

FIG. 8 shows a computer system according to an embodiment of the present invention, where a computer device is connected to a first and to a second pointer device, and is running an O/S and GUI providing a native mouse pointer/cursor (e.g. a white arrow), and is running an overlay application according to an embodiment of the present invention. The overlay application maintains a first pointer position in accordance with movements of the first pointer device, and maintains a second pointer position in accordance with movements of the second pointer device, and adapts, e.g. overrides the position of the native mouse pointer/cursor in accordance with movements of the first pointer device. In addition, the overlay application provides a second visible object (e.g. a black arrow) which moves in accordance with movements of the second pointer device. FIG. 8(a) shows movements of the first visible object in accordance with movements of the first pointer device. FIG. 8(b) shows movements of the second visible object in accordance with movements of the second pointer device. FIG. 8(c) is a schematic representation of a so called “Z-order” of windows or image planes and a “cursor plane” as may be used in the computer system of FIG. 8(a).

FIG. 9 shows a computer system according to an embodiment of the present invention, and is a variant of the system shown in FIG. 8. Where the embodiment of FIG. 8 is especially useful for right-handed people, the embodiment of FIG. 9 is especially useful for left-handed people. FIG. 9(a) shows movements of the second visible object (e.g. a black arrow) in accordance with movements of the first pointer device. FIG. 9(b) shows movements of the first visible object (e.g. the native mouse cursor/pointer, here in the form of a white arrow) in accordance with movements of the second pointer device. FIG. 9(c) shows a few lines of pseudo-code illustrating a portion of a simplified message handler as may be used by the overlay application.

FIG. 10 shows a computer system according to an embodiment of the present invention, where a computer device is connected to a first and to a second pointer device, and is running an O/S and GUI providing a native mouse pointer/cursor (e.g. a white arrow), and is running an overlay application according to an embodiment of the present invention. The overlay application maintains a first pointer position in accordance with movements of the first pointer device, and maintains a second pointer position in accordance with movements of the second pointer device, and adapts, e.g. overrides the position of the native mouse pointer/cursor in accordance with movements of the pointer device which is most recently moved. In addition, the overlay application provides a second visible object (e.g. a black arrow) which assumes the other maintained position. FIG. 10(a) shows movements of the first visible object (e.g. the native mouse cursor/pointer) in accordance with movements of the first pointer device (the pointer device being moved), while the second visible object is located at the other maintained position. FIG. 10(b) shows movements of the first visible object in accordance with movements of the second pointer device (the pointer device being moved), while the second visible object (the black arrow) is located at the other maintained position.

FIG. 11 shows a simplified high-level block diagram of hardware and software components situated in a computer system according to an embodiment of the present invention, the computer system comprising a computer device with a special overlay application according to an embodiment of the present invention, and two classical pointer devices directly connected to the computer device.

FIG. 12 shows a simplified high-level block diagram of hardware and software components situated in a computer system according to an embodiment of the present invention, the computer system comprising a computer device with a special overlay application according to an embodiment of the present invention, and two classical pointer devices connected to the computer device via a classical hub.

FIG. 13 shows a few lines of pseudo-code illustrating a portion of a first message handler routine as can be used in overlay applications according to embodiments of the present invention.

FIG. 14(a) to FIG. 14(c) and FIG. 15 show exemplary sequences of signals or messages coming from two classical mouse devices, and show how these signals are satisfactorily handled by the first message handler process illustrated in FIG. 13.

FIG. 16 and FIG. 17 show two exemplary sequences of signals or messages coming from two classical mouse devices, and show how these signals are unsatisfactorily handled by the message handler process illustrated in FIG. 13.

FIG. 18(a) shows a few lines of pseudo-code illustrating a portion of a second message handler routine as can be used in overlay applications according embodiments of the present invention.

FIG. 18(b) shows a variant of the routine of FIG. 18(a), as can be used in overlay applications according embodiments of the present invention.

FIG. 18(c) shows a more complete version of the routine of FIG. 18(a), as can be used in overlay applications according embodiments of the present invention.

FIG. 19 and FIG. 20 show two exemplary sequences of signals or messages coming from two classical mouse devices, and show how these signals are satisfactorily handled by the second message handler process illustrated in FIG. 18(a).

FIG. 21 shows an exemplary sequence of signals or messages coming from two classical mouse devices, and shows how these signals are unsatisfactorily handled by the second message handler process illustrated in FIG. 18(a).

FIG. 22(a) and FIG. 22(b) show two exemplary sequences of signals coming from two special pointer devices according to an embodiment of the present invention, and show how these signals or messages are satisfactorily handled by the second message handler process illustrated in FIG. 18(a).

FIG. 23(a) shows a simplified high-level block diagram of hardware and software components situated in a computer system according to an embodiment of the present invention, the computer system comprising a computer device with a special overlay application according to an embodiment of the present invention, and comprising two special mouse devices according to an embodiment of the present invention.

FIG. 23(b) shows an exemplary block-diagram of a special mouse device according to an embodiment of the present invention, as can be used in the system of FIG. 23(a).

FIG. 24 shows a simplified high-level block diagram of hardware and software components situated in a computer system according to an embodiment of the present invention, the computer system comprising a computer device with a special overlay application according to an embodiment of the present invention, and comprising two special mouse devices according to an embodiment of the present invention, connected to the computer device via a classical hub.

FIG. 25 shows a simplified high-level block diagram of hardware and software components situated in a computer system according to an embodiment of the present invention, the computer system comprising a computer device with a special overlay application according to an embodiment of the present invention, and comprising two classical mouse devices connected to the computer device via a special adaptor or hub or dongle according to an embodiment of the present invention.

FIG. 26(a) to FIG. 26(d) show exemplary sequences of signals or messages coming from the two classical pointer devices of FIG. 25, and show how these signals or messages are handled by a message handler process illustrated in FIG. 18, after passing through the special adaptor or hub or dongle.

FIG. 27(a) shows an exemplary block-diagram of a hub (or dongle or adapter) according to an embodiment of the present invention, as can be used in the system of FIG. 25, having at least two physical connectors for connection with two classical wired pointer devices.

FIG. 27(b) shows an exemplary block-diagram of a wireless hub (or dongle or adapter) according to an embodiment of the present invention, as can be used in the system of FIG. 25, having one or two RF transceivers for operative connection with two classical wireless pointer devices.

FIG. 28(a) shows an exemplary user-interface window, referred to herein as the “mini user interface” supporting a plurality of input modes and a plurality of display modes.

FIG. 28(b) shows an exemplary pop-up menu as can be used in embodiments of the present invention.

FIG. 29 shows an exemplary user-interface window, referred to herein as the “main user interface”, as can be used in embodiments of the present invention, e.g. to select an input mode and/or a display mode, and/or to select a size and/or a color of the second or further visible object, and/or to select or tune a semi-transparency level, and/or to select a semi-transparent textured background.

FIG. 30 and FIG. 31(a) show an enlarged view of a portion of FIG. 29.

FIG. 31(b) is a variant of the portion of FIG. 31(a), where a feature is added to force cursor movements to be only horizontal (East/West) or vertical (North/South) or diagonal (North-East, North-West, South-East, South-West).

FIG. 31(c) shows a few lines of pseudo-code which can be used in the position update routine for achieving this effect.

FIG. 31(d) and FIG. 31(e) illustrate a variant of the displacement transformation routine, where near-horizontal movements are transformed into pure horizontal movements.

FIG. 32 shows a computer system according to an embodiment of the present invention, where the computer device is running an O/S and GUI and two applications (e.g. a PDF document viewer and a text editor), and is running an overlay application according to an embodiment of the present invention. The overlay application is configured to reposition the native mouse cursor and to show two movable lines, which move in accordance with movements of the pointer devices.

FIG. 33 shows a variant of the computer system of FIG. 32, where the overlay application is configured to reposition the native mouse cursor and to show two movable squares, which move in accordance with movements of the pointer devices.

FIG. 34 shows another variant of the computer system of FIG. 32, where the overlay application is configured to reposition the native mouse cursor and to show two visible objects, one object containing an image of a left hand, and the other object containing an image of a right hand, which images move in accordance with movements of the pointer devices.

FIG. 35 shows a computer system according to an embodiment of the present invention, where the computer device is running an O/S and GUI and an exemplary application (e.g. a PDF document editor), and is running an overlay application according to an embodiment of the present invention. The overlay application is configured to reposition the native mouse cursor and to show a movable line, in accordance with movements of the pointer devices.

FIG. 36 shows a variant of the computer system of FIG. 35, where the overlay application is configured to reposition the native mouse cursor and to show a movable cross, in accordance with movements of the pointer devices.

FIG. 37 shows a computer system according to an embodiment of the present invention, where the computer device is running an O/S and GUI and an exemplary application (e.g. a text editor), and is running an overlay application according to an embodiment of the present invention. The overlay application is configured to reposition the native mouse cursor and to show two movable lines, in accordance with movements of the pointer devices.

FIG. 38 shows a variant of the computer system of FIG. 37, where the overlay application is configured to reposition the native mouse cursor and to show two movable crosses, in accordance with movements of the pointer devices.

FIG. 39 shows a computer system according to an embodiment of the present invention, where the computer device is running an O/S and GUI and an exemplary application (e.g. a text editor), and is running an overlay application according to an embodiment of the present invention. The overlay application is configured to reposition the native mouse cursor and to show a vertical line to split the screen in a left part and right part, and to show two horizontal lines which are movable vertically, in accordance with movements of the pointer devices.

FIG. 40 shows a variant of the computer system of FIG. 39, where the overlay application additionally provides two squares or rectangles inside the horizontal lines, which squares are also movable horizontally, in accordance with movements of the pointer devices.

FIG. 41 shows a computer system according to an embodiment of the present invention comprising a special monitor or display according to an embodiment of the present invention, directly connectable to a pointer device, the special display or monitor being adapted for overlaying the image provided by the computer device with at least one visible object which is movable in accordance with movements of the pointer device connected to the display. The O/S and GUI of the computer device shows the native mouse cursor/pointer, which is movable by the pointer device that is connected to the computer.

FIG. 42 shows an exemplary block-diagram of a display device used in the system of FIG. 41.

FIG. 43 shows a computer system according to an embodiment of the present invention comprising a video adapter device or video interface device according to an embodiment of the present invention, having an input port for receiving first graphical image data from a computer device, the computer device being connected to a first pointer device. The video adapter further comprises an output port for providing second graphical image data to a monitor or display, the video adapter further comprising a wired or wireless interface to a second pointer device, the video adapter being adapted for generating at least one visible object, and for overlaying the first graphical image data with said at least one visible object, and for moving said visible object in accordance with movements of said second pointer device connected to the video adapter.

FIG. 44 shows an exemplary hardware block-diagram of the video adapter device of FIG. 43.

It is noted that the timing diagrams shown herein are high-level timing diagrams, and many details are omitted, which are not relevant for understanding the principles of the present invention.

FIG. 45 shows a window which may be shown at the start-up of the overlay-application, for allowing a user to indicate which pointer devices connected to the computer are to be considered as the “left” and the “right” pointer device.

FIG. 46 shows a computer system according to an embodiment of the present invention, where a computer device is connected to a first and to a second pointer device, and is running an O/S and GUI maintaining a single native mouse cursor position, and is running an application according to an embodiment of the present invention. The application maintains a first pointer position in accordance with movements of the first pointer device, and maintains a second pointer position in accordance with movements of the second pointer device, and adjusts, e.g. overrides the position of the native mouse pointer/cursor in accordance with movements of only the left pointer device (if configured for left handed people) or in accordance with movements of only the right pointer device (if configured for right handed people), or in according with the pointer device which is most recently moved (if configured for both-handed people). The application further provides a first visible object at the first maintained position, and a second visible object at the second maintained position.

FIG. 47 shows a simplified high-level block diagram of hardware and software components situated in the computer system of FIG. 46, comprising a computer device with a special application according to an embodiment of the present invention, and comprising two classical mouse devices connected to the computer device.

FIG. 48 to FIG. 50 illustrate another aspect of the present invention, related to a computer system comprising a computer device operatively connected to two displays having a different screen resolution.

FIG. 48(a) shows an exemplary hardware configuration of the computer system.

FIG. 48(b) is a schematic drawing showing the total operative display area, and showing two intended paths of movement of the mouse pointer from a point on the first display panel to a point on the second display panel, the upper path not having any obstructions, the lower path encountering a virtual wall near the right bottom of the display panel with with the higher resolution.

FIG. 48(c) shows a solution provided by the present invention to avoid the mouse pointer being blocked by the virtual wall, based on automatically moving or shifting the mouse pointer out of a forbidden zone adjacent the virtual wall.

FIG. 49 illustrates a computer implemented method that can be used in the computer system of FIG. 48(a) to implement the behaviour shown in FIG. 48(c).

FIG. 50 to FIG. 53 illustrate another aspect of the present invention, related to a computer system comprising a computer device operatively connected to two displays having the same or having a different screen resolution.

FIG. 50 shows an exemplary hardware configuration of the computer system comprising a computer device operatively connected to two identical display panels, and at least one pointer device and an optional keyboard.

FIG. 51 illustrates another virtual wall encountered at the top right corner of the first display panel, which is encountered when moving a mouse cursor from a first display panel to a second display panel (from left to right in FIG. 51) near the top of the display panel, and shows a solution proposed by the present invention.

FIG. 52 illustrates another virtual wall encountered at the top left corner of the second display panel, which is encountered when moving a mouse cursor from a second display panel to a first display panel (from right to left in FIG. 52) near the top of the display panel, and shows a solution proposed by the present invention.

FIG. 53 illustrates a computer implemented method that can be used in the computer system of FIG. 50 to implement the behaviour shown in FIG. 51 and/or FIG. 52.

### DETAILED DESCRIPTION OF ILLUSTRATIVE EMBODIMENTS

The present invention will be described with respect to particular embodiments and with reference to certain drawings but the invention is not limited thereto but only by the claims. The drawings described are only schematic and are non-limiting. In the drawings, the size of some of the elements may be exaggerated and not drawn on scale for illustrative purposes. The dimensions and the relative dimensions may not correspond to actual reductions to practice of the invention.

Furthermore, the terms first, second and the like in the description and in the claims, are used for distinguishing between similar elements and not necessarily for describing a sequence, either temporally, spatially, in ranking or in any other manner. It is to be understood that the terms so used are interchangeable under appropriate circumstances and that the embodiments of the invention described herein are capable of operating in other sequences than described or illustrated herein.

It is to be noticed that the term “comprising”, used in the claims, should not be interpreted as being restricted to the means listed thereafter; it does not exclude other elements or steps. It is thus to be interpreted as specifying the presence of the stated features, integers, steps or components as referred to, but does not preclude the presence or addition of one or more other features, integers, steps or components, or groups thereof. Thus, the scope of the expression “a device comprising means A and B” should not be limited to devices consisting only of components A and B. It means that with respect to the present invention, the only relevant components of the device are A and B.

Reference throughout this specification to “one embodiment” or “an embodiment” means that a particular feature, structure or characteristic described in connection with the embodiment is included in at least one embodiment of the present invention. Thus, appearances of the phrases “in one embodiment” or “in an embodiment” in various places throughout this specification are not necessarily all referring to the same embodiment, but may. Furthermore, the particular features, structures or characteristics may be combined in any suitable manner, as would be apparent to one of ordinary skill in the art from this disclosure, in one or more embodiments.

Similarly, it should be appreciated that in the description of exemplary embodiments of the invention, various features of the invention are sometimes grouped together in a single embodiment, figure, or description thereof for the purpose of streamlining the disclosure and aiding in the understanding of one or more of the various inventive aspects. This method of disclosure, however, is not to be interpreted as reflecting an intention that the claimed invention requires more features than are expressly recited in each claim. Rather, as the following claims reflect, inventive aspects lie in less than all features of a single foregoing disclosed embodiment. Thus, the claims following the detailed description are hereby expressly incorporated into this detailed description, with each claim standing on its own as a separate embodiment of this invention.

Furthermore, while some embodiments described herein include some but not other features included in other embodiments, combinations of features of different embodiments are meant to be within the scope of the invention, and form different embodiments, as would be understood by those in the art. For example, in the following claims, any of the claimed embodiments can be used in any combination.

In the description provided herein, numerous specific details are set forth. However, it is understood that embodiments of the invention may be practiced without these specific details. In other instances, well-known methods, structures and techniques have not been shown in detail in order not to obscure an understanding of this description.

In this document the terms “alpha-blending” and “mixing” (of images or bitmaps) are used as synonyms. In the context of graphical overlay, there is an upper image (having a higher Z-order) and a lower image (having a lower Z-order). The mixing can be done in hardware and/or software, and is based on a parameter called “alpha-blending value” α, which refers to the level of mixing the two images, where α=0% means that the original image (with the lower Z-order) is not mixed with the overlay image (or that the overlay image is fully transparent), and where α=100% means that the resulting pixel value is that of the overlay image (or that the overlay image is fully opaque except for fully transparent pixels). The alpha-blending value may be expressed on a scale from 0 to 255, where α=255 corresponds to α=100% and α=0 corresponds to α=0%. Alpha-blending can for example be used to fade-in or fade out a graphical image. In the context of the present invention there may also be a second parameter involved in the mixing, referred to as “TransparentColorValue”. If a pixel of the overlay image has this predefined value, this pixel is treated as “fully transparent”. Fully transparent pixels are typically used at the circumference of a bitmap, for example for showing a rectangular image with rounded edges or rounded corners. “Alpha-blending” and “fully transparent pixels” are both well known in the art.

In this document, the terms “word processor” or “text editor” should not be interpreted too narrow, because many so called word processors (such as e.g. Microsoft Word) also have drawing capabilities. Likewise, the term “spreadsheet” or “worksheet” should not be interpreted too narrow, because many so called worksheet applications, e.g. Microsoft Excel, also have graphical capabilities.

The expression “the overlay window is configured in click-through mode” or “the overlay window is configured in pass-through mode” means that the overlay window is configured in such a way that events from input devices (such as e.g. a mouse, a keyboard, a trackball, a touchpad, a stylus, a joystick, etc.) are sent by the operating system to one or more underlying application windows or to objects thereof, despite the higher Z-order of the overlay application, and despite the native mouse cursor being located over the area defined by the overlay window. The message being “passed through to lower windows” applies for example to events caused by a button press, and to a button release, and to a button click, and to a scroll event of a mouse wheel, and to movements of the pointer device. In the context of the present invention, the overlay application typically comprises one window configured in click-through mode, and optionally but preferably also contains a second, mainly opaque window with user interface elements, not configured in click-through mode.

In this document, the expression “the window is configured in non-click-through mode” means that the window is “not configured in click-through mode”.

In this document, the term “work area” refers to a portion of the pixel area of a screen, namely the area that will typically be occupied by an application in case it is be maximized. In a Microsoft Windows environment, the “work area” means the entire pixel area or the area of the desktop minus the so called “taskbar”, which is typically located at the bottom of the screen.

In this document the terms “mouse pointer” and “mouse cursor” are used as synonyms, and refer to a symbol or graphical image on a computer monitor or other display device that echoes movements of a pointing device, e.g. a mouse, touchpad, or stylus pen. This pointer or cursor can assume different shapes, such as for example an “arrow” or a “crosshair” (looking like a roman number “I”) or as a “hand” etc.

In this document, the terms “display” and “monitor” and “screen” are used as synonyms.

In this document, the terms “line” or “bar” or “line segment” are used as synonyms. They refer to an elongated, for example a rectangular object, optionally with rounded edges or rounded corners.

In this document the expression “the mouse cursor or pointer follows movements of the pointer device” means that the position of the cursor or pointer is adjusted in accordance with movements of said pointer device”.

In this document the terms “first maintained position” and “position related to movements of the first pointer device” mean the same. This position is also referred to herein by Pos1 or the coordinates (x1,y1) or the coordinates (xR,yR).

In this document the “first pointer device” usually refers to the pointer device to be controlled by the right hand of a user, unless explicitly mentioned otherwise.

In this document the terms “second maintained position” and “position related to movements of the second pointer device” mean the same. This position is also referred to herein by Pos2 or the coordinates (x2,y2) or the coordinates (xL,yL).

In this document the “second pointer device” usually refers to the pointer device to be controlled by the left hand of a user, unless explicitly mentioned otherwise.

In this document, the expression “shifting focus between two documents” means shifting focus between two locations on the screen, for example between a first window associated with a first application (e.g. a PDF viewer) showing a portion of a first document, and a second window associated with a second application (e.g. a text editor) showing a portion of a second document, unless explicitly mentioned otherwise.

In this document, the term “host” means a “computer device”, unless explicitly mentioned otherwise.

In this document, the terms “signal” and “message” sent by a pointer device mean the same.

In this document the term “underlining” or “highlighting” of a text fragment means seemingly or virtually underlining or highlighting said text fragment by means of an overlaid object.

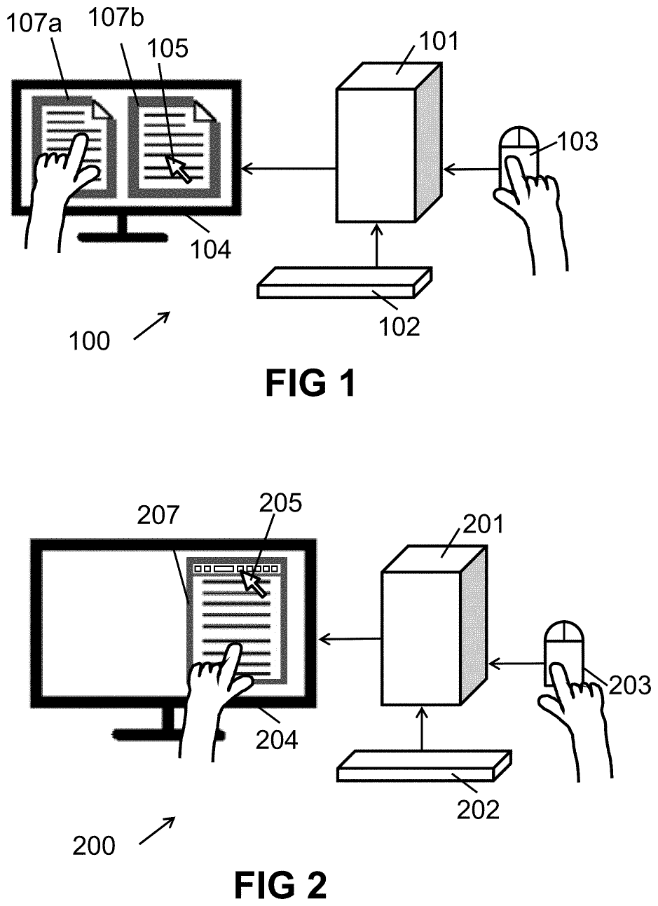

As described in the background section and as illustrated in FIG. 1 to FIG. 4, there are many occasions when a computer user would want that the computer system had a mechanism that allows the user to read and/or write and/or click at two different locations on a screen, whereas typically today, in all major operating systems for personal computers with a graphical user interface, only a single visible object known as “mouse pointer” or “mouse cursor” is supported.

Even though the present invention is not limited to “Windows compatible” computers, running a version of the “Windows” operating system from Microsoft Corporation (Redmond, USA), the present invention will be explained primarily with such computers in mind, in order to simplify the description. But the principles of the present invention will also work for other computers with an operating system O/S and a graphical user interface GUI that provides only a single mouse pointer, such as for example Mac OS from Apple Inc.

Even though the present invention is not limited to working with two “mouse devices”, the present invention will be explained with two mouse devices in mind, in order to simplify the description. But the principles of the present invention will also work with other pointer devices, such as for example a touchpad or a trackball or a stylus or the like.

The problems a translator or proofreader or writer or transcriber is confronted with in the cases illustrated in FIG. 1 to FIG. 4, are related to a feature (or shortcoming) of operating systems with a GUI that maintains only a single mouse cursor or mouse pointer. From a commercial point of view, one might think that there is a simple solution to these problems, namely to connect a second pointer device to the computer device and hope that a second mouse cursor will somehow appear that follows movements of the second pointer device. Unfortunately, classical operating systems for personal computers such as e.g. Windows and macOS do not work that way, because they maintain only a single cursor position, and although multiple pointer devices can be physically connected to the computer device, all signals coming from these pointer devices are routed to said single cursor position. For example, when two USB-mouse devices are connected to a laptop computer running Windows 7 or Windows 10, the Windows native mouse cursor can be moved e.g. to the left by moving any of these mouse devices to the left. No second mouse cursor will automatically appear.

In contrast, the present invention provides a computer system that supports two pointer devices and provides two or at least two visible objects, which are individually movable by said two pointer devices, for example a first mouse device and a second mouse device.

While it would be technically possible to develop a new operating system with inherent support for multiple pointer devices and multiple cursors, such solution is not a realistic option. The inventors of the present invention therefore tried to find a solution based on an existing operating system O/S with a graphical user interface GUI that provides a single native mouse cursor, and to extend or enhance its functionality, ideally in such a way that most or all existing applications can benefit without modification of these applications.

As will be explained in more detail further, the present invention proposes to address the problem not in the “device driver layer” but as a “graphical overlay application” comprising a window configured in “click-through”-mode. This is one of the underlying principles of the present invention. This solution is believed not to be trivial, inter alia because:
i) the logical place to solve a problem related to input devices is in the device driver layer, not by overlaying the application;
ii) it is not logical to configure a window of the overlay application in “click through mode” because that means that the O/S will not send messages related to the pointer devices (e.g. “a movement message” when the pointer device is moved, a “button-press message” when a button is pressed, a “button-release message” when a button is released, a “scrollwheel-rotation message” when a scrollwheel is rotated, etc.) to this overlay application, thereby inhibiting that the overlay application can filter or block or alter these messages.

Instead, the O/S is configured to send raw input messages, and the overlay application of the present invention is configured to receive these raw input messages from the O/S, and the overlay application provides a message handler to process these messages, but (as the inventors discovered only during testing) the overlay application receives these messages only after the O/S has already processed them.

Another underlying principle of the present invention is that use is made of the native mouse cursor provided by the O/S and GUI as one of the at least two visible and movable objects. This solution is believed not to be trivial either, because the O/S and GUI will receive the input messages from the pointer devices via the device driver layer, and will want to position the native mouse cursor in their own way, namely by moving the native mouse cursor in accordance with movements from any pointer device. As will be explained further, the overlay application of the present invention will override this position.

Using the native mouse cursor of the O/S and GUI as one of the visible objects offers the major benefit that the look and feel of this mouse cursor remains under control of the O/S and GUI and the other applications most of the time, except when the mouse cursor hovers over a user-interface window of the overlay application. Thus, the solution provided by the present invention allows the mouse pointer to change shape depending on the context of the application underneath the overlay application, e.g. into “an arrow pointer” or an “I-beam pointer” or an “hour glass pointer” etc.

Referring now to the Figures.

FIG. 1 to FIG. 4 are already described in the background section, and illustrate several practical examples when a single user (in particular a professional user) would want to use a personal computer with two pointer devices, one controllable by his/her dominant hand, the other controllable by his/her non-dominant hand.

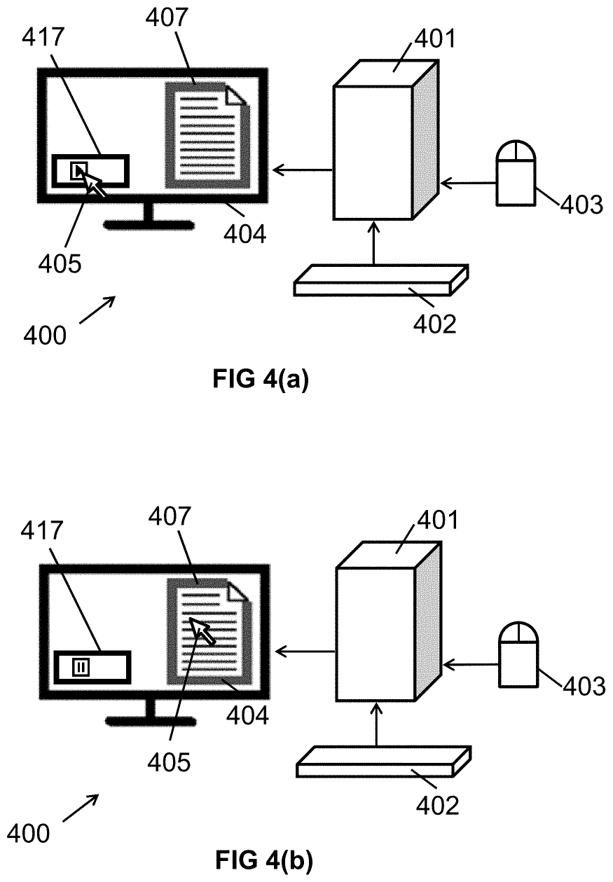

In order to quantify the requirements of a potential solution with two pointer devices, it is assumed that the user of FIG. 1 to FIG. 4 is right-handed, and that the computer device of FIG. 1 to FIG. 4 would be connected to two pointer devices: a “right mouse device” for the right hand, and a “left mouse device” for the left hand, then:
(1) the user of FIG. 1 and FIG. 2 and FIG. 3 would want to move and/or click and/or scroll the right mouse device, and would want to move the left mouse device, but would not necessarily need to click and/or scroll the left mouse device;
(2) alternatively the user of FIG. 1 may want to move and/or click and/or scroll the right mouse device, and may want to move and/or drag (i.e. press and move and release) and/or scroll the left mouse device;
(3) the user of FIG. 4 would want to move and/or click and/or scroll the right mouse device, and would want to move and/or click the left mouse device, but would not necessarily need to scroll the left mouse device.

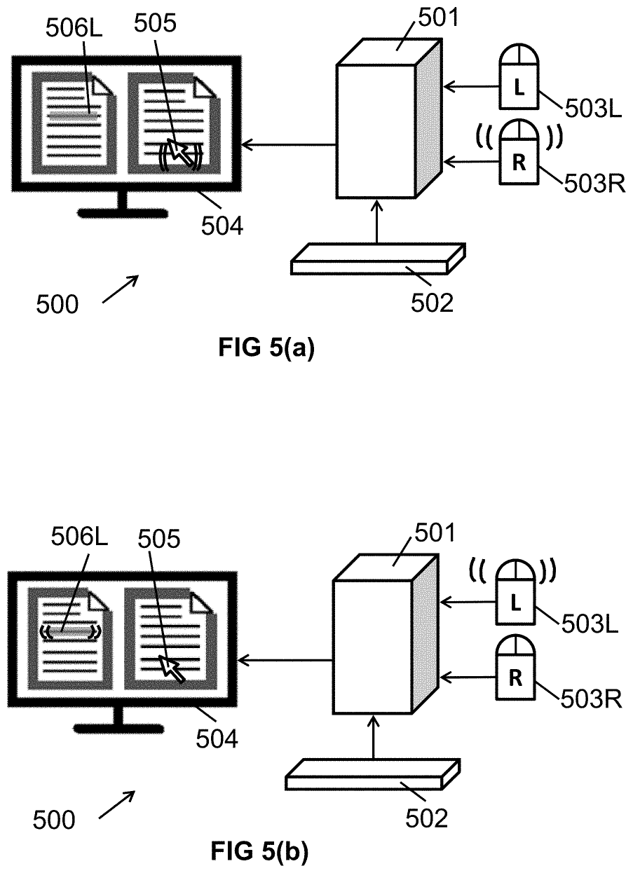

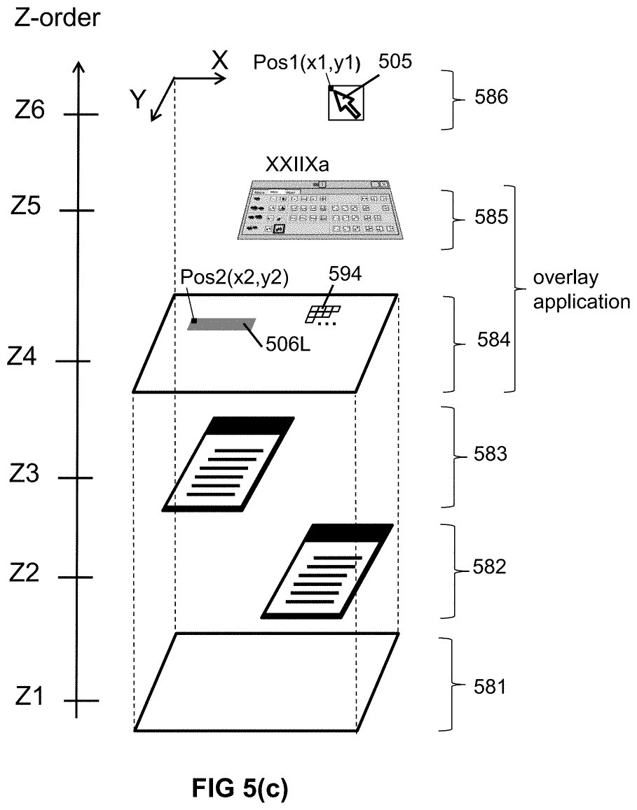

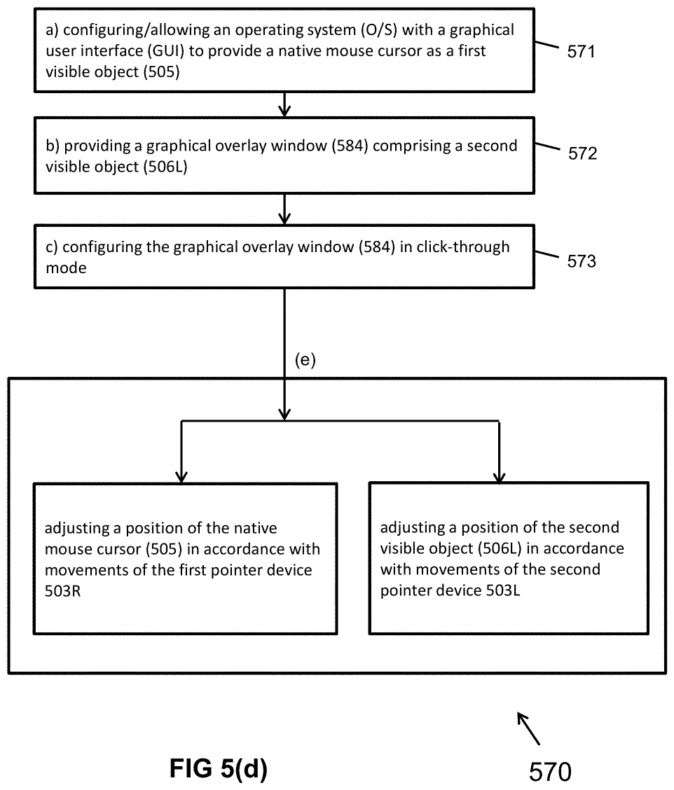

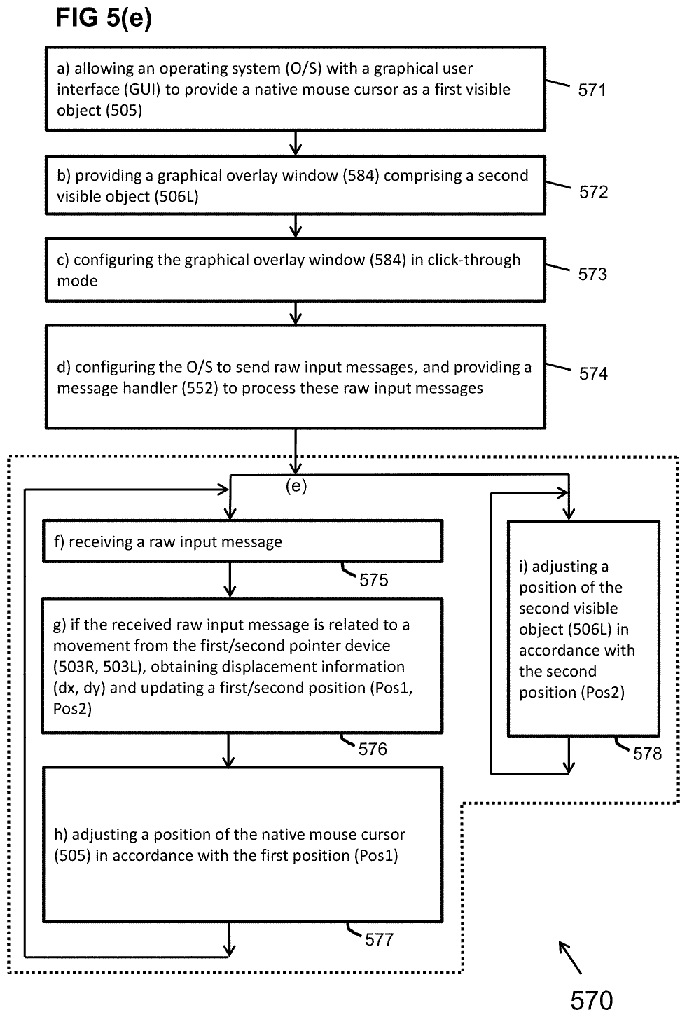

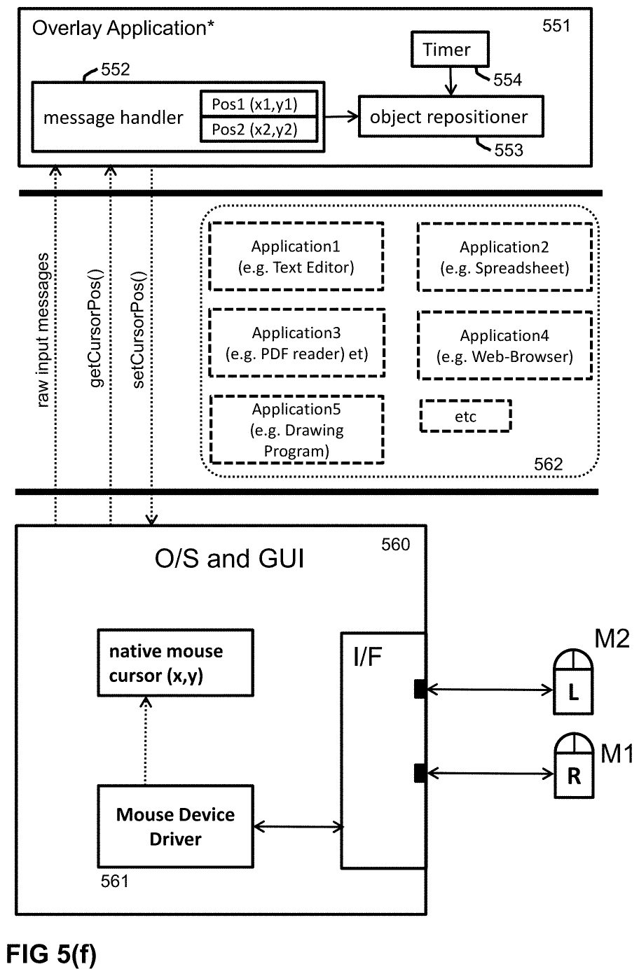

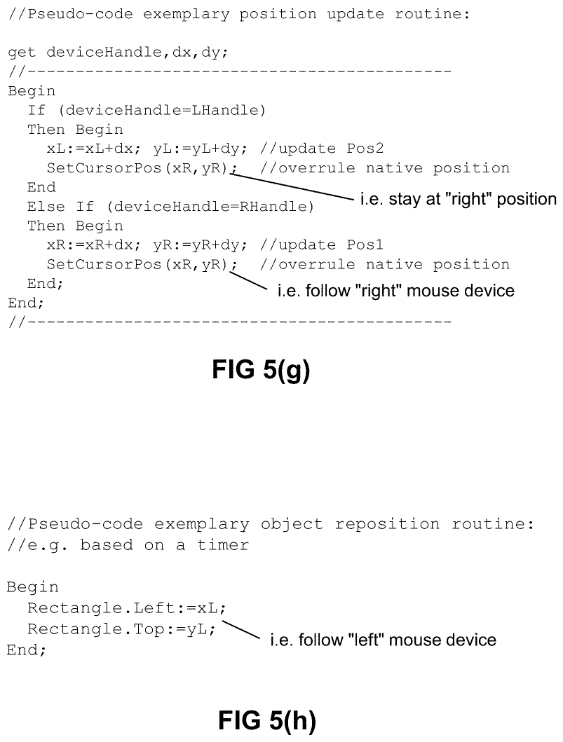

FIG. 5 shows a computer system 500 according to an embodiment of the present invention, comprising a computer device 501 and two pointer devices 503R, 503L and a display 504 and optionally a keyboard 502. The computer device 501 is connected to a first pointer device 503R and to a second pointer device 503L, and is running an O/S and GUI (e.g. Windows 10 from Microsoft) providing a native mouse pointer/cursor 505 (shown here in the form of a white arrow), and is running an overlay application according to an embodiment of the present invention, and is optionally running one or more other applications, such as e.g. a text editor, a PDF document viewer, a web-browser, etc. The overlay application maintains two positions Pos1, Pos2 in accordance with movements of the first and second pointer device respectively, and repeatedly overrides the position of the native mouse pointer/cursor 505 so as to correspond with movements of the first pointer device 503R. The overlay application allows the native mouse pointer/cursor 505 of the O/S and GUI to be shown as a first visible object rather than hiding it. In addition, the overlay application provides a second visible object 506L which moves in accordance with movements of the second pointer device 503L.

FIG. 5(a) shows movements of the first visible object 505, being the native mouse cursor provided by the O/S and GUI, in accordance with movements of the first pointer device 503R. The second visible object 506L shows the second maintained position Pos2, but is stationary in FIG. 5(a).

FIG. 5(b) shows movements of the second visible object 506L provided by the overlay application, in accordance with movements of the second pointer device 503L. The first visible object 505 shows the first maintained position Pos1, but is stationary in FIG. 5(b).

FIG. 5(c) is a schematic representation of a so called “Z-order” of five windows or image planes 581-585 and a “cursor plane” 586 as may be used in the computer system 500 of FIG. 5(a) and FIG. 5(b).

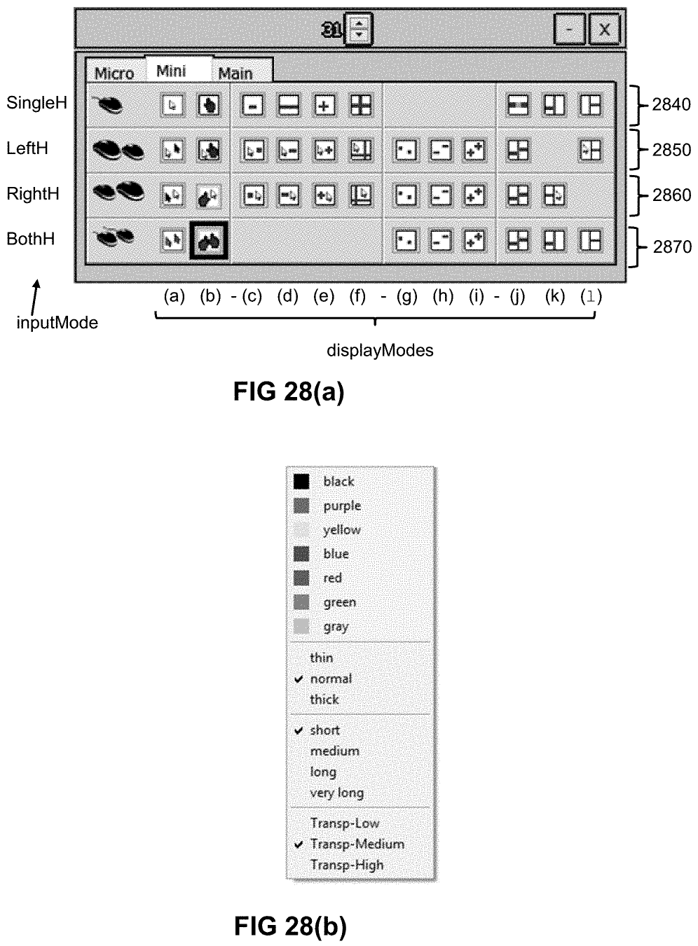

The plane 581 may be a background plane (in the case of Windows known as the “desktop”), the image plane 582 may be the visual representation of a window associated with a text editor application for example, the image plane 583 may be the visual representation of a window associated with a PDF viewer application for example, the image plane 584 may be the visual representation of a window associated with the graphical overlay application according to the present invention, the cursor plane 586 is the image plane associated with the native mouse cursor provided by the O/S and GUI, the shape of which may be modified by an underlying application. The graphical overlay application of the present invention may also have an optional user-interface window 585, an example of which will be described in FIG. 28 to FIG. 31. The user-interface window 585 is not configured in click-through mode, but is configured in non-click-through mode, meaning that its visible components (e.g. buttons, radio buttons, checkboxes, etc.) are capable of receiving (inter alia) mouse clicks.

The window 584 of the overlay application may have a size equal to the visible screen, or equal to the area of the desktop plane 581, or equal to the area of the so called work area (i.e. the area of the screen minus the area occupied by the so called “taskbar”), or another suitable size. The window 584 comprises at least one visible object 506L, for example in the form of a rectangular object. The object 506L may be opaque or semi-transparent. The object 506L may have monochrome pixels, for example red or blue pixels, or may have a bitmap with a color gradient, etc. The other pixels 594 of the window 584 may be fully transparent pixels. Alternatively the window 584 may be configured as a semi-transparent window, for example having an alpha-transparency in the range from 1% to 99%, for example in the range from 5% to 95%. In this case the pixels of the window 584 may have a color, for example a monochrome color, but the window 584 may also comprise a “perforated bitmap” or a “texture bitmap” or a perforated texture bitmap”. These aspects are described in more detail in patent application BE2017/5891 filed on 4 Dec. 2017, by the same applicant, with title “METHOD, DEVICE AND COMPUTER PROGRAM FOR OVERLAYING A GRAPHICAL IMAGE”, which document is incorporated herein by reference in its entirety, and is further referred to herein as the co-pending “perforated bitmap application”. In case of conflict between this application and the co-pending application, the present document prevails.

In the example of FIG. 5(c) the graphical overlay application has two windows:
a window 584 which is configured in click-through mode and is mainly transparent or semi-transparent (e.g. having an alpha-transparency in the range from 5% to 95%),
and another window 585 which is preferably not configured in click-through mode and which is mainly opaque.

FIG. 5(d) shows a high level flowchart of a computer implemented method 570 according to an embodiment of the present invention, for providing a first and a second visible object 505, 506L separately movable by a first pointer device 503R and a second pointer device 503L respectively.

The method can be implemented in an overlay application 551 (see FIG. 5f) which can run on the computer device 501 (see FIG. 5a), which computer device 501 also comprises an operating system O/S with a graphical user interface GUI providing a single native mouse cursor 505. The computer device 501 is connected to the first and the second pointer device 503R, 503L. The method maintains two positions Pos1 and Pos2 (see also FIG. 5f). The method illustrated in FIG. 5d comprises the following steps:
a) configuring, 571 the operating system O/S with graphical user interface GUI to provide said native mouse cursor 505 as the first visible object, e.g. by allowing the O/S to show said mouse cursor or by not explicitly hiding said mouse cursor;
b) providing 572 a graphical overlay window 584 comprising the second visible object 506L;
c) configuring 573 the graphical overlay window 584 in click-through mode;
d) adjusting a position of the native mouse cursor 505 in accordance with movements of the first pointer device 503R, and adjusting a position of the second visible object 506L in accordance with movements of the second pointer device 503L.

In an embodiment, the position of the first visible object 505 is updated at the same rate as the position of the second visible object 506L.

In another embodiment, the position of the first visible object 505 is updated at a different rate than the position of the second visible object 506L. For example, the position of the native mouse cursor may be updated in a message handler routine (see for example FIG. 5g), and the position of the second visible object may for example be updated based on a timer interrupt.

FIG. 5(f) shows a more detailed example of a computer implemented method according to an embodiment of the present invention, which can be seen as a special case of the method shown in FIG. 5(d). The method of FIG. 5(e) further comprises step d):
d) configuring 574 the operating system O/S to send raw input messages;
   In case the O/S is a Microsoft Windows variant, this step may comprise registering the application with the O/S for receiving raw input data, e.g. in the form of input messages known as WM_INPUT messages, for example using the WinAPI function RegisterRawInputDevices( ) It is noted that by default applications do not receive raw input messages.

And wherein step e) comprises: repeatedly performing:
f) receiving 575 a raw input message;
g) determining if the received raw input message is related to a movement from the first or second pointer device 503R, 503L, and if the outcome of this test is true, obtaining displacement information dx, dy related to said displacement, and updating the corresponding first or second position Pos1, Pos2; and if the outcome of this test is false, skipping step h);
h) adjusting 577 the position of the native mouse cursor 505 based on the first maintained position Pos1, or the second maintained position Pos2, or the position Pos1 or Pos2 associated with the pointer device being most recently moved and/or asserted. In the example of FIG. 5(a) and FIG. 5(b) the position of the native mouse cursor 505 is always updated in accordance with movements of the first pointer device 503R, but as will be explained further, this position may also be updated otherwise.

And wherein step e) further comprises:
repeatedly adjusting 578 a position of the second visible object 506L in accordance with the second position (Pos2). This step i) may be performed asynchronously with respect to steps f) to h), for performance reasons. Alternatively, step i) may be performed after each execution of step h).

Step g) in combination with step h) is also referred to herein as the “position update routine”, it is part of the message handler routine. Step i) is also referred to herein as “object repositioner routine”.

FIG. 5(f) shows a simplified high-level block diagram of hardware and software components situated in the computer system 500, comprising a computer device 501 with a special overlay application according to an embodiment of the present invention, and two classical pointer devices M1, M2.

The overlay application maintains two pointer positions: a first position Pos1 having coordinates (x1, y1) and a second position Pos2 having coordinates (x2, y2). A message handler 552 of the overlay application 551 will update the first and second position Pos1, Pos2 based on movements of the two pointer devices, discussed further in FIG. 5(g).

The graphical overlay application of the system 500 repeatedly adjusts the position of the native mouse cursor 505 to the first maintained position Pos1, corresponding with movements of the right mouse device 503R, and repeatedly adjusts the position of the second visible object 506L to correspond with the second maintained position Pos2, corresponding with movements of the left mouse device 503L, or vice versa.

FIG. 5(g) shows a few lines of pseudo-code to illustrate a simplified version of an message handler routine as can be used in the overlay application 551 running in the computer device 501 of FIG. 5(a) and FIG. 5(b). The message handler 552 is triggered by incoming raw messages from input devices (such as e.g. keyboard and/or pointer devices) in a manner known per se in the art. The message handler can obtain or request further information related to each message, for example to get a device handle in order to determine which pointer device has sent the message, and/or to get a horizontal and vertical displacement dx, dy indicative of a movement in the horizontal and/or vertical direction, and/or to get a value indicative of how much a scrollwheel is scrolled, etc.

As can be appreciated from the pseudo-code, if the message was sent by the left pointer device 503L, the second position Pos2 will be updated using the displacement values dx, dy, and the position of the native mouse cursor 505 will be set (or reset) to the first position Pos1 related to the right pointer device 503R. If the message was sent by the right pointer device 503R, the first position Pos1 will be updated using the displacement values dx, dy, and the position of the native mouse cursor 505 will be adjusted to move accordingly. Tests have shown that this routine also correctly handles simultaneous movements of the left and right pointer device 503L, 503R.

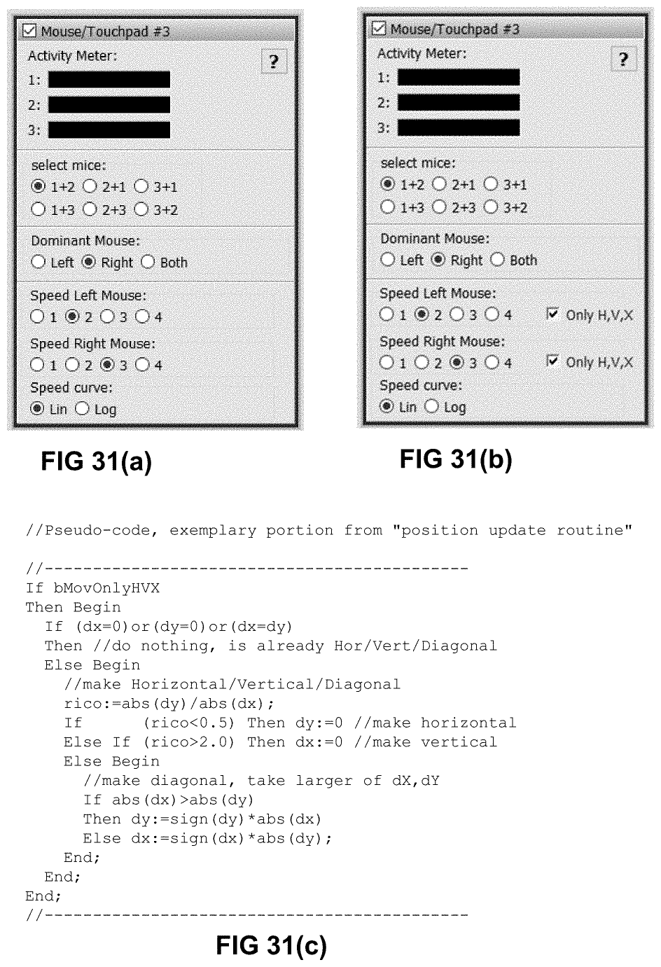

In the example shown in FIG. 5(g) the X and Y-coordinate of the first and second position Pos1, Pos2 are increased with the displacement values dx, dy as received from the pointer devices, but in practice the displacement values dx, dy may first be transformed linearly or non-linearly to make the movements more or less sensitive (see the radio buttons “Speed Left/Right Mouse” and the “speed curve” in FIG. 31a).

As will be further discussed in FIG. 31(b) and FIG. 31(c) other adjustments of the displacement values are possible.

FIG. 5(h) shows a few lines of pseudo-code to illustrate a simplified version of a routine that updates the position of the second visible object 506L, in the example being a rectangle, but the present invention is not limited thereto. This routine may be based on a timer interrupt. In this way, the update of the position of the second visible object 506L can be handled outside of the message handler, which may be preferred for performance reasons. The period of the timer can be chosen for example in the range from 1 ms to 250 ms, preferably in the range from about 1 ms to about 100 ms, for example equal to about 1 ms or about 5 ms or about 10 ms or about 20 ms or about 25 ms or about 30 ms or about 35 ms or about 40 ms or about 50 ms or about 75 ms or about 100 ms. The value of this period is not critical. The smaller this time period value, the faster the response but the higher the CPU load. The higher this time period value, the slower the response but the lower the CPU load. The skilled person can easily find a suitable value by routine experimentation. Some embodiment may allow the end-user to select a preferred timer value.

FIG. 5(a) to FIG. 5(h) illustrate a first embodiment of the present invention, especially suitable for right-handed people. The O/S and GUI provide the native mouse cursor 505, but the overlay application repeatedly adjusts its position such that the position is defined by movements of the right mouse device 503R only. The right mouse device 503R can be moved, its buttons can be pressed or released or clicked, and its scrollwheel can be scrolled as in the prior art. In addition, the overlay application shows a second visible object 506L, in the example of FIG. 5(a) having the form of a line or rectangle, and the overlay application repeatedly adjusts its position such that the position is defined by movements of the left mouse device 503L only. This embodiment successfully addresses the problems illustrated in FIG. 1 to FIG. 3. The user can use his non-dominant hand to move the second object 506L to underline or highlight text he or she wants to read, and can use his dominant hand to edit a document, select text, select menus etc. using the native mouse cursor 505. Thus the overlay application enhances the O/S and GUI by providing one additional visible object 506L which is movable by the left pointer device 503L, while keeping most or all of the functionality of the native mouse cursor. The additional visible object 506L can for example be used for underlining or highlighting text fragments.

In an embodiment, the overlay application may be a dedicated application implementing only the specific behaviour illustrated in FIG. 5(a) and FIG. 5(b), where the native mouse cursor 505 is moved by the right pointer device, and a second visible object 506L having the form of a line is movable by the left pointer device, in which case the user-interface window 585 may be omitted.

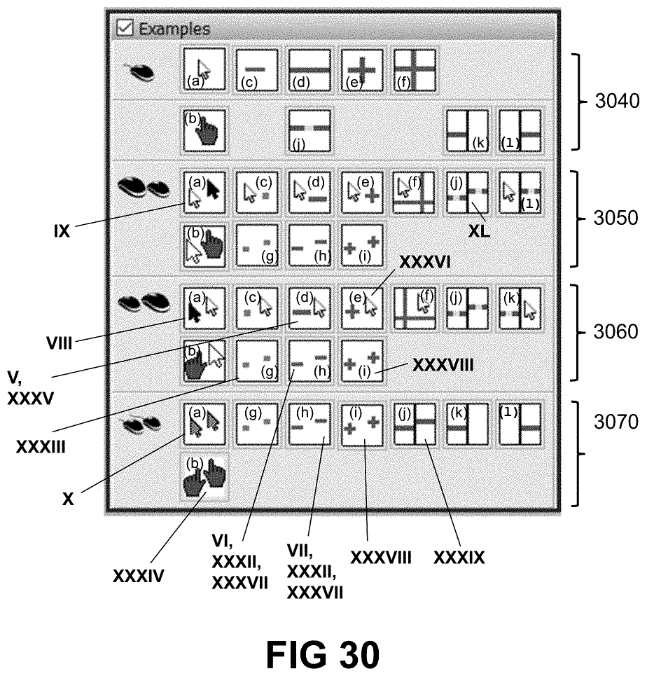

In another embodiment, the overlay application may implement several options, and a user can select a mode out of a plurality of modes. In this case a user interface window comes in handy, see for example the exemplary user interface of FIG. 28(a), e.g. mode 2860(d), and the exemplary user interface of FIG. 30, e.g. mode 3060(d). The “large right mouse” shown on the left side of FIG. 28(a) is a hint to the user that the right mouse is the dominant mouse for the modes 3060, meaning that the “right mouse device” controls the native mouse cursor 505. The “small left mouse” is a hint to the user that the left mouse device is the non-dominant mouse controlling the second visible object, in the case of mode 2860(d) being a line or rectangle.

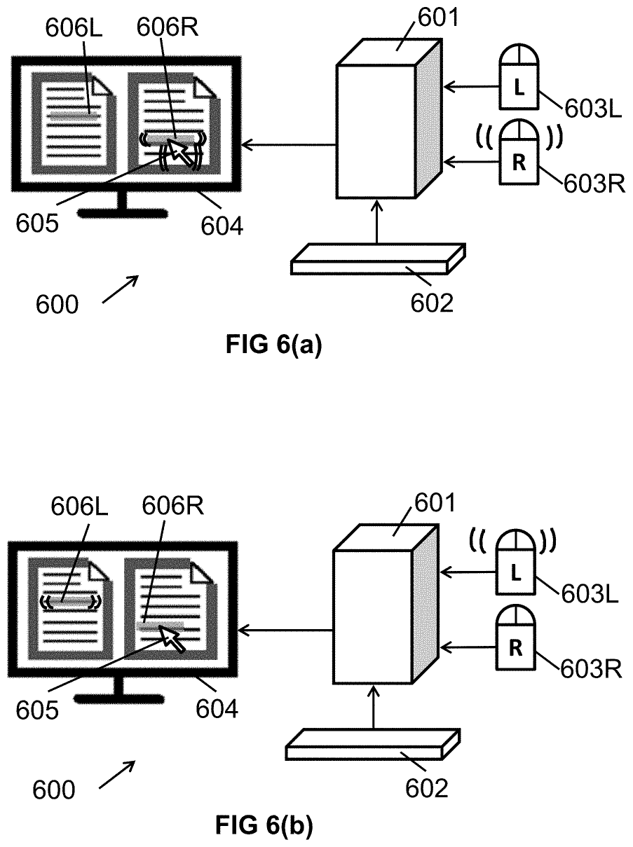

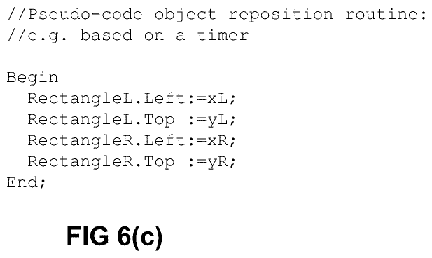

FIG. 6(a) to FIG. 6(c) shows a computer system 600 according to another embodiment of the present invention, which can be seen as a variant of the computer system 500 of FIG. 5, where a computer device 601 is connected to a first and second pointer device 603R, 603L, and is running an O/S and GUI (e.g. Windows 10) providing a native mouse pointer 605 (e.g. having the shape of a white arrow), and is running an overlay application according to an embodiment of the present invention. The overlay application maintains a first and a second position Pos1, Pos2 in accordance with movements of the first and second pointer device 603R, 603L respectively, and adapts, e.g. overrides the position of the native mouse pointer 605 in accordance with movements of the first pointer device 603R. The overlay application provides a second visible object 606L which moves in accordance with movements of the second pointer device 603L, and also provides a third visible object 606R which moves in accordance with movements of the first pointer device 603R. In the example of FIG. 6 the second and third object 606L and 606R are rectangles having the same size and color, but that is not absolutely required, and the two visible objects may have a different size and/or a different shape and/or a different color. Thus, the overlay application used in the computer system 600 of FIG. 6 enhances the O/S and GUI by providing two additional visible objects 606L, 606R which are movable by the two pointer devices 603L, 603R, and which can be used for example for underlining or highlighting text fragments of classical applications running on said computer, for example: a text editor, a web-browser, a slideshow, a PowerPoint presentation, a PDF document viewer, etc. The objects 606L, 606R may be opaque or semi-transparent or may contain a “perforated bitmap” as described in the co-pending “perforated bitmap application”.

FIG. 6(a) shows movements of the first visible object 605 (the native mouse cursor) and movements of the third visible object 606R in accordance with movements of the first pointer device 603R.

FIG. 6(b) shows movements of the second visible object 606L in accordance with movements of the second pointer device 603L.

FIG. 6(c) shows an exemplary object reposition routine which may be used in the overlay application to move the two visible objects 606L, 606R, in pseudo-code. Simply stated, the coordinates of the object 606L (referred to as rectangleL) are updated according to the second position Pos2 associated with the second mouse device 603L, and the coordinates of the object 606R (referred to as rectangleR) are updated according to the first position Pos1 associated with the first mouse device 603R. These steps are performed repeatedly, for example based on a timer.

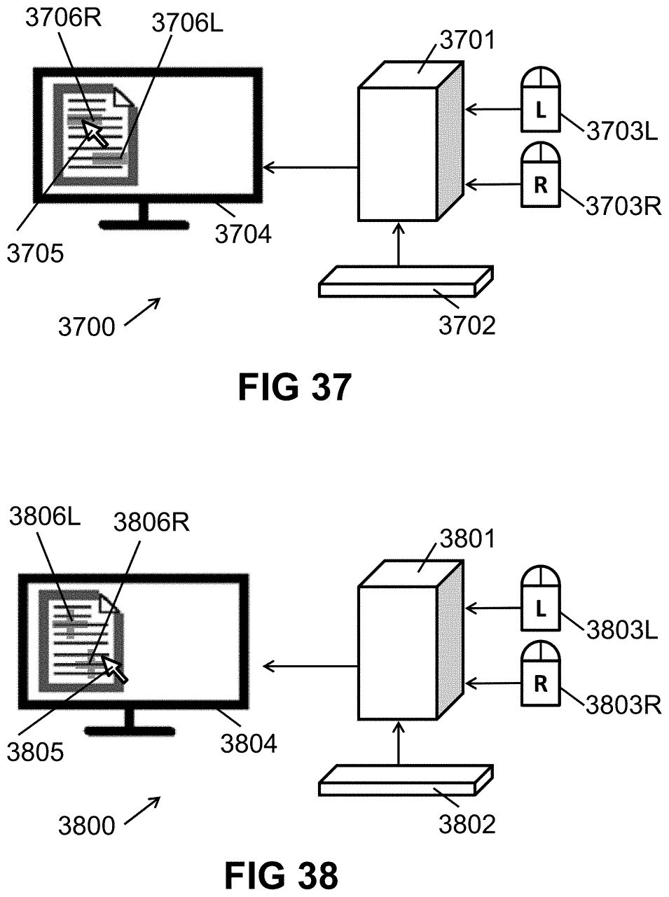

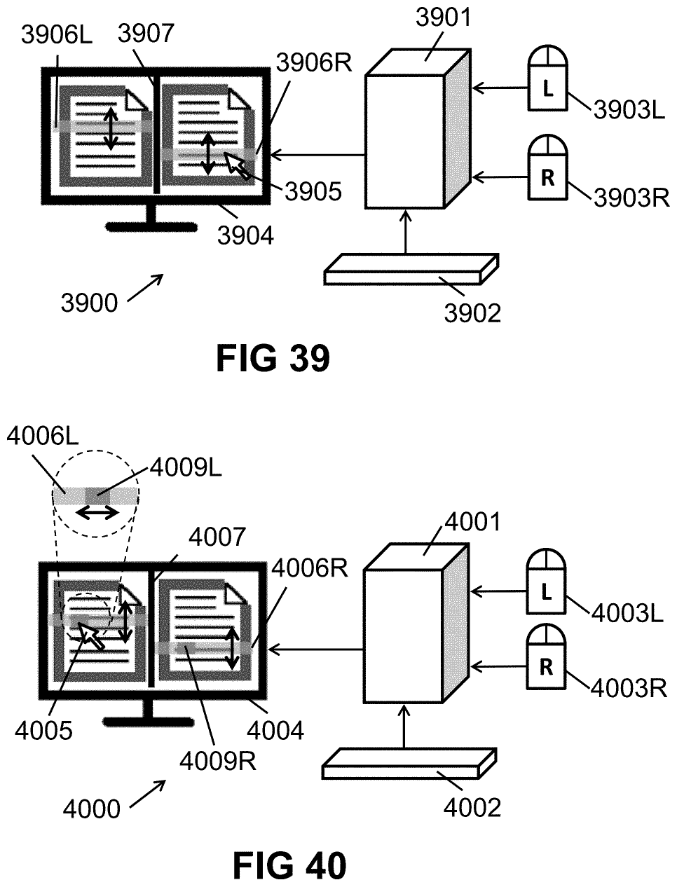

It is pointed out that, in FIG. 6(a) and FIG. 6(b), the first visible object 606R is shown on the right side of the screen 604, and the second visible object 606L is shown on the left side of the screen 604, but that is not absolutely required, and both objects can be moved anywhere on the screen, as shown for example in FIG. 37. In practice however, a user will typically find it more intuitive to position the object related to the left pointer device on the left side of the screen. In other embodiments, the movement of the second and optionally further objects 3906R, 3906L is restricted, as shown for example in FIG. 39, which will be discussed later, but even then the movement of the native mouse cursor 3905 is preferably not restricted.

The computer system 600 of FIG. 6 can be used for example by proofreaders for seemingly underlining text portions in two documents shown side by side on the screen 604 without actually modifying the content of the documents itself. It is a major advantage that text fragments can be seemingly underlined in two different documents simultaneously. This may drastically lower the cognitive burden of the user when switching focus back and forth between the two documents. It is a major advantage that the text fragments can be underlined independently (in contrast to for example text editors allowing only synchronous navigation through two text documents), not only because sentences in one language may be longer or shorter than sentences in another language, but also because the two documents may have a different formatting, e.g. a different layout and/or a different font and/or a different line spacing, etc. It is an advantage that the “second mouse and second object” can be used in combination with almost any underlying application, e.g. a text editor, a PDF document reader, a worksheet, a web-browser, a PowerPoint application, etc. without having to modify any of these applications. For example, the object 606L can be moved over a PDF document, and the object 606R can be moved over a text-document, and vice-versa. In the example of FIG. 6(a) and FIG. 6(b), the native mouse cursor 605 moves along with the object 606R.

The user can use the native mouse cursor 605 to click and/or drag and/or select menu options anywhere on the screen, for example in the text document to select text which can then be deleted or replaced by other text using the keyboard 602, or in the taskbar (not explicitly shown) to open new applications in the same way as can be done without the graphical overlay application.

In the exemplary user-interface of FIG. 28(a), the behaviour of FIG. 6(a) and FIG. 6(b) may correspond with mode 2860(h). (the word “may” is used, because several variations are possible, for example for the message handler, as will become clear further).

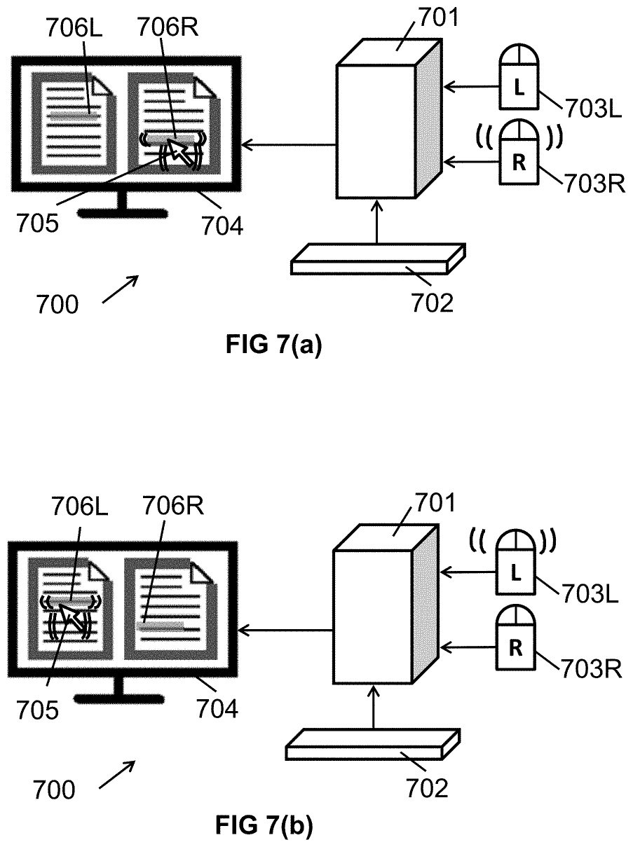

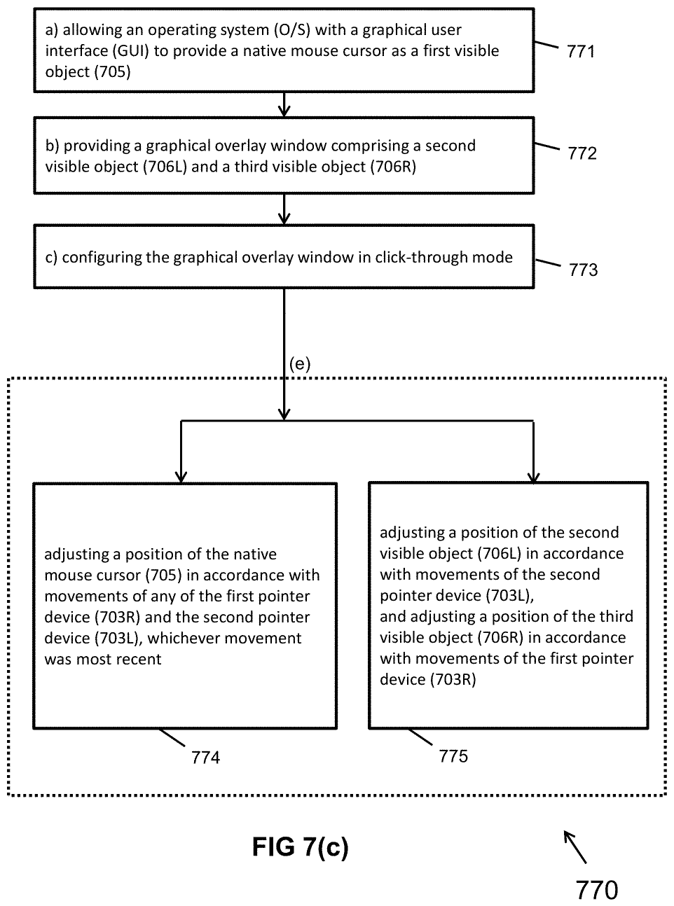

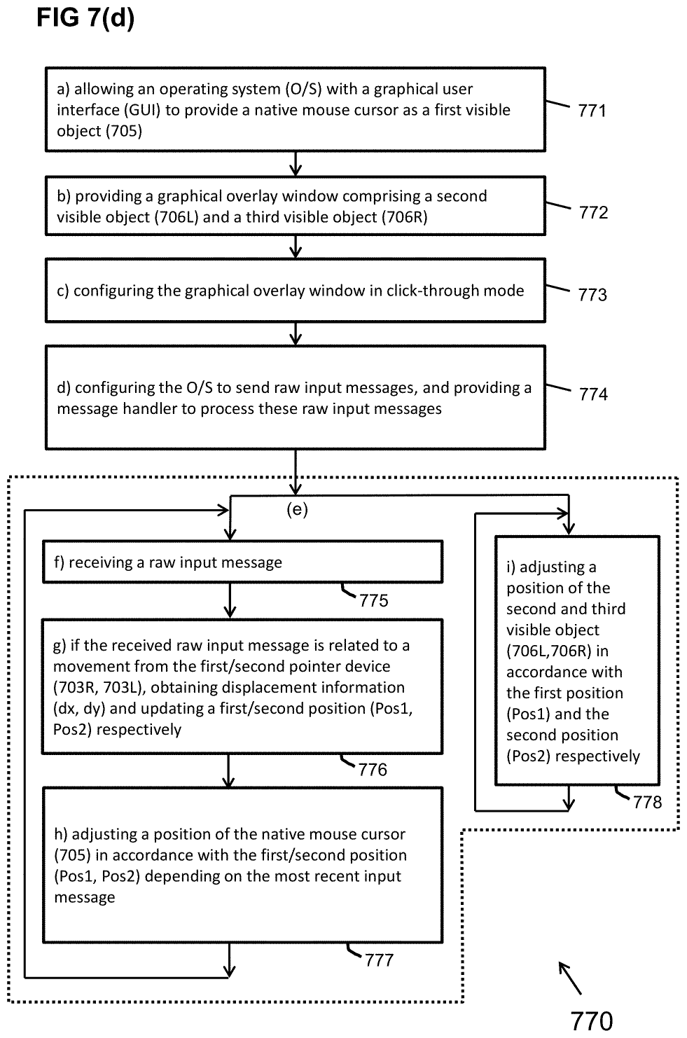

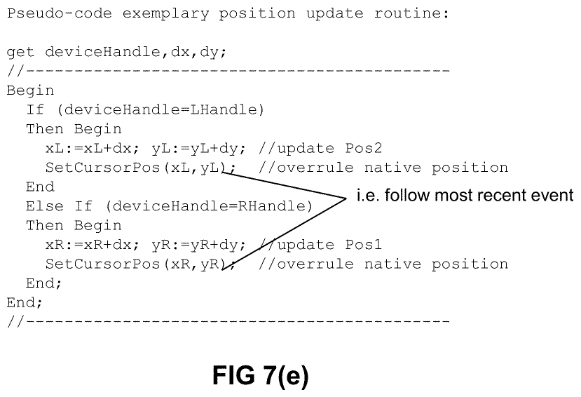

FIG. 7 shows a computer system 700 according to another embodiment of the present invention, which can be seen as a variant of the computer system 600 of FIG. 6, where a computer device 701 is connected to a first pointer device 703R and a second pointer device 703L, and is running an O/S and GUI providing a native mouse pointer or mouse cursor 705 (e.g. a white arrow), and is running an overlay application according to an embodiment of the present invention, which provides a second and a third visible object 706L, 706R.

The overlay application maintains a first and a second pointer position Pos1, Pos2 in accordance with movements of the first and second pointer device 703R, 703L respectively, and adapts, e.g. overrides the position of the native mouse pointer/cursor 705 in accordance with movements of the pointer device which is most recently moved. Thus, if the right pointer device 703R is being moved and the left pointer device 703L is stationary, as illustrated in FIG. 7(a), the native mouse cursor 705 follows movements of the right pointer device 703R, and the buttons and/or the scrollwheel of the right pointer device 703R can be used. If at another moment in time the left pointer device 703L is being moved and the right pointer device 703R is stationary, as illustrated in FIG. 7(b), the native mouse cursor 705 follows movements of the left pointer device 703L, and the buttons and/or the scrollwheel of the left pointer device 703L can be used. As can be understood from FIG. 7(a) and FIG. 7(b) the native mouse cursor follows movements of the pointer device which is moved, until the moment that the other pointer device is moved, which causes the native mouse pointer to jump to the other maintained position. In this way, the user can use the native mouse pointer at two different locations of the screen, albeit at different moments in time. Or stated in other words, in this embodiment, the native mouse cursor 705 provided by the O/S and GUI is temporarily associated with one of the pointer devices 703L, 703R at any moment in time, thus the native mouse pointer 705 is “shared in time” between the two pointer devices.

FIG. 7(c) is a high-level flowchart illustrating a computer implemented method according to an embodiment of the present invention, as can be used in the computer system of FIG. 7(a).

FIG. 7(c) shows a computer implemented method for providing a first visible object 705 and a second visible object 706L and a third visible object 706R. The third visible object 706R is movable by a first pointer device 703R. The second visible object 706L is separately movable by a second pointer device 703L.

The first visible object 705 is selectively movable by any of the first pointer device 703R and the second pointer device 703L whichever is most recently moved and/or asserted. In FIG. 7(a) the first pointer device 703R is being moved, and the native mouse cursor 705 and the third visible object 703R both move in accordance with movements of the right pointer device, or more particularly, in accordance with a first position Pos1. In FIG. 7(b) the second pointer device 703L is being moved, and the native mouse cursor 705 and the second visible object 706L both move in accordance with movements of the left pointer device 703L. It can be understood that the native mouse cursor 705 moves gradually as long a only one pointer device is being moved, but typically suddenly jumps from Pos1 to Pos2 or vice versa when the other pointer device is being moved.

FIG. 7(c) shows a flowchart illustrating a computer implemented method comprising the following steps:
a) configuring, e.g. allowing an operating system O/S with a graphical user interface GUI to provide a native mouse cursor 705 as a first visible object;
b) providing a graphical overlay window comprising a second visible object 706L and a third visible object 706R;
c) configuring the graphical overlay window in click-through mode;
d) adjusting 774 a position of the native mouse cursor 705 in accordance with movements of any of the first pointer device 703R and the second pointer device 703L, whichever movement was most recent, and
   adjusting 775 a position of the second visible object 706L in accordance with movements of the second pointer device 703L, and adjusting a position of the third visible object 706R in accordance with movements of the first pointer device 703R.

FIG. 7(d) is a more detailed flowchart illustrating a computer implemented method according to an embodiment of the present invention, as can be used in the computer system of FIG. 7(a). The method comprises the following steps:
a) configuring, e.g. allowing an operating system O/S with a graphical user interface GUI to provide a native mouse cursor 705 as a first visible object;
b) providing a graphical overlay window comprising a second visible object 706L and a third visible object 706R;
c) configuring the graphical overlay window in click-through mode;
d) configuring the O/S to send raw input messages, and providing a message handler to process these raw input messages;
e) repeatedly performing the following steps:
f) receiving a raw input message;
g) if the received raw input message is related to a movement from the first/second pointer device 703R, 703L, obtaining displacement information dx, dy and updating a first and second position Pos1, Pos2 respectively;
h) adjusting a position of the native mouse cursor 705 in accordance with the first or second position Pos1, Pos2 depending on the most recent input message;
   and repeatedly performing the following step:
i) adjusting a position of the second and third visible object 706L,706R in accordance with the first position Pos1 and the second position Pos2 respectively.

FIG. 7(e) shows an exemplary position-update routine, (as part of the message handler routine), in pseudo-code, which can be used to obtain this behaviour. As can be seen, the coordinates (xR,yR) and (xL,yL) of the first and second position Pos1, Pos2 are updated in accordance with movements of the first and second pointer device 703R, 703L respectively (albeit indirectly, by making use of a device handle which the O/S assigns to each pointer device), and the position of the native mouse cursor 705 is adjusted depending on the most recent movement message.

An advantage of this embodiment is that a user can use two mouse devices for simultaneously showing two visible objects, e.g. two lines or two rectangles for underlining or highlighting text fragments at two different locations of the screen, and in addition the user can also click or scroll the mouse device which is most recently moved. This can for example be used for scrolling the respective documents up/down when proofreading.

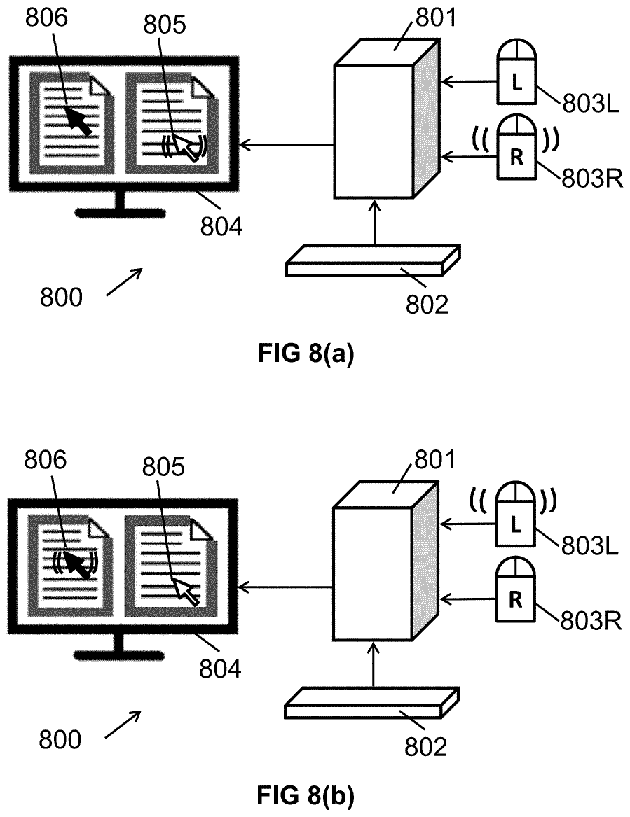

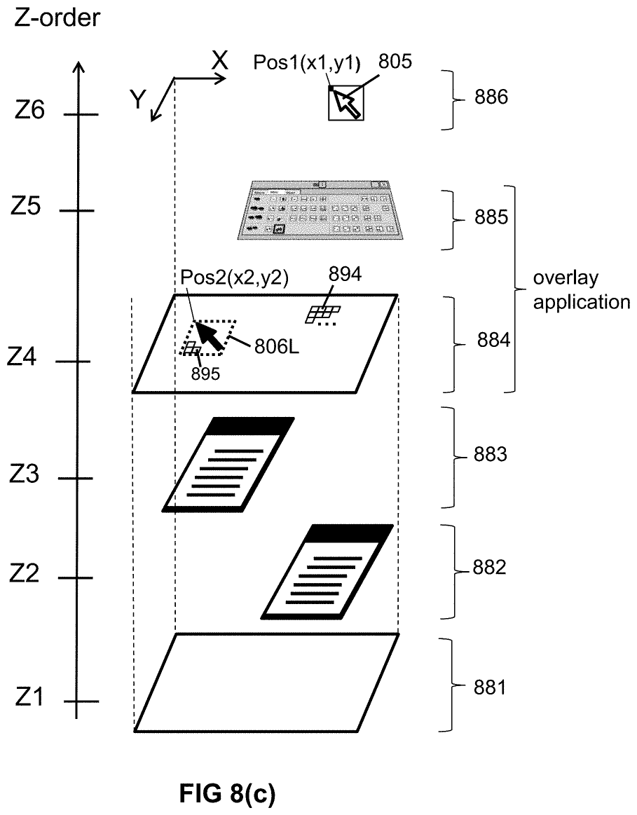

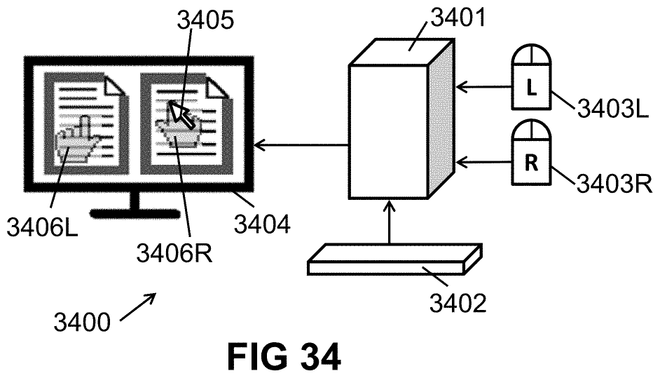

FIG. 8 shows another computer system 800 according to an embodiment of the present invention, which can be seen as a variant of the computer system 500 of FIG. 5, where the second visible object 806 has the shape of a black arrow, but of course the invention is not limited thereto, and an arrow of another color can also be used, but the drawing is not limited to an arrow, and also other shapes can be used, see for example FIG. 34 where two hands are used.

As illustrated in FIG. 8(c) the overlay application used in the computer system 800 of FIG. 8 comprises a click-through window 884 similar to the window 584 of FIG. 5(c), but where the rectangular object 506L is replaced by a visual object (e.g. an “image component”) containing a suitable bitmap. The image component 806L may contain a bitmap containing pixels representing a black arrow surrounded by fully transparent pixels 895 (only a few of which are shown), which is suitable in case the other pixels 894 of the window 884 are also fully transparent pixels. In case the window 884 is configured as a semi-transparent window and the pixels 894 have a certain color (e.g. lightgray), then the black arrow is preferably surrounded by semi-transparent pixels 895 having that same color (e.g. lightgray). In case the window 884 is configured as a semi-transparent perforated bitmap or a semi-transparent perforated texture bitmap as described in more detail in the co-pending “perforated bitmap application”, the black arrow is preferably also surrounded by the same or similar perforated bitmap. In the latter case the object reposition routine should preferably locate the movable object 806L such that the perforated background of the movable image is aligned with the perforated bitmap of the window 884, which in case of a 2×2 checkerboard patterned bitmap may be implemented by positioning the movable object 806L, for example only at locations with even X and even Y coordinates, or only at locations with odd X and odd Y coordinates, depending on where or how the pattern of the pixels 894 is located.

FIG. 8(a) shows movements of the first visible object 805 in accordance with movements of the first pointer device 803R.

FIG. 8(b) shows movements of the second visible object 806 in accordance with movements of the second pointer device 803L. For reasons which will become clear further, the left mouse device 803L should only be moved, but not clicked or scrolled in the system 800. For that reason, the representation of the second visible object 806 in the form of an arrow may be confusing to a user, and a line or a rectangle or a square may be preferred as a visual indication of the second position, because it is intuitively clear that a line or square should not be clicked. In the system 800 the native mouse cursor 805 follows movements of the right mouse device 803R, and is therefore probably better suited for right handed people.

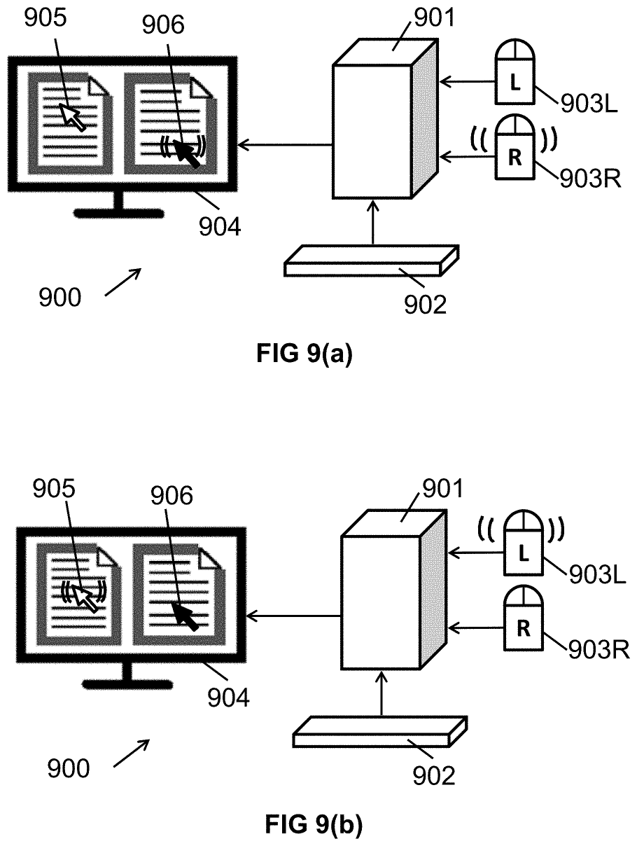

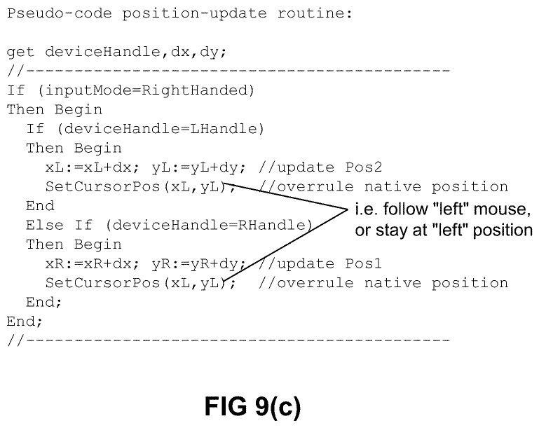

FIG. 9 shows a computer system 900 according to an embodiment of the present invention which can be seen as a variant of the computer system 800 shown in FIG. 8, where the native mouse cursor 905 follows movements of the left mouse device 903L. The embodiment of FIG. 9 is therefore probably better suited for left-handed people. In this embodiment the black arrow 906 can be moved by the right pointer device 903R, but this pointer device 903R should not be clicked or scrolled.

FIG. 9(a) shows that the position of the black arrow 906 is adjusted in accordance with movements of the right pointer device 903R.

FIG. 9(b) shows that the position of the native mouse cursor 905 is adjusted in accordance with movements of the left pointer device 903L. Both arrows are visible on the screen at all times.

FIG. 9(c) shows an exemplary position update routine as part of a message handler routine, in pseudo-code, which can be used to obtain this behaviour. As can be seen, the first and second position Pos1, Pos2 are updated in accordance with movements of the first and second pointer device 903R, 903L respectively. In case the left pointer device 903L was moved, the position of the native mouse cursor 905 is adjusted accordingly. In case the right pointer device 903R was moved, the position of the native mouse cursor 905 is forced back to the second position Pos2 maintained by the overlay application. Thus, the two arrows 905, 906 are individually movable by the two pointer devices.

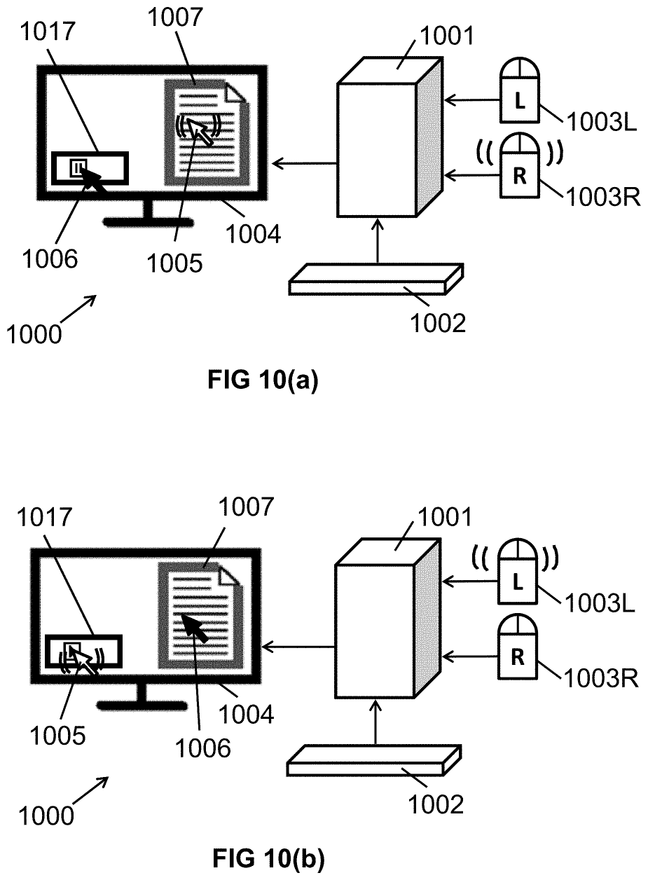

FIG. 10 shows a computer system 1000 according to another embodiment of the present invention, which can be seen as a variant of the computer system 700 of FIG. 7 for aspects related to the positioning of the native mouse cursor 1005, and can be seen as a variant of the computer system 800 of FIG. 8 and 900 of FIG. 9 for aspects related to the shape of the second visible object 1006.

The computer system 1000 comprises a computer device 1001 connected to a first pointer device 1003R and to a second pointer device 1003L and connected to a display 1004. The computer device 1001 has at least one processor running an O/S and GUI providing a native mouse pointer/cursor 1005 (e.g. a white arrow), and running an overlay application according to an embodiment of the present invention. The overlay application maintains a first and a second pointer position Post, Pos2 in accordance with movements of the first and second pointer device 1003R, 1003L respectively, and adapts, e.g. overrides the position of the native mouse pointer/cursor 1005 in accordance with movements of the pointer device which is most recently moved.

FIG. 10(a) shows movements of the first visible object, being the native mouse pointer 1005, in accordance with movements of the first pointer device 1003R because this is the pointer device being moved, while the second visible object 1006 (e.g. a black arrow) assumes the other maintained position Pos2. In this situation, the user can press/release/click the buttons and/or move the scrollwheel of the first mouse pointer 1003R, for example to activate the text editor application, select text, add a comment, etc.

FIG. 10(b) shows movements of the first visible object 1005 in accordance with movements of the second pointer device 1003L, which is the pointer device being moved, while the second visible object 1006 (e.g. a black arrow) assumes the other maintained position Post. In this situation, the user can press/release/click the buttons and/or move the scrollwheel of the second mouse pointer 1003L, for example to activate the audio player application 1017, to click on the play or pause button, etc.

As can be appreciated from FIG. 10(a) and FIG. 10(b) the user can see both locations on the screen 1004, and work at two different locations on the screen, albeit not simultaneously, by merely moving the respective pointer device. The user can click on either mouse device after making sure that the native mouse cursor 1005 is at the desired maintained location Pos1 or Pos2, as visually indicated by the white arrow.

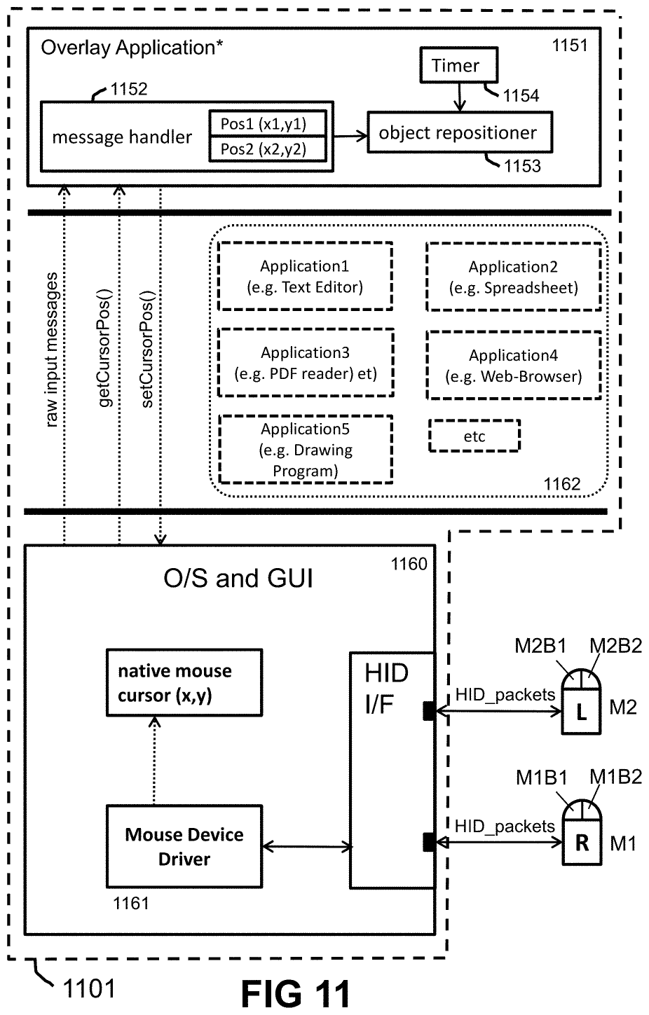

FIG. 11 shows a specific example of the simplified high-level block diagram of hardware and software components shown in FIG. 5(f) in case the pointer devices M1, M2 are HID compatible devices (abbreviation for “Human Interface Device”), and in case the computer device comprises a HID interface with at least two ports, as is typically the case inter alia for computer devices containing USB-interfaces. As is known in the art, such mouse devices send signals or messages to the computer device, e.g. in the form of HID packets, containing movement or displacement information dx, dy and/or information about a button being pressed or released, and/or information about a scrollwheel being rotated. In fact, the communication between the computer device and the mouse devices is bidirectional, but the overlay application does not have to deal with that part of the communication, which is therefore not discussed further.

As schematically indicated by the asterisk *, only the overlay application 1151 is new in FIG. 11, all other components (without asterisk) can be classical components, notably the pointer devices M1, M2, the operating system O/S and GUI 1160, the mouse device drivers 1161, and the other applications 1162. This again illustrates that the overlay application can be used to extend or enhance the functionality of an existing O/S and GUI which originally only provide a single native mouse cursor.

The mouse devices M1 and M2 can be wired mouse devices, or wireless mouse devices, or a combination of both.

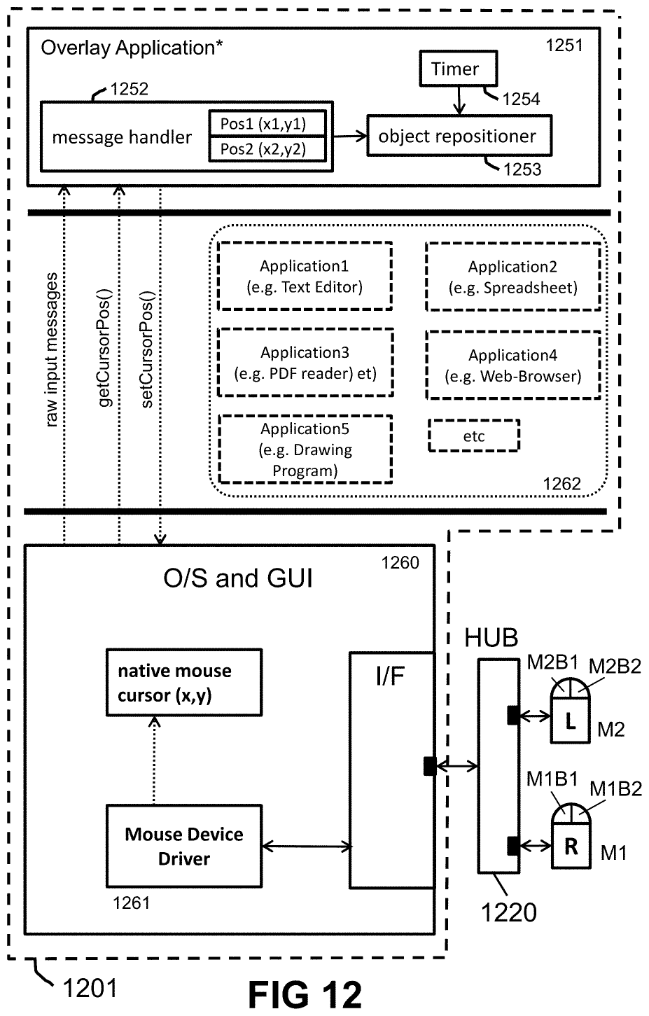

FIG. 12 shows a variant of the high-level block diagram of FIG. 11, where two classical pointer devices M1, M2 are connected to the computer device via a classical hub or adaptor or dongle 1220 instead of being connected directly to the computer device. The hub 1220 can be a wired hub, or a wireless hub. The interface may be a HID compatible interface, and the pointer devices may be HID compatible devices, but that is not absolutely required for the present invention to work.

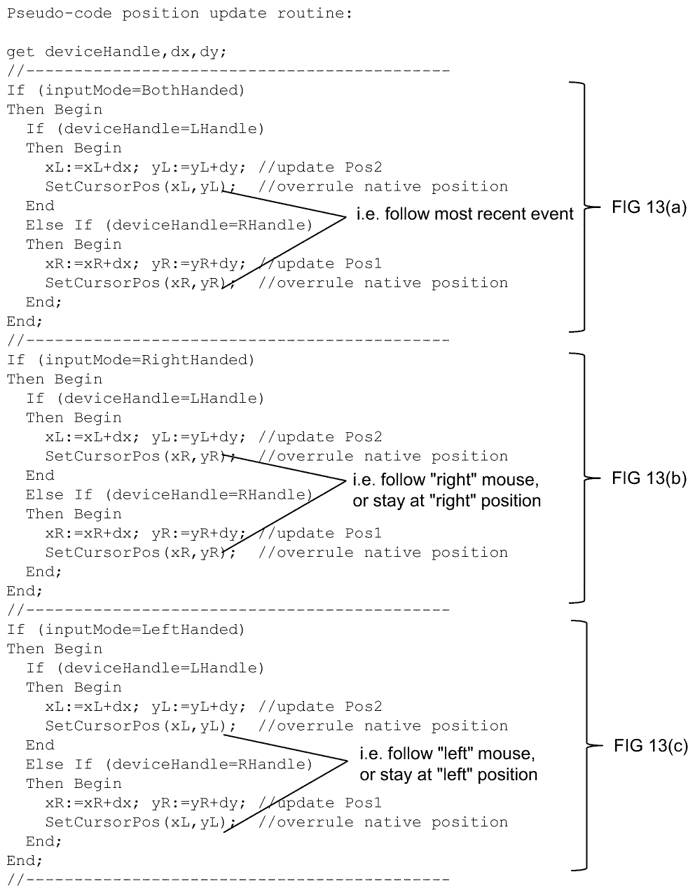

FIG. 13 shows a few lines of pseudo-code illustrating a portion of a message handler capable of operating in one of three input modes, referred to herein as:
“BothHanded” (FIG. 13(a)) as explained in FIG. 7(c) where the native mouse cursor follows movements of the pointer device which is most recently moved, or
“RightHanded” (FIG. 13(b)) as explained in FIG. 5(g) where the native mouse cursor follows movements of the right pointer device, and
“LeftHanded” (FIG. 13(c)) as explained in FIG. 9(c) where the native mouse cursor follows movements of the left pointer device.

Some embodiments of an overlay application according to the present invention may implement (e.g. hardcode) only one of these input modes.

Other embodiments of an overlay application according to the present invention may implement two of these input modes, or all three of these input modes, and allow the user to select which input mode to use, for example explicitly, as shown in FIG. 31(a), by allowing a user to select a “Dominant mouse” in which case for example the display modes of group 2850 and 2870 (see e.g. FIG. 28) can be hidden, or implicitly by allowing the user to select any display mode of any group 2850 to 2870, in which case the application can change the corresponding input mode itself, if needed.

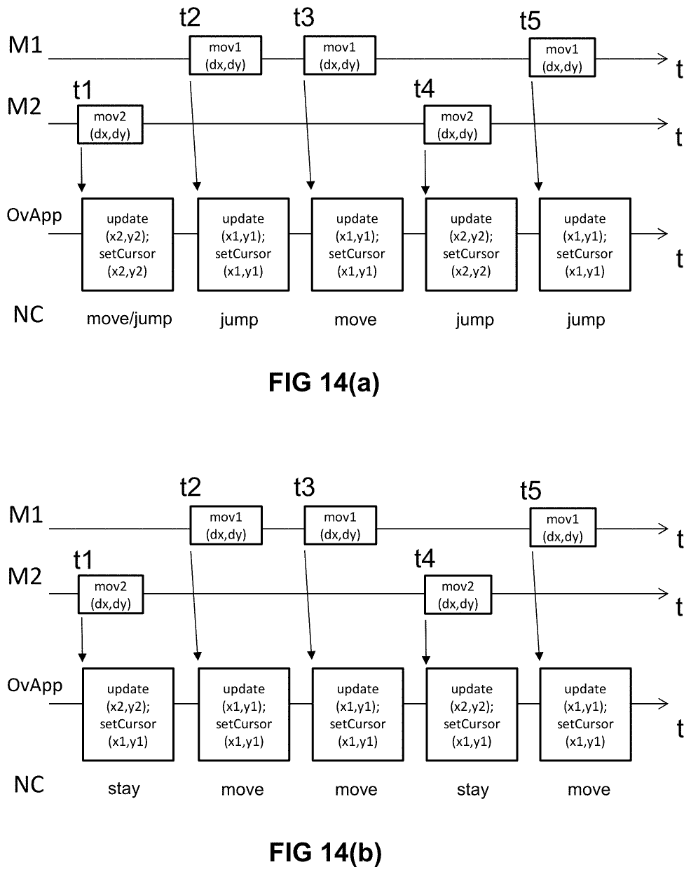

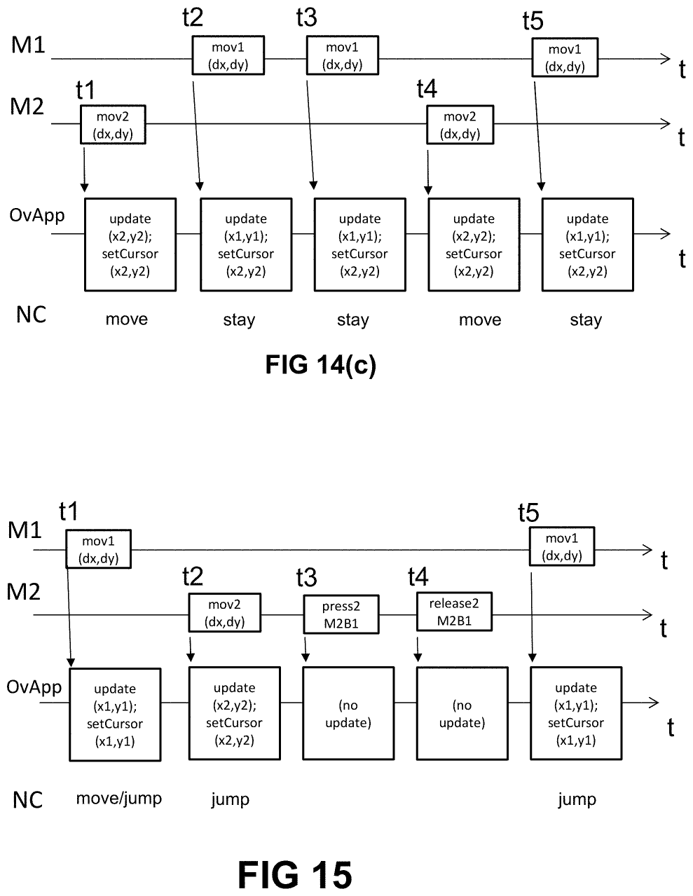

FIG. 14(a) is a schematic representation of an exemplary sequence of signals or messages coming from two classical mouse devices M1, M2, and shows how these signals are correctly handled by the message handler process illustrated in FIG. 13, assumed to be configured in the “BothHanded” input mode. In reality there may be many more signals or messages exchanged between the computer device and the mouse devices, but these are not shown in order not to overload the drawings. Also, FIG. 14 only shows how the position NC of the Native mouse Cursor is updated, and does not explicitly mention how the position of the second and/or further visible object is updated, again, not to overload the drawings.

At time t1 mouse device M2 is moved and sends a movement message mov2 to the computer device, and in response the overlay application updates Pos2 and sets the position of the native mouse cursor NC to Pos2. Depending on where the native mouse cursor was located before t1, this may appear to the user as a small move or as a jump.

At time t2 mouse device M1 is moved and sends a movement message mov1 to the computer device, and in response the overlay application updates Pos1 and sets the position of the native mouse cursor NC to Post, which will typically appear to the user as a “jump” from Pos2 to Post.

At time t3 mouse device M1 is moved again and sends a movement message mov1 to the computer device, and in response the overlay application updates Pos1 and sets the position of the native mouse cursor NC to Pos1, which will typically appear to the user as a small move.

At time t4 mouse device M2 is moved and sends a movement message mov2 to the computer device, and in response the overlay application updates Pos2 and sets the position of the native mouse cursor NC to Pos2, which will typically appear to the user as a “jump” from Pos1 to Pos2.

At time t5 mouse device M1 is moved and sends a movement message mov1 to the computer device, and in response the overlay application updates Pos1 and sets the position of the native mouse cursor NC to Post, which will typically appear to the user as a “jump” from Pos2 to Post.

FIG. 14(b) shows the same sequence of signals or messages as that of FIG. 14(a), and shows how an overlay application having the message handler of FIG. 13, when configured in the “RightHanded” input mode, would update the position NC of the native mouse cursor. As can be seen, when the right pointer device M1 is moved the first position Pos1 is updated, and when the second pointer device M2 is moved the second position Pos2 is updated, but in all of these cases the position of the native mouse cursor NC is set to the first position Pos1, associated with movements of the right pointer device M1.

FIG. 14(c) shows the same sequence of signals or messages as that of FIG. 14(a), and shows how an overlay application having the message handler of FIG. 13, when configured in the “LeftHanded” input mode, would update the position NC of the native mouse cursor. As can be seen, when the right pointer device M1 is moved the first position Pos1 is updated, and when the second pointer device M2 is moved the second position Pos2 is updated, but in all of these cases the position of the native mouse cursor NC is set to the second position Pos2, associated with movements of the left pointer device M2.

As can be appreciated from FIG. 14(a) to FIG. 14(c), movements of both mouse devices M1, M2 are handled correctly, even simultaneous movements of the two mouse devices M1, M2.

FIG. 15 is a schematic representation of another exemplary sequence of signals or messages coming from two classical mouse devices M1, M2, and shows how these signals are correctly handled by the message handler process illustrated in FIG. 13, assumed to be configured in the “BothHanded” input mode.

At time t1 mouse device M1 is moved and sends a movement message mov1 to the computer device, and in response the overlay application updates Pos1 and sets the position of the native mouse cursor NC to Pos1. Depending on where the native mouse cursor NC was located before t1, this may appear to the user as a small move or as a jump.

At time t2 mouse device M2 is moved and sends a movement message mov2 to the computer device, and in response the overlay application updates Pos2 and sets the position of the native mouse cursor NC to Pos2, which will typically appear to the user as a jump from Pos1 to Pos2.

At time t3 a button (e.g. a left button M2B1) of the second mouse device M2 is pressed and the mouse device M2 sends a button-press message press2 to the computer device. The message handler of the overlay application receives the message, but since it is not a movement message, step h) of FIG. 5(e) is skipped, and the overlay application does not update Pos1 or Pos2, but lets the O/S and GUI handle the button M2B1 being pressed.

At time t4 the button M2B1 of the second mouse device M2 is released and the second mouse device M2 sends a button-release message release2 to the computer device, and again the overlay application does not change any position, but lets the O/S and GUI handle the button being released. As is known in the art, under some conditions the O/S will consider the button press and button release as a so called “mouse click”.

At time t5 mouse device M1 is moved and sends a movement message mov1 to the computer device, and in response the overlay application updates Pos1 and sets the position of the native mouse cursor NC to Pos1, which will typically appear to the user as a jump from Pos2 to Pos1.

As can be appreciated from FIG. 15, the “click” on a button M2B1 of the second mouse M2, is handled correctly by the message handler of FIG. 13 configured in the BothHanded input mode, despite movements of the first mouse M1 before and after the click.

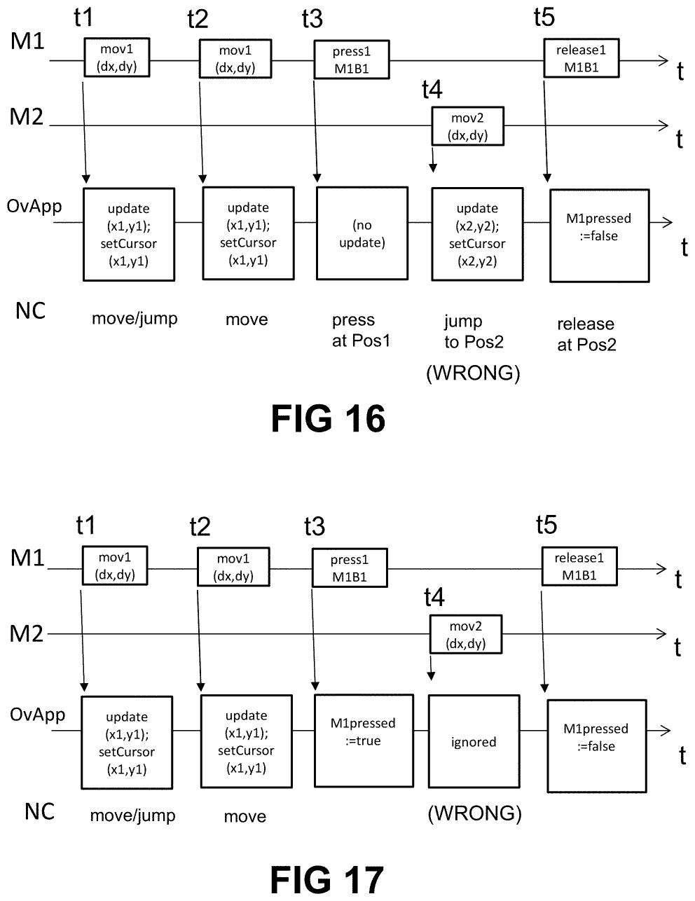

Tests with further sequences have shown however that the message handler of FIG. 13 does not always provide the expected behaviour. Closer investigation revealed that the exemplary sequence of signals or messages shown in FIG. 16 is unsatisfactorily handled.

At time t1 mouse M1 is moved and sends a movement message mov1 to the computer device, and in response the message handler updates the first position Post and positions the native mouse cursor accordingly. Likewise at time t2.

At time t3 a button (e.g. a left button M1B1) of the first mouse device M1 is pressed and the mouse sends a button-press message press1 to the computer device, for which the message handler of FIG. 13 takes no action.

At time t4 the second mouse device M2 is moved and sends a movement message mov2 to the computer device, and in response the message handler of FIG. 13 repositions the native mouse cursor NC to the second maintained position Pos2.

At time t5 the button M1B1 of the first mouse device M1 is released and the mouse device M1 sends a button-release message release1 to the computer device, but the O/S considers this release to take place at Pos2 which is usually different from Pos1, not resulting in the expected “click” behaviour of the first mouse M1, but in a “dragging”-behaviour. This is not the intended behaviour.

In a first attempt to solve this problem, the message handler of FIG. 13 was modified by adding and maintaining two variables, a boolean variable M1pressed indicative of a button of the first mouse device M1 being pressed or released, and a variable M2pressed indicative of a button of the second mouse device M2 being pressed or released, and by not reacting on the movement signal mov2 sent by the second mouse M2 at t4 during the time a button of the first mouse M1 was pressed, as shown in FIG. 17, but for some reason this modified message handler did not provide the correct result either.

In a second attempt to solve this problem, the message handler of FIG. 13 was modified further, but Instead of ignoring the “mov2” signal (as in FIG. 17), the message handler was changed to actively reposition the native mouse cursor NC to the same position Pos1 where the native mouse cursor was located at time t3 when the button was being pressed. Tests have shown that such message handler works for a “click” on a button of the first mouse M1, but does not work when the first mouse M1 is being “dragged”. Rather than (at t4) freezing the position Pos1 to the same position as where the native mouse cursor NC was located when the button was pressed (at t3), the position of the native mouse cursor NC was allowed to move along with movements of the first mouse M1, even when a button of the same device M1 was being pressed.

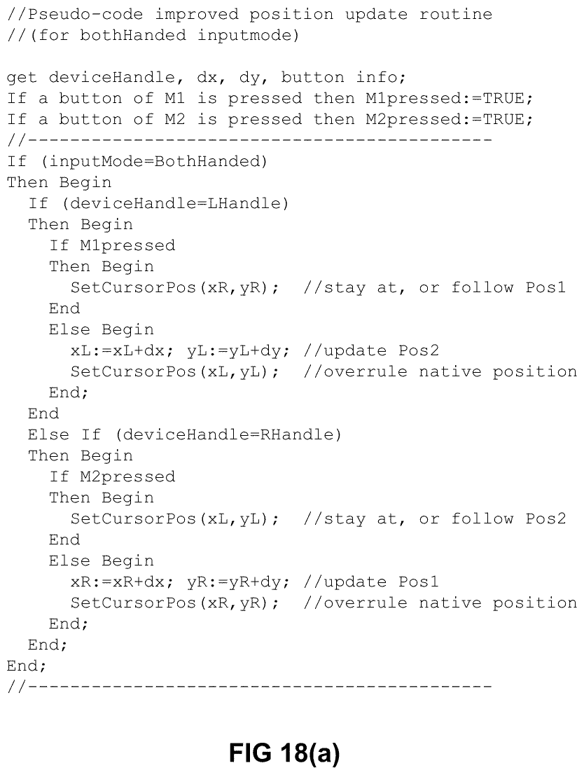

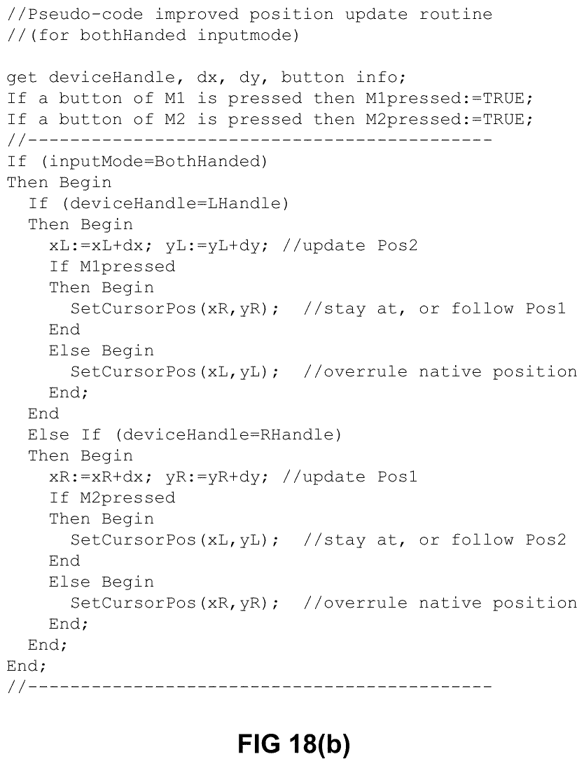

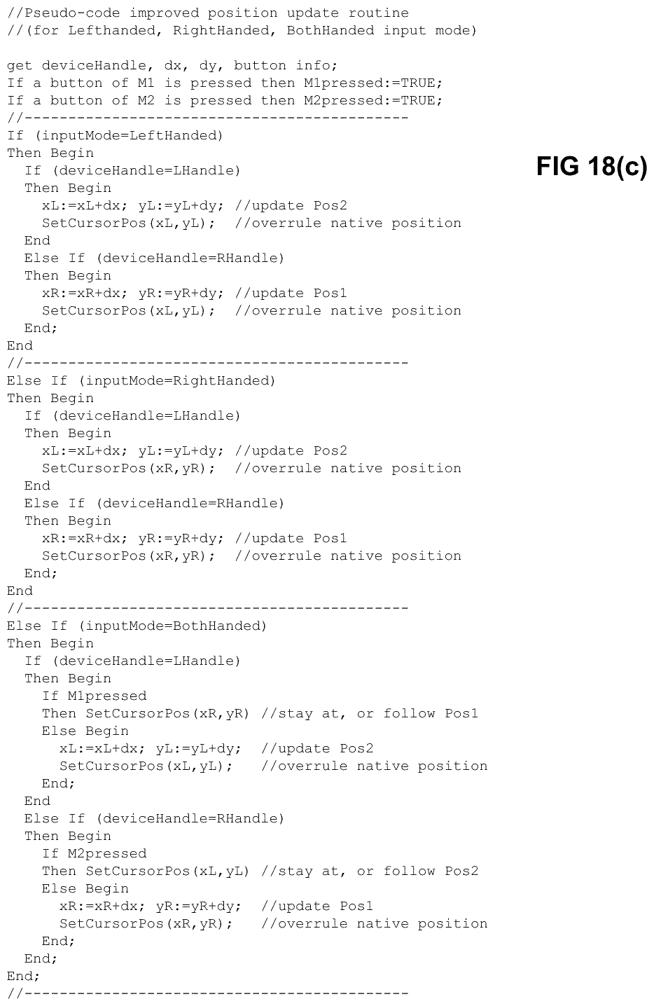

FIG. 18(a) shows a few lines of pseudo-code, illustrating a portion of an improved message handler routine to implement this behaviour. (only a portion of the BothHanded input mode is shown).

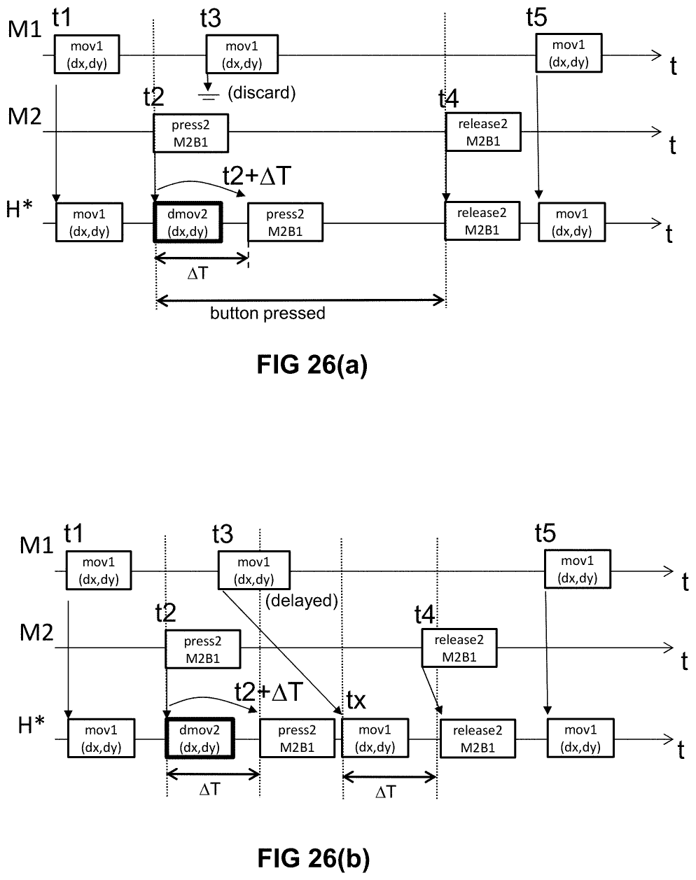

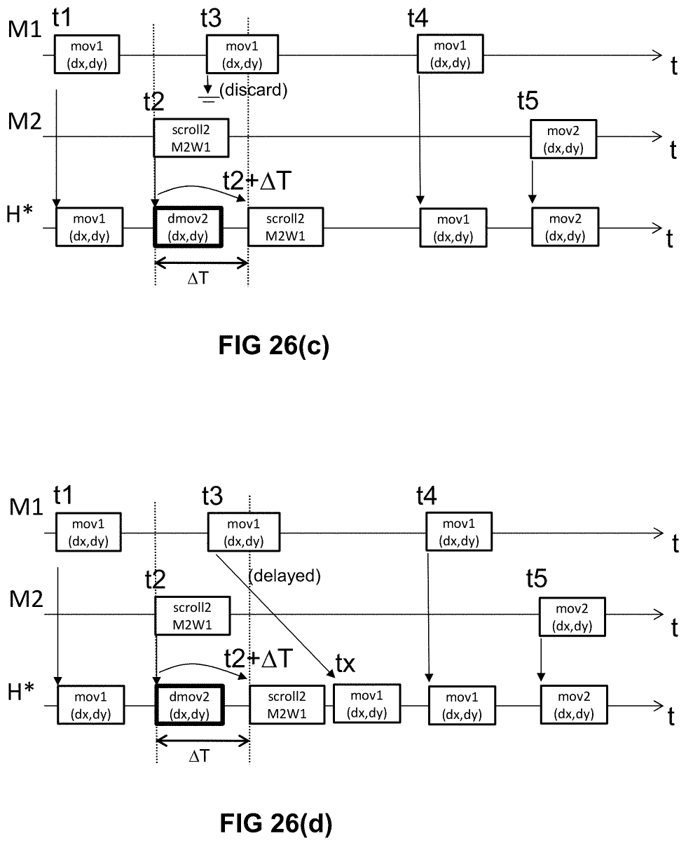

FIG. 18(b) shows a variant of the routine of FIG. 18(a), as can be used in overlay applications according embodiments of the present invention. (again, only a portion of the BothHanded input mode is shown). The main differences with the routine of FIG. 18(a) is that the second position Pos2 is updated even if a button of the first pointer device is pressed, and vice versa, that the first position Pos1 is updated even if a button of the second pointer device is pressed. This routine will be discussed further when discussing FIG. 26(a) and FIG. 26(b).

FIG. 18(c) shows a more complete version of a position-update routine, as can be used in overlay applications according embodiments of the present invention. It can be seen as a combination of the code portions shown in FIG. 5(g) and in FIG. 9(c) and in FIG. 18(a).

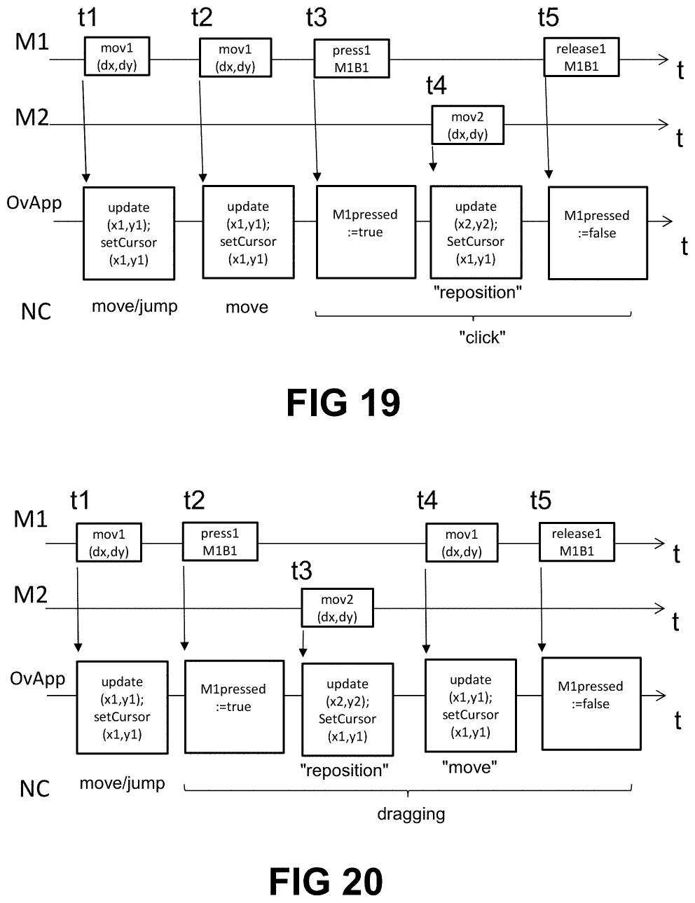

FIG. 19 shows the same exemplary sequence of signals or messages of FIG. 16, but processed by the message handler of FIG. 18(a). As can be seen, in response to the movement signal mov2 of the second mouse M2 at time t4, the improved message handler of FIG. 18(a) does update the second position Pos2 in accordance with the movement signal mov2, but actively repositions the native mouse cursor to Pos1, so that at time t5, the button M1B1 of the first mouse device M1 is considered to be released at the same position Pos1 as where it was pressed. The O/S interprets this as a “click” of the button M1B1 of the mouse device M1, which is satisfactorily handled, despite the movement signal “mov2” of the second mouse M2 at time t4.

It is noted that the update of Pos2 at t4 is not required for the correct interpretation of the click-command sent by the first pointer device M1, and may be omitted. But if omitted, the visible object(s) associated with the second position Pos2 will not move as long as a button of the first pointer device M1 is being pressed, even if the second pointer device is being moved. To allow such movements, the position Pos2 is preferably updated even if a button of the first pointer device is being pressed.

FIG. 20 shows a variant of the sequence of signals or messages of FIG. 19, showing that dragging of one mouse M1 works correctly even when the second mouse M2 is moved.

At time t1 the first mouse M1 is moved, the first mouse M1 sends a first movement message mov1 to the computer device, and in response the overlay application updates Pos1 and positions the native mouse cursor NC at Pos1.

At time t2 a button (e.g. a left button M1B1) of the first mouse M1 is pressed, the first mouse M1 sends a button-press message press1 to the computer device, and in response the message handler sets an internal variable M1pressed to TRUE.

At time t3 the second mouse M2 is moved, the second mouse M2 sends a second movement message mov2 to the computer device, and in response the message handler updates Pos2 and positions the native mouse cursor NC at Pos1.

At time t4 the first mouse M1 is moved, the first mouse M1 sends a first movement message mov1 to the computer device, and in response the overlay application updates Pos1 and positions the native mouse cursor NC at Pos1.

At time t5 the button M1B1 of the first mouse device M1 is released, causing the O/S and GUI to perform a “dragging operating”, and in response the message handler sets the variable M1pressed to FALSE.

As can be appreciated from FIG. 20, dragging the first mouse M1 is satisfactorily handled by the message handler illustrated in FIG. 18(a) configured in the BothHanded input mode, even in combination with movements of the second mouse M2.

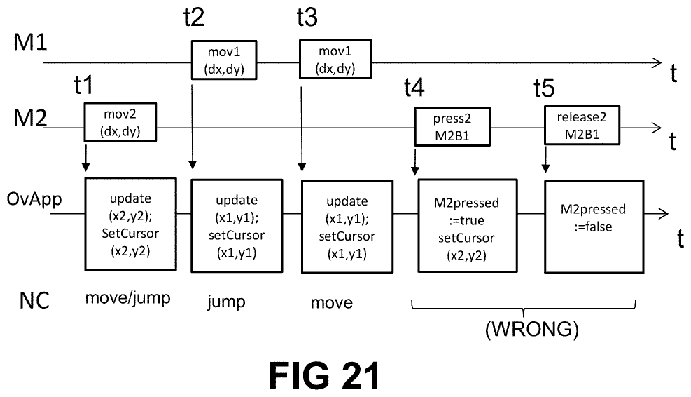

Referring to FIG. 21, further tests were performed using the message handler of FIG. 18(a) in the BothHanded input mode, which revealed yet another fault-condition, illustrated by the exemplary sequence of signals or messages shown in FIG. 21, where:

At time t1 the second mouse M2 is moved, a movement-message mov2 is sent, the second position Pos2 is updated taking into account the displacement values dx, dy, and the native mouse cursor is set to Pos2.

At time t2 the first mouse M1 is moved, a movement-message mov1 is sent, the first position Pos1 is updated taking into account the displacement values dx, dy, and the native mouse cursor is set to Pos1.

At time t3 the first mouse M1 is moved again, another movement-message mov1 is sent, the first position Pos1 is updated, and the native mouse cursor NC is set to the updated position Pos1.

At time t4 a button (e.g. a left button M2B1) of the second mouse device M2 is pressed, a button-press message press2 is sent, and in response the message handler of FIG. 18(a) sets the value M2pressed to TRUE, and changes the position of the native mouse cursor NC to Pos2.

At time t5 the button M2B1 of the second mouse device M2 is released, a release-message release2 is sent to the computer device, and in response the message handler sets the variable M2pressed to FALSE.

Despite the fact that a button of the second mouse device M2 was pressed and released at the same physically location, the press and release messages of FIG. 21 are not interpreted as a click. While the inventors do not wish to be bound by any theory, analysis seems to indicate that this sequence goes wrong, because at the moment t4 at which the button M2B1 of the second mouse M2 is pressed, the native mouse position NC was still at the first position Pos1(x1,y1), and therefore the O/S and GUI will assume the “button-press” to take place at the location Pos1(x1,y1) instead of Pos2, and only some time later (than t4) the overlay application will reposition the native mouse cursor NC to the second position Pos2(x2,y2), but that is “too late”. This problem is not known in the art, because there is only one cursor position.

No technical solution for this problem seems possible, because it is impossible for the overlay application to predict when a button of the mouse M2 will be pressed, and because the O/S and GUI will always be faster than the overlay application. Desiring to leave the mouse driver layer 561, 1161, 1261 of the O/S and GUI intact, the inventors surprisingly came up with another solution to address this problem.

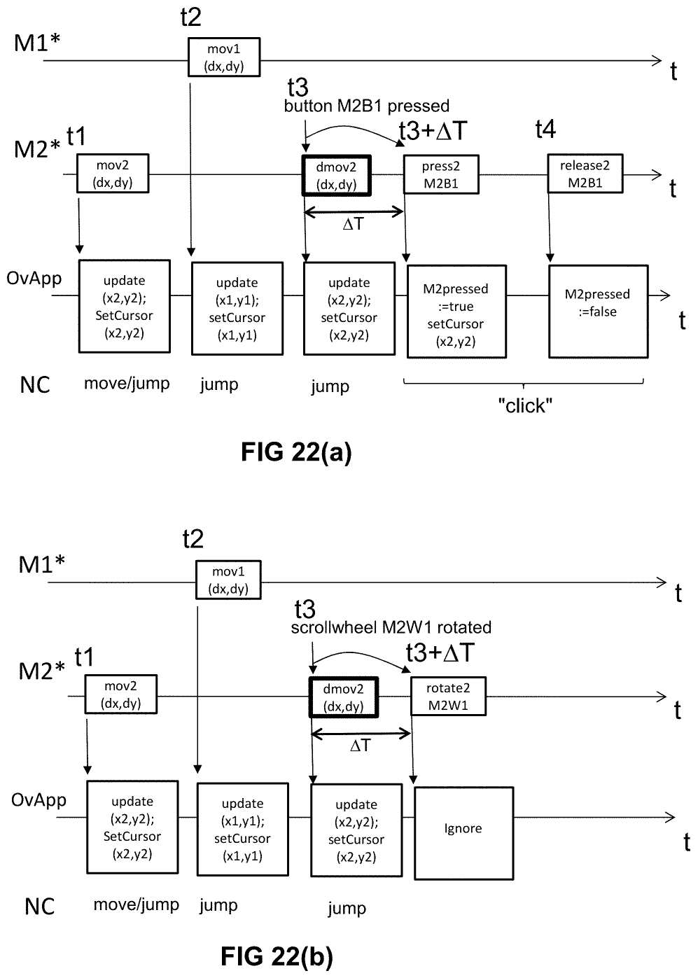

Referring to FIG. 22(a), the inventors decided to provide a special mouse device M2* which, upon a button thereof being pressed, sends a “dummy move” signal some time ΔT before sending an actual “button-press” signal. This effectively circumvents the problem of FIG. 21, because, as can be understood from FIG. 22(a):

At time t1 the second mouse M2* is moved, a (real) movement message mov2 is sent to the computer device, in response the overlay application updates the second position Pos2 and sets the native mouse cursor NC at position Pos2.

At time t2 the first mouse M1* is moved, a (real) movement message mov1 is sent to the computer device, in response the overlay application updates the first position Pos1 and sets the native mouse cursor NC at position Pos1.

At time t3 a button (e.g. a left button M2B1) of the special second mouse device M2* is pressed, causing the mouse device M2* to first send a dummy-movement message “dmov2” (preferably with small displacement values dx,dy), and to send some time ΔT later a button-press message press2. As shown, in response to the dummy-movement signal dmov2, the overlay application will set the native mouse cursor NC at the second position Pos2, well before the button-press message press2 is sent by the mouse device M2* at time t3+ΔT, such that the O/S and GUI will assume the “button press” takes place at position Pos2 (or more precise: very close to the original position Pos2, if dx and dy are small, but not exactly zero).

At time t4 the button M2B1 is released, and in response the message handler of the overlay application sets a variable M2pressed to FALSE.

It is noted that a dummy-movement message is not required when the button is released, only when a button is pressed.

FIG. 22(b) shows a variant of the sequence of FIG. 22(a) where a scrollwheel of the second pointer device M2* is rotated instead of a button being pressed and released. In a similar manner as described in FIG. 22(a), the special pointer device M2* does not merely send a scrollwheel-rotation message, but first sends a dummy movement message dmov2, and only some time ΔT later the pointer device M2* sends the actual scrollwheel rotation message rotate2, in order to allow the overlay application to reposition the native mouse cursor NC before the actual scrollwheel rotation message arrives at the computer device,

In FIG. 22(b) a scrollwheel of the pointer device M2* is physically being rotated at time t3, upon which the pointer device M2* sends a dummy movement message dmov2 to the computer device. In response the overlay application (configured in BothHanded input mode) will update the second position Pos2 and will set the native mouse cursor at Pos2.

At time t3+ΔT, the pointer device M2* sends a scrollwheel-rotation message rotate2, which the overlay application can simply ignore, because this message will be handled by the O/S and GUI.

While the solution proposed in FIG. 22(a) and FIG. 22(b) requires a special mouse device, it is an advantage that this special mouse behaviour does not require a hardware modification, only a firmware modification of the mouse device.

It is also an advantage that the proposed solution is backwards compatible, in the sense that this “special mouse” with the “move-before-click” feature and/or with the “move-before-scroll” feature can also be used in classical computer systems, not having the special overlay application. The main difference with existing mouse devices is that the button-press signal and/or the scrollwheel-rotation-signal is slightly delayed, which is probably totally unacceptable in the gaming world, and already for that reason is not obvious, but this does not cause a significant problem for professional users such as translators, proofreaders, transcribers, technical writers, attorneys, etc. who are used to working with tools (e.g. CAT tools, local or on-line dictionaries, local or on-line databases, local or on-line Translation Memories, etc.) having relatively slow response times anyway (typically in the order of at least 500 ms).

There is some design freedom in the choice of the three parameters ΔT, dx, dy.

In an embodiment, the delay ΔT is a value in the range from 1 ms to 250 ms or from 2 ms to 100 ms, and dx is a value in the range from −5 to +5, and dy is a value in the range from −5 to +5.

In an embodiment, the delay ΔT is a value in the range from 1 ms to 250 ms or from 2 ms to 100 ms, and dx is a value in the range from −2 to +2, and dy is a value in the range from −2 to +2.

In an embodiment, the delay ΔT is a value in the range from 1 ms to 250 ms or from 2 ms to 100 ms, and dx is a value in the range from −1 to +1, and dy is a value in the range from −1 to +1.

In an embodiment, the delay ΔT is a value in the range from 1 to 250 ms or from 2 ms to 100 ms, and dx=−1 and dy=−1.

In an embodiment, the delay ΔT is a value in the range from 1 to 250 ms or from 2 ms to 100 ms, and dx=−1 and dy=0.

In an embodiment, the delay ΔT is a value in the range from 1 to 250 ms or from 2 ms to 100 ms, and dx=−1 and dy=+1.

In an embodiment, the delay ΔT is a value in the range from 1 to 250 ms or from 2 ms to 100 ms, and dx=0 and dy=−1.

In an embodiment, the delay ΔT is a value in the range from 1 to 250 ms or from 2 ms to 100 ms, and dx=0 and dy=0.

In an embodiment, the delay ΔT is a value in the range from 1 to 250 ms or from 2 ms to 100 ms, and dx=0 and dy=+1.

In an embodiment, the delay ΔT is a value in the range from 1 to 250 ms or from 2 ms to 100 ms, and dx=+1 and dy=−1.

In an embodiment, the delay ΔT is a value in the range from 1 to 250 ms or from 2 ms to 100 ms, and dx=+1 and dy=0.

In an embodiment, the delay ΔT is a value in the range from 1 to 250 ms or from 2 ms to 100 ms, and dx=+1 and dy=+1.

In all of the above mentioned embodiments, the value of ΔT can for example be at least 1 ms, or at least 2 ms or at least 8 ms, or at least 16 ms, or at least 24 ms, or at least 32 ms, or at least 40 ms, or at least 48 ms, or at least 56 ms, or at least 64 ms, or at least 72 ms, or at least 80 ms, or at least 88 ms, or at least 96 ms, or at least 104 ms, or at least 120 ms, or at least 144 ms, or at least 160 ms, or at least 176 ms, or at least 192 ms.

In all of the above mentioned embodiments, the value of ΔT can for example be equal to about 8 ms or about 16 ms, or about 24 ms, or about 32 ms, or about 40 ms, or about 48 ms, or about 56 ms, or about 64 ms, or about 72 ms, or about 80 ms, or about 88 ms, or about 96 ms, or about 104 ms, or about 112 ms, or about 120 ms, or about 128 ms, or about 136 ms, or about 144 ms, or about 152 ms, or about 160 ms, or about 168 ms, or about 176 ms, or about 184 ms, or about 192 ms, or about 200 ms, or about 208 ms, or about 216 ms, or about 224 ms, or about 232 ms, or about 240 ms, or about 248 ms.

On the one hand the value of ΔT should be sufficiently large to increase the likelihood that the computer device has sufficient time for the dummy-movement signal to be processed by the overlay application, before the button press signal arrives. On the other hand, the value of ΔT should be as small as possible to reduce the latency, and to reduce the risk that a real movement signal or a dummy movement signal from the other mouse device could intervene. The skilled person can find a suitable compromise.

In an embodiment, the dummy movement signal or message contains the displacement values dx=0 and dy=0. If this message is not filtered out by the O/S and GUI, such a message would be ideal, because it does not adjust the coordinates of the first and second position Pos1 or Pos2, yet it allows to signal to the overlay application to reposition the native mouse cursor (or stated in other words: it allows the overlay application to force a jump if needed). If the dummy-movement message has a zero-displacement (dx=0 and dy=0), the native mouse cursor NC does not shift or drift due to multiple dummy movement messages being sent, irrespective of how many times the button is clicked, and/or the scrollwheel is scrolled.

In another embodiment, the dummy movement message is not a single predefined message with dx=0 and dy=0, but subsequent dummy movement messages are different from the first dummy movement message, with dx and dy values chosen such that a cumulative horizontal displacement defined as Δx=Σdx and a cumulative vertical displacement defined as Δy=Σdy is smaller than a predefined maximum distance. Preferably the predefined maximum distance is less than 10 pixels, more preferably less than 4 pixels, or less than 3 pixels, or less than 2 pixels.

For example, the dummy movement messages may be selected alternatingly or periodically from a group consisting of two predefined dummy movement messages, containing a first message with (dx=+1, dy=0) and a second message with (dx=−1, dy=0), resulting in a tiny left/right movement, but other groups of two messages are also possible, for example:
the group consisting of two dummy movement messages containing a first message with (dx=0, dy=+1) and a second message with (dx=0, dy=−1), resulting in a tiny up/down movement, or
the group consisting of two dummy movement messages containing a first message with (dx=+1, dy=+1) and a second message with (dx=−1, dy=−1), resulting in a tiny diagonal movement, or
the group consisting of two dummy movement messages containing a first message with (dx=+1, dy=−1) and a second message with (dx=−1, dy=+1), resulting in a tiny diagonal movement, or
the group consisting of three dummy movement messages containing a first message with (dx=+1, dy=0), and a second message with (dx=0, dy=+1), and a third message (dx=−1,dy=−1), or
the group consisting of four dummy movement messages, containing a first message with (dx=+1,dy=0), a second message with (dx=0,dy=−1), a third message with (dx=−1,dy=0), and a fourth message with (dx=0,dy=+1), etc.

In this way, the mouse position remains substantially stationary even after multiple clicks and/or scrollwheel rotations, and does not drift away from the original position unless the pointer device is physically moved.

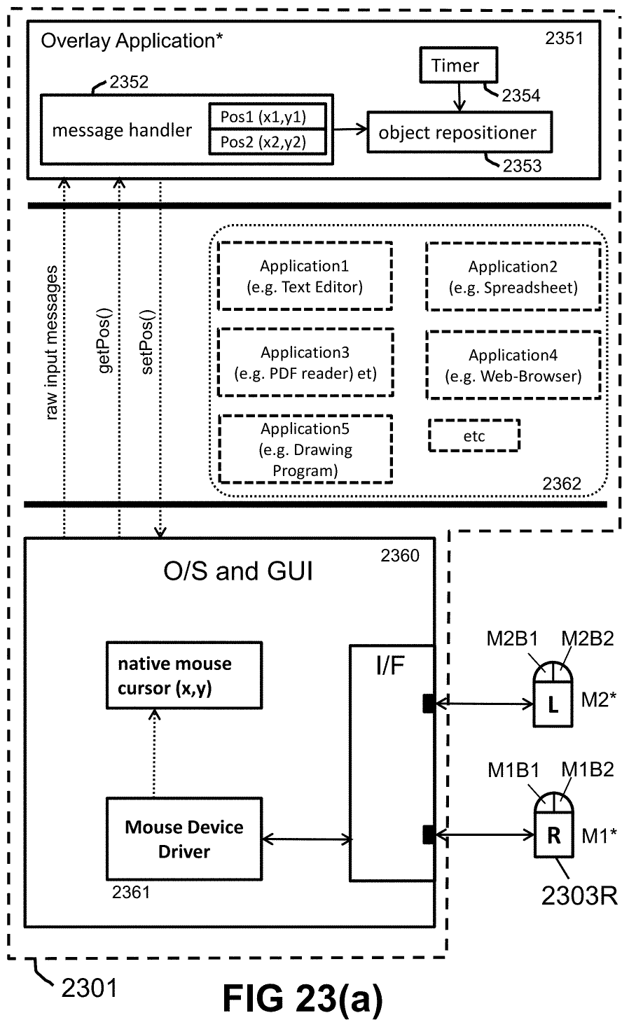

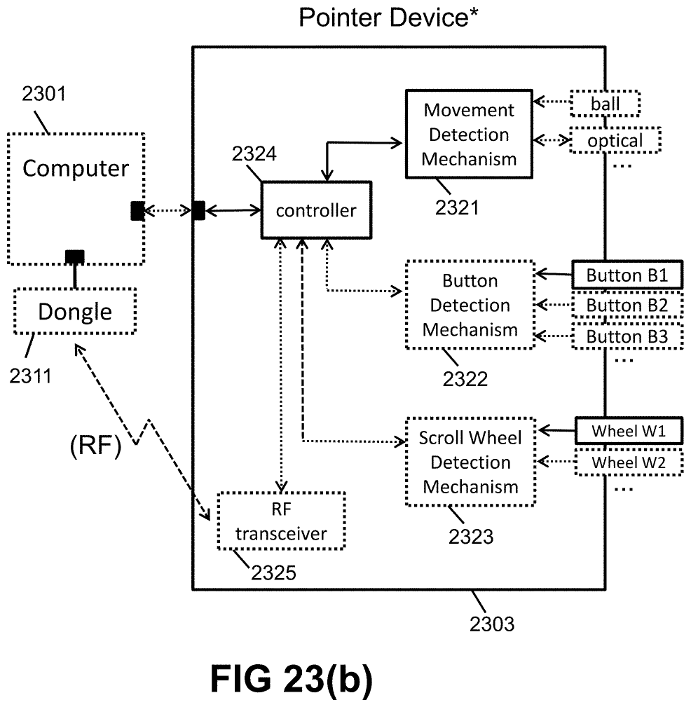

FIG. 23(a) shows a simplified high-level block diagram of hardware and software components situated in an exemplary computer system according to an embodiment of the present invention, comprising a computer device 2301 with a special overlay application 2351 according to an embodiment of the present invention, and two special mouse devices M1*, M2* according to an embodiment of the present invention. The special mouse devices M1*, M2* have the above mentioned “move-before-click” feature illustrated in FIG. 22(a) and/or the above mentioned “move-before-scroll” feature illustrated in FIG. 22(b), meaning that these mouse devices M1*, M2*, upon detection of a button being pressed and/or a scrollwheel being rotated, first send a “dummy-movement message” and only some time ΔT later send a button-press message or a scrollwheel-rotation message.

As suggested by the asterisks, only the overlay application 2351 and the mouse devices M1*, M2* are special. All other components, in particular the O/S and GUI 2360, the device drivers 2361, the other applications 2362, etc. can be classical components.

The mouse devices M1* and M2* can be wired mouse devices, or wireless mouse devices, or a combination of both.

But the present invention is not limited to special mouse devices, and the proposed solution can also be applied to other pointer devices having at least one button and/or at least one scrollwheel.

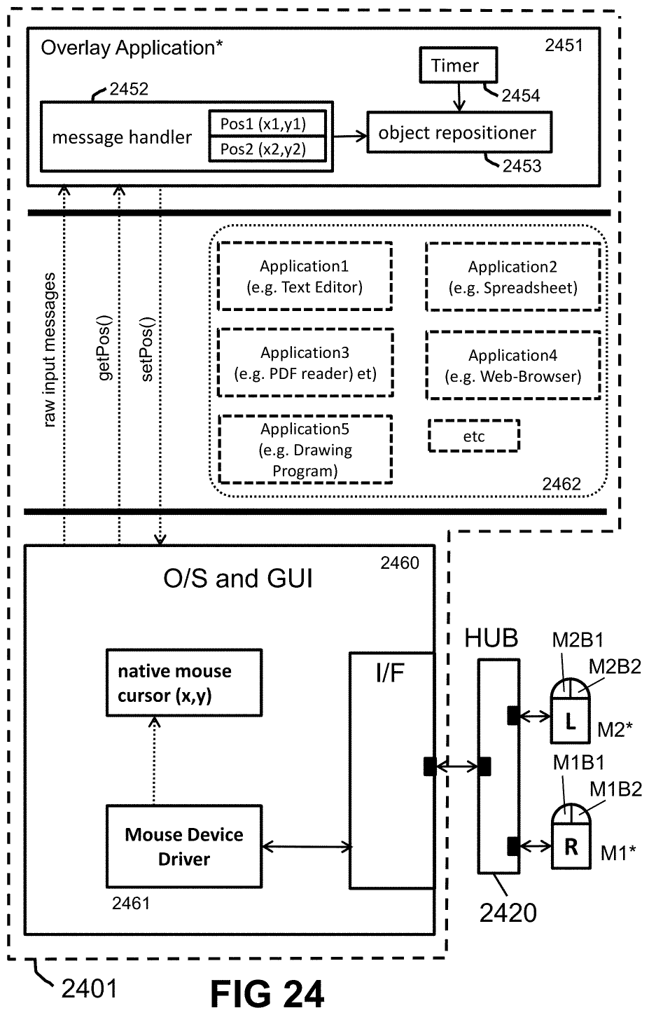

FIG. 23(b) shows an exemplary block-diagram of a special pointer device according to an embodiment of the present invention, as can be used in the system of FIG. 23(a) or FIG. 24 (to be discussed next). The pointer device 2303 comprises at least:
a movement detection mechanism 2321 for detecting a two-dimensional movement;
a controller 2324 connected to said movement detection mechanism 2321;
at least one button B1 pressable and releasable by a user;
a button detection mechanism 2322 for detecting if said at least one button B1 is being pressed or being released;
the controller 2324 being connected to said button detection mechanism 2322;
the controller 2324 being adapted for (e.g. being programmed for):
   when a movement is detected, for sending a movement message mov2;
   when it is detected that the at least one button B1 is being pressed, for sending a dummy movement message dmov2, and for sending a button-press message press2 a predefined period ΔT after sending the dummy movement message dmov.

The movement message may comprise displacement parameters dx, dy related to said two-dimensional movement.

The pointer device 2303 may further comprise at least one scrollwheel W1 rotatable by a user, and a scrollwheel detection mechanism 2323 for detecting if the at least one scrollwheel W1 has rotated, and the controller 2324 may be connected to said scrollwheel detection mechanism 2323, and may be further adapted, when it is detected that the at least one scrollwheel has rotated, for sending a dummy movement message dmov, and for sending a scrollwheel-rotation message a predefined period ΔT after sending the dummy movement message dmov.

The pointer device 2303 may further comprise an RF transceiver 2325 connected to the controller 2324, and the controller 2324 may be further configured for sending messages to a computer device 2301, and for receiving messages from the computer device 2301 via said RF transceiver 2325, for example via a dongle 2311 connected to the computer device 2301.

The controller 2324 may be a programmable controller, e.g. a microprocessor.

FIG. 24 shows a variant of the high-level block diagram of FIG. 23(a), where the two “special” pointer devices M1*, M2* are connected to the computer device 2401 via a classical hub or adaptor or dongle 2420 instead of being connected directly to the computer device. The hub 2420 can be a wired hub, or a wireless hub.

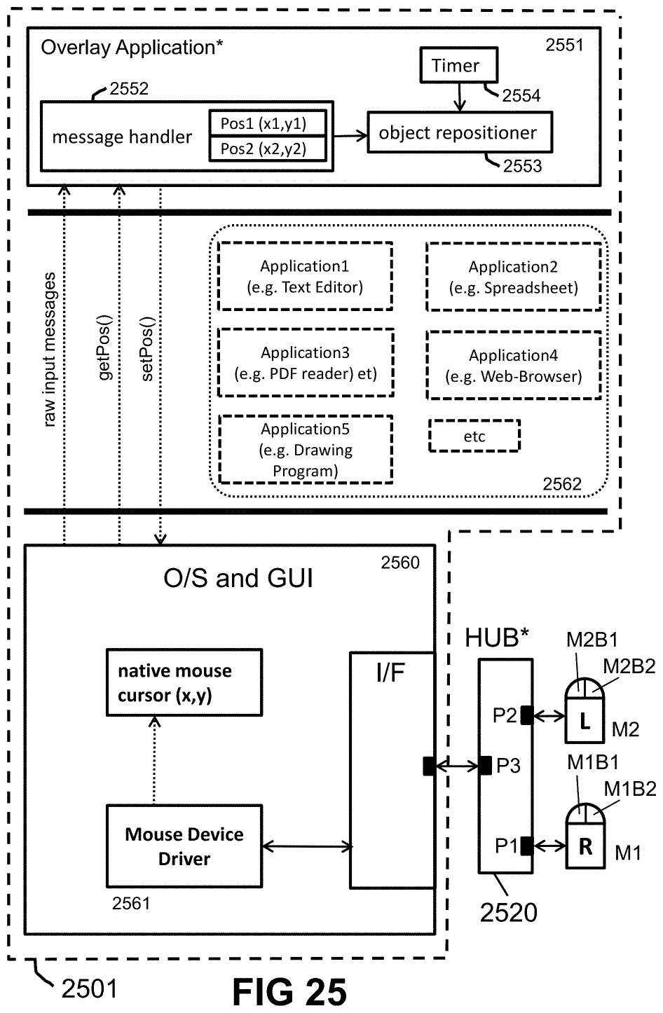

FIG. 25 shows a variant of the high-level block diagram of FIG. 24, where the problem shown in FIG. 21 is solved in a special hub 2520 rather than in special pointer devices. Thus, the computer device 2501 of FIG. 25 preferably comprises a classical O/S and GUI 2560, classical applications 2562, classical device drivers 2561 e.g. mouse drivers, classical pointer devices M1, M2, but a special overlay application 2551 and a special hub or adaptor or dongle 2520.

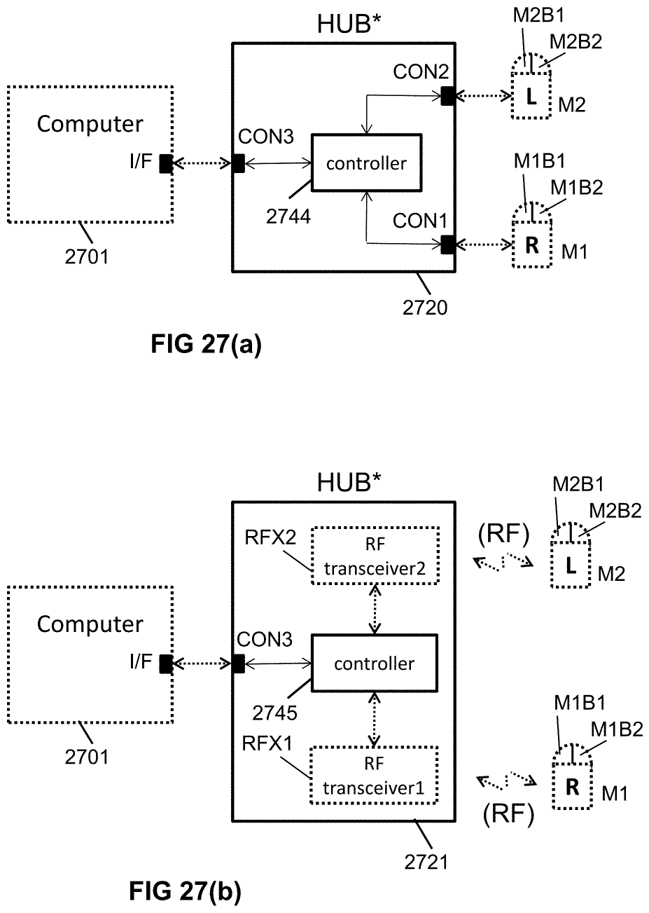

The functionality of a special hub 2520 will be explained in more detail in FIG. 26(a) to FIG. 26(d). Exemplary hardware block-diagrams to implement this functionality will be described in FIG. 27(a) and FIG. 27(b).

As can be understood from FIG. 21 to FIG. 22(b), the hub H* should avoid that the computer device receives a button-press-message from pointer device M2 which is preceded in time by a message from the other pointer device M1 (e.g. a movement message, a button-click message, a button-release message, a scrollwheel message), and vice versa. Since the messages from both pointer devices have to pass through the hub H*, the hub is capable of preventing this situation.

In the exemplary sequence of FIG. 26(a), this situation is avoided as follows.

At time t1 the first pointer device M1 sends a movement-message mov1, and the hub H* transmits the movement-message to the computer device (also referred to as “host”).

At time t2 a button M2B1 of the second pointer device M2 is pressed, and the pointer device M2 sends a button-press-message to the hub H*. The hub H* intercepts this message, and transmits a dummy movement message dmov2 to the host (preferably with small movement parameters as explained above), preferably formatted as if this dummy movement message was sent by the second pointer device M2.

Some time later, at time t2+ΔT the hub 2520 sends the button-press-message to the host, formatted as if this message came from the second pointer device M2.

In the embodiment shown in FIG. 26, the hub H* discards all messages sent by the other pointer device M1 until the button M2B1 of the pointer device M2 is released at time t5. Therefore, in the example shown, the movement message mov1 sent by the pointer device M1 at t3 is discarded.

At time t4 the second pointer device M2 sends a button-release message to the hub H*, and the hub H* transmits this message to the host.

At time t5 the first pointer device M1 sends a movement message to the hub H*, and the hub H* transmits this message to the host.

In other words, the special hub H* implementing the behaviour of FIG. 26(a) passes all messages coming from the pointer devices to the host, except when a button-press message is received from one of the pointer devices (in the example M2), in which case the hub H* temporarily behaves in a special manner, namely by first sending a dummy movement message, and some time ΔT later sending a button press message press2, and by discarding all messages from the other pointer device (in the example: M1) until a button-release message is received from the pointer device M2 of which button M2B1 was pressed.

FIG. 26(b) shows the same sequence as FIG. 26(a), but handled differently by a variant of the special hub H*. In this embodiment, the hub does not discard the movement message mov1 sent at t3, but delays this message until after the button-press press2 message is sent to the host at t2+ΔT, say at tx=t2+ΔT+ε, where ε is preferably smaller than 33 ms, for example about 8 ms or about 16 ms or about 24 ms. As explained above, the special overlay application may optionally update Post, but needs some time to reposition the native mouse cursor to Pos2, otherwise the O/S may interpret the button being released at Pos1 rather than Pos2. Therefore, in this example, the button-release message sent by the second pointer device M2 at t4 also needs to be delayed until tx+ΔT. Of course, if t4 was already larger than tx, than the button-release message release2 can be simply forwarded to the host.

If the behaviour of the signals and how the overlay application will react to them illustrated in FIG. 26(b) is well understood, it can now be appreciated that the position-update routine of FIG. 18(b), allowing the second object to be moved while a button of the first pointer device is pressed, would go wrong for the sequence shown in FIG. 26(b), in case the user releases the button M2B1 sooner than tx+AT. The routine shown in FIG. 18(a) does not suffer from this problem, because it discards the movement signal, in pretty much the same was as the hub of FIG. 26(a) does.

Thus, when the special hub H* is used, the position-update routine of FIG. 18(a) and that of FIG. 18(b) can both be used in the BothHanded input mode, because the hub takes care of the timing between the messages from different devices. But if the special hub is not used in the computer system, the position-update routine shown in FIG. 18(a) is “safer”.

FIG. 26(c) shows an exemplary sequence to explain how the special hub H* having the behaviour specified in FIG. 26(a) may react in response to a scrollwheel-message.

At time t1 the first pointer device M1 sends a movement-message mov1, and the hub H* transmits the movement-message to the computer device (also referred to as “host”).

At time t2 a scrollwheel M2W1 of the second pointer device M2 is rotated, and the pointer device M2 sends a scrollwheel-rotation message to the hub H*. The hub H* intercepts this message, and transmits a dummy-movement message dmov2 to the host (preferably with small movement parameters as explained above), preferably formatted as if this dummy-movement message was sent by the second pointer device M2.

Some time later, at time t2+ΔT the hub H* sends the scrollwheel-rotation message to the host, formatted as if this message came from the second pointer device M2.

In the embodiment shown in FIG. 27, the hub H* discards all messages sent by the other pointer device M1 to the hub H* arriving between t2 and t2+ΔT. Therefore, in the example shown, the movement message mov1 sent by the pointer device M1 at t3 is discarded.

At time t4 the first pointer device M1 sends a movement message mov1 to the hub H*, and the hub H* transmits this message to the host.

At time t5 the second pointer device M2 sends a movement message to the hub H*, and the hub H* transmits this message to the host.

FIG. 26(d) shows the same sequence as FIG. 26(c), but handled differently by a variant of the special hub H*. In this embodiment, the hub H* does not discard the movement message mov1 sent at t3, but delays this message until after the scrollwheel-rotation message scroll2 is sent to the host at t2+ΔT, say at tx=t2+ΔT+ε. The movement message mov1 at t4 sent by the first pointer device M1, and the movement message mov2 sent by the second pointer device M2 are simply transmitted to the host.

Comparing the behaviour of the special hub H* as specified in FIG. 26(a) to FIG. 26(d) with the behaviour of the special pointer devices, as specified in FIG. 22(a) and FIG. 22(b), it can be seen that the special hub H* addresses the problem of FIG. 21 based on the same principle, namely by inserting a dummy-movement message some time ΔT before forwarding the actual button-press message or scrollwheel-rotation message. Implementing this behaviour in a special hub rather than in special pointer devices provides the additional advantage that the hub H* can really prevent that the other pointer device sends an intermediate message to the host in between this dummy movement message and the actual button-press or scrollwheel-rotation message, and can therefore guarantee that the situation of FIG. 21 will not occur. That is not possible with the special pointer devices.

Or stated in other words, while the “move before click” and the “move before scroll” feature proposed in FIG. 22 decreases the risk that the computer device will misinterpret the messages, the risk is not completely eliminated, because one pointer device has no influence over the messages sent by the other pointer device. In contrast, a special hub H* having the characteristics described in FIG. 26(a) to FIG. 26(d) has full control over the messages which are sent to the computer device, and can filter and/or adapt the stream of messages to and from both pointer devices. In this way undesired combinations of conditions or undesired timing between the signals/messages can be avoided, or adjusted, such that the O/S and GUI and the special overlay application 2551 will function correctly.

“Smart hubs” which interpret and/or modify and/or insert and/or delay messages from multiple pointer devices for allowing dual mouse support on a computer device in general, let alone for facilitating dual mouse support provided by an overlay application running on a computer device having an O/S and GUI that provides only a single native mouse cursor, to reposition the native mouse cursor, in order to provide an O/S and GUI that virtually provides dual mouse support, do not exist in the prior art.

FIG. 27(a) shows an exemplary block-diagram of a hub or dongle or adapter according to an embodiment of the present invention, as can be used in the system of FIG. 25, having at least two physical connectors CON1, CON2 for connection with two classical wired pointer devices M1, M2, and at least one connector CON3 (optionally at the end of a cable) for connection with a computer device 2701.

FIG. 27(b) shows an exemplary block-diagram of a wireless hub (or dongle or adapter) according to an embodiment of the present invention, as can be used in the system of FIG. 25, having one or two RF transceivers for operative connection with two classical wireless pointer devices.

The hub 2720 of FIG. 27(a) comprises:
a first interface CON1 for communicating with a first pointer device M1;
a second interface CON2 for communicating with a second pointer device M2;
a third interface CON3 for communicating with a computer device 2701;
a controller 2744 being connected to said first interface for receiving first messages from the first pointer device M1, and being connected to said second interface for receiving second messages from the second pointer device M2, and being connected to said third interface for transmitting said first and second messages to said computer device (2701);
and wherein the controller 2744 is adapted for sending a dummy movement message a predefined period (ΔT) before sending a button-press message and/or a scrollwheel-rotation message.

More specifically, the controller 2744 may be adapted to behave as follows:

upon receipt of a first button-press message press1 from the first pointer device via the first interface, to send a first dummy movement message dmov1 to the computer device via the third interface, and a predefined period ΔT later to send the first button-press message press1 to the computer device via the third interface;
upon receipt of a second button-press message press2 from the second pointer device via the second interface, to send a second dummy movement message dmov2 to the computer device via the third interface, and a predefined period ΔT later, to send the second button-press message press2 to the computer device via the third interface;
upon receipt of a first scrollwheel-rotation message from the first pointer device via the first interface, to send a first dummy movement message dmov1 to the computer device via the third interface, and a predefined period ΔT later, to send the first scrollwheel-rotation message to the computer device via the third interface;
upon receipt of a second scrollwheel-rotation message from the second pointer device via the second interface, to send a second dummy movement message dmov2 to the computer device via the third interface, and a predefined period ΔT later, to send the second scrollwheel-rotation message to the computer device via the third interface.

The hub 2721 of FIG. 27(b) comprises:
a first RF transceiver RFX1 for receiving messages from and transmitting messages to the first pointer device M1; and
a second RF transceiver RFX2 for receiving messages from and transmitting messages to the second pointer device M2, the second RF transceiver being the same as the first RF transceiver, or being a separate RF transceiver; and
a connector CON3 connectable to a computer device 2701;
a controller 2745 being connected to said first RF transceiver RFX1 for receiving first messages from the first pointer device M1, and being connected to said second RF transceiver RFX2 for receiving second messages from the second pointer device M2, and being connected to said connector CON3 for sending messages to (and typically also receiving messages from) the computer device 2701,
   the controller being adapted for sending a dummy movement message a predefined period ΔT before sending a button-press message to the computer device and/or for sending a dummy movement message a predefined period (ΔT) before sending a scrollwheel-rotation message to the computer device.

What is described above related to the parameters dx, dy, ΔT when discussing special pointer devices, is not repeated here, but is also applicable for the special hub.

The controller 2744, 2745 may be a programmable controller, e.g. a microprocessor.

FIG. 28(a) shows an exemplary user-interface window, referred to herein as the “mini user interface”, as can be used in embodiments of the present invention for configuring the overlay application, e.g. to select an input mode and/or a display mode, and/or to select a size and/or a color of the second or further visible object, and/or to select a semi-transparency level of the click-through window using one or more pop-up menus, an example of which is shown in FIG. 28(b).

The user interface window, e.g. window 585 in FIG. 5c or window 885 in FIG. 8c, is preferably opaque and is not configured in click-through mode, and preferably has a Z-order higher than that of the click-through window 584, 884 in FIG. 5c and FIG. 8c. The pop-up menu of FIG. 28(b) may for example appear when clicking on a right button of the dominant pointer device when the native mouse cursor is positioned over one of the icons representing a specific display mode.

The overlay application may implement one or more input modes selected from the group consisting of: a Single Pointer mode (denoted as “SingleH” in FIG. 28a), a Dual Pointer Mode with the left Pointer device being the dominant pointer device (denoted as “LeftH” in FIG. 28a), a Dual Pointer Mode with the right Pointer device being the dominant pointer device (denoted as “RightH” in FIG. 28a), and a Dual Pointer Mode where both pointer devices are dominant (denoted as “BothH” in FIG. 28a).

In an embodiment of the present invention configurable in one of multiple input modes, a message handler of the overlay application may comprise the pseudo-code of FIG. 18(c). It is noted that testing whether a button of the dominant pointer device is pressed or not, is not required in case of the RightHanded and LeftHanded input mode, because in these cases the native mouse cursor does not jump from one to the other maintained position Post, Pos2. Thus for example, in the case of the RightHanded input mode, a button of the right pointer device may well be pressed and moved (e.g. when dragging or when selecting text in a text editor) while the left pointer device is also being moved, without causing a conflict (assuming that no button of the left pointer device is being pressed, and that the scrollwheel of the left pointer device is not being rotated).

It is noted in this respect that some embodiments of the special hub may implement the behaviour illustrated in FIG. 26(a) and FIG. 26(c), or as illustrated in FIG. 26(b) and FIG. 26(d), assuming that both pointer devices are allowed to be moved and/or clicked and/or scrolled.

Other embodiments of the special hub may unconditionally discard all button press messages and all button release messages and all scrollwheel rotation messages received via one of its input ports, and only pass movement messages. Such embodiment may be especially useful in combination with a LeftHanded or RightHanded input mode. In this way it is guaranteed that such message sent by the non-dominant pointer device cannot reach the computer device, even if the user would accidentally click or scroll the non-dominant pointer device.

Some embodiments of the special hub are configurable, e.g. via dip switches or in software, for example via a command from the overlay application, or in any other way, to either (i) allow passage of all movement and press and release and scrollwheel-rotation messages from all pointer devices, or (ii) to allow passage of movement messages from all pointer devices, but to allow press—and release—and scrollwheel messages only from one single pointer device.

The overlay application may implement one or more display modes, for example as represented by the icons shown in FIG. 28(a).

First Group:

A first group 2840 of display modes works with the “Single Pointer” input mode, and offers the following display modes, which can be summarised as follows:
icon 2840(a) represents a mode with the single (native) mouse pointer provided by a classical O/S and GUI,
icons 2840(b) to 2840(f) represent a mode with the single (native) mouse pointer, but in addition a second and/or third visible object in the form of (b) a hand; (c) a square or line segment or rectangle; (d) a line or rectangle which extends over the entire width of the overlay window; (e) a small cross; (f) a large cross formed by a horizontal line or rectangle which preferably extends over the entire width of the overlay window 584, 884 and by a vertical line or rectangle which preferably extends over the entire height of the overlay window 584, 884;
icon 2840(j) representing a mode with a horizontal line or bar similar to mode 2840(d), but with an additional visible object in the form of a small block e.g. a square or rectangle movable inside said line or bar;
icon 2840(k) represents a mode with a vertical line which splits the screen in a left part and a right part, this vertical line is preferably movable by “dragging” (after temporarily setting the overlay window 584, 884 in “non-click-through mode” as explained in more detail in the co-pending “perforated bitmap application”), and with a horizontal line on the left part of said vertical line, which horizontal line moves along with the mouse pointer when the mouse pointer is located on the left side of the vertical line, and which horizontal line freezes when the mouse pointer is located on the right side of the vertical line. This mode may be especially useful for right-handed translators or reviewers working with only a single mouse pointer;
icon 2840(l) represents a mode similar to mode 2840(k) but the horizontal line is located on the right side of the vertical line, and moves up/down when the native mouse pointer is located on the right side of the vertical line, and freezes when the mouse pointer is located on the left side of the vertical line. This mode may be especially useful for left-handed translators or reviewers working with only a single mouse pointer.

In all of the modes 2840(a)-(l) the native mouse cursor is visible on screen, and moves along with the at least second visible object in the form of a hand or a line or a cross or a block as described above, except in the modes with the “frozen line” represented by icon 2840(k) and 2840(l), where the visible object only moves along with the pointer device under certain conditions.

Second Group:

A second group 2850 of display modes works with the “LeftHanded Dual Pointer” input mode, and offers the following display modes, which can be summarised as follows:
icon 2850(a) represents a mode with the single (native) mouse pointer provided by a classical O/S and GUI, and in addition a second visible object in the form of an arrow, e.g. a black arrow. The native mouse cursor is controlled by the left pointer device. Aspects of mode 2850(a) were also described in FIG. 9;
icons 2850(b) to 2850(f) represent a mode with the single (native) mouse pointer controllable by the left pointer device, and with an additional second or further visible object in the form of (b) a hand; (c) a square; (d) a line or rectangle; (e) a small cross; (f) a large cross, controllable by the other pointer device, namely the right pointer device;
icon 2850(g) to icon 2850(i) represents a mode similar to mode 2850(c) to 2850(e), but the overlay application further shows an additional (g) square or (h) line or (h) small cross which moves along with the native mouse pointer, and thus is movable by the left pointer device;
icon 2850(j) represents a mode where the overlay application provides a vertical line that splits the screen in a left part and a right part, and with a first horizontal line located on the left side of the vertical line that moves in accordance with movements of the left pointer device, and with a second horizontal line located on the right side of the vertical line that moves in accordance with movements of the right pointer device. The native mouse cursor is movable over the entire screen, and moves along with the left pointer device. This mode may be especially useful for left-handed translators or reviewers comparing two texts;
icon 2850(l) represents a variant of the mode 2850(j) without showing the left horizontal line;

In all of the modes 2850(a)-(l) the native mouse cursor is visible on screen, and moves in accordance with movements of the left pointer device, which is why these modes are probably most suitable for left-handed people controlling the native mouse cursor with their dominant (left) hand, and moving a second visible object with their non-dominant (right) hand. The user should not click or scroll the non-dominant pointer device, only move it (e.g. to underline textual information on screen).

Third Group:

A third group 2860 of display modes works with the “RightHanded Dual Pointer” input mode, and offers display modes similar to the second group 2850 of display modes, except that the function of the left and right pointer device are swapped, and that in mode 2860(k) the left horizontal line is shown rather than the right horizontal line.

Aspects of mode 2860(a) were also described in FIG. 8.

Aspects of mode 2860(d) were also described in FIG. 5.

Aspects of mode 2860(h) were also described in FIG. 6.

In all of the modes 2860(a)-(k) the native mouse cursor is visible on screen, and moves in accordance with movements of the right pointer device, which is why these modes are probably most suitable for right-handed people controlling the native mouse cursor with their dominant (right) hand, and moving a second visible object with their non-dominant (left) hand. The user should not click or scroll the non-dominant pointer device, only move it (e.g. to underline textual information on screen).

Fourth Group:

A fourth group 2870 of display modes works with the “BothHanded Dual Pointer” input mode, and offers display mode 2870(a) with two visible objects: the native mouse cursor, e.g. as a white arrow, and a second arrow (e.g. black arrow) already described in FIG. 10,
icon 2870(b) represents a mode similar to mode 2850(b) except that two bitmaps with a hand are shown, one movable with the left pointer device, the other movable with the right pointer device;
icon 2870(g) to icon 2870(j) represents a mode similar to mode 2850(g) to 2850(j), except that the native mouse cursor will follow the position associated with the pointer device which is most recently moved, and/or a button of which is most recently pressed, and/or a scrollwheel of which is most recently rotated, as explained above. These modes are especially suitable for users who want to move and click and/or scroll both pointer devices, for example the transcribers of FIG. 4, but for example also the translators or proofreaders of FIG. 1 desiring to scroll through and/or edit both documents using both pointer devices.

As described above (see e.g. FIG. 14 and FIG. 15 and FIG. 19 and FIG. 20), the modes of this fourth group 2870 work well even with classical pointer devices M1, M2 provided that the pointer device which is clicked and/or scrolled is the one which is most recently moved, which requires special attention of the user. A relatively simple solution would be to always first manually move a mouse before clicking it. But as explained above, these modes work even better when using special pointer devices (see e.g. FIG. 22) which automatically take care of the “move before clicking” and/or “move before scrolling”, or with a special hub or adaptor or dongle as described above, see e.g. and FIG. 26(a) to FIG. 26(d).

FIG. 28(b) shows an exemplary pop-up menu which can be invoked by clicking with a right button of the dominant pointer device on some of the display modes in the mini-interface window of FIG. 28(a). In the example shown, the menus allow to change the color, and the size of the second and/or further visible object(s), as well as to select a transparency level of the click-through overlay window 584 (FIG. 5c) or 884 (FIG. 8c).

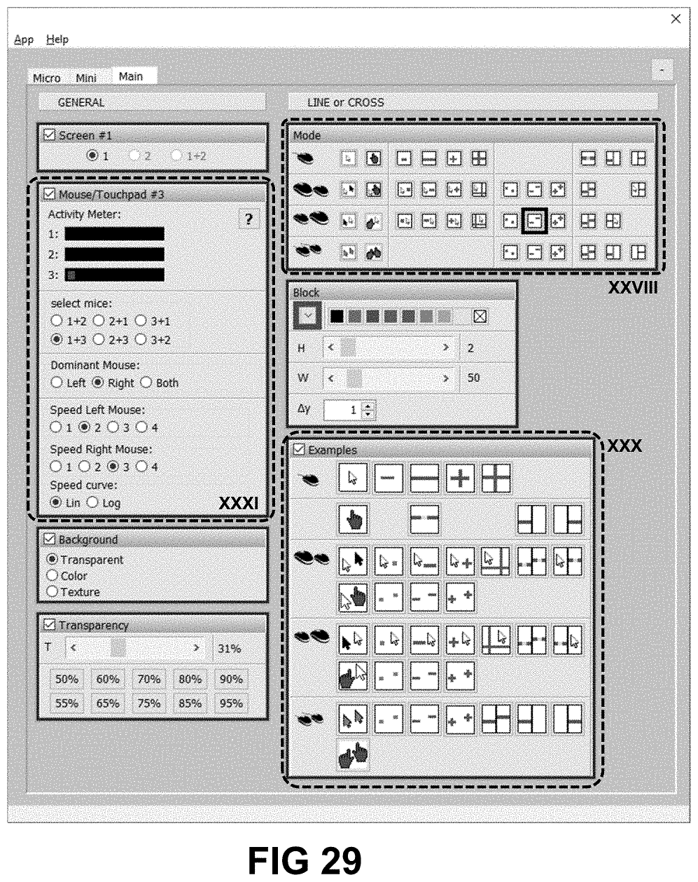

FIG. 29 shows another exemplary user-interface window, referred to herein as the “main user interface”, as can be used in embodiments of the present invention for configuring the overlay application.

The user interface (UI) window shown in FIG. 29 has a region with title “Mouse/Touchpad” for selecting the input mode (e.g. LeftHanded or RightHanded or BothHanded), and for selecting which pointer device (or rather, which “handle” assigned by the operating system to each pointer device) is to be considered the dominant pointer device (or handle thereof). The UI also comprises components such as e.g. radio-buttons for selecting relative speed of movement, etc. In FIG. 31(a) this region is shown in an enlarged view.

The interface window shown in FIG. 29 also has a region with title “Background”, which allows the click-through overlay window 584, 884 comprising the at least one second visible object 506L, 806L to further contain a bitmap comprising pixels 594, 894 a majority of which are fully transparent pixels, or semi-transparent monochrome pixels, or a semi-transparent texture bitmap as described in more detail in the co-pending “perforated bitmap application”.

The exemplary user interface window shown in FIG. 29 also has a region with title “Transparency”, which allows to select or choose an alpha-transparency level of the overlay window 584. For example, if the background pixels 584 and 884 are fully transparent pixels, the degree of transparency of the movable visible object can be modified in this way. The user may choose a compromise between on the one hand showing an object which is quite different from the background pixels, and on the other hand, which is sufficiently transparent to be able to read underlying textual information.

The user interface window shown in FIG. 29 also has a region with title “Mode”, which is already described in FIG. 28. Depending on the display mode being selected, the main window may show an additional region such as the region “block” where the user can select a color, height, width and vertical offset, for example.

The interface window shown in FIG. 29 also has a region with title “Examples”, for using the display modes with default settings, but default settings can also be implemented differently, of course. In FIG. 30 this region is shown in an enlarged view.

It is pointed out that embodiments of the present invention are by no means limited to this particular user-interface.

FIG. 30 is an enlarged view of a portion of FIG. 29. It gives a visual overview of various possible embodiments of the present invention, however, the invention is not limited thereto. These default modes largely correspond to the modes shown in the mini-interface of FIG. 28(a). Some of the modes are described in more detail in this document, as indicated by the roman numbers referring to the respective figures.

FIG. 31(a) is an enlarged view of a portion of FIG. 29. It illustrates for example how a user can select an input mode, e.g. LeftHanded; RightHanded; BothHanded.

It is noted for example that a touchpad of a laptop computer is also considered a pointer device, hence the indication “#3” in the title, meaning that the operating system of the computer device from which this screenshot was taken, found three input devices: two physical mouse devices and one touchpad.

It is noted that the present invention will also work for example with a laptop computer to which only a single physical mouse is connected, e.g. by using the touchpad as the non-dominant pointer device and the physical mouse as the dominant pointer device.

FIG. 31(b) is a variant of the portion of FIG. 31(a), where a feature is added to adjust the orientation of the displacement vector defined by the displacement values (dx, dy) into a preferred orientation selected from a first group of predefined directions consisting of the directions: North, West, South, East, or from a second group of predefined directions consisting of the directions: North, North-West, West, South-West, South, South-East, East, North-East. This transformation can be applied to movements of the dominant pointer device only, or to movements of the non-dominant pointer device only, or to both pointer devices.

Tests have shown that this feature can greatly help the user to better control movements of one or both the pointer devices, when performing certain tasks. For example, this feature may be particularly helpful to move the pointer device controlled by the non-dominant hand horizontally over a text line, e.g. when performing text based tasks such as reading a text document, proofreading a translation, pointing to individual words on a same line during a webinar or presentation, etc.

FIG. 31(c) shows a few exemplary lines of pseudo-code which can be used in the position update routine for transforming the displacement values dx, dy to be located in an orientation of the second group of eight allowed orientations mentioned above (North, North-West, etc.). In the example of FIG. 31(c),
if dx=0, it means the movement was already vertical, hence no modification is required;
if dy=0, it means the movement was already horizontal, hence no modification is required;
if dx=dy, it means the movement was already diagonal, hence no modification is required,
otherwise, it is determined whether the angle of the displacement vector lies in the range from (−30° to +30°) or in the range from (150° to 210°), in which case the absolute value of the tangent of said angle is smaller than 0.5, in which case the movement is forced to be horizontal,
and/or it is determined whether the angle of the displacement vector lies in the range from (60° to) 120° or in the range from (240° to 300°), in which case the absolute value of the tangent of said angle is larger than 2.0, in which case the movement is forced to be vertical,
otherwise the movement is forced to be diagonal (oriented at +45° or 135° or 225° or 315°).

It is noted that no goniometric functions are used in this routine, thus keeping the implementation relatively simple and relatively fast, thereby keeping the CPU load relatively low. The careful reader will recognize that the amplitude of the displacement vector may slightly increase or decrease by the adjustment, in order to keep the transformation simple and fast. This effect is barely noticeable.

Tests have shown that the transformation of FIG. 31(c) does not influence slow movements of the pointer device, (for which dx and dy are very small). This feels to a user as if relatively slow movements can be performed in any direction, which is desirable to allow fine-tuning of a position on the screen. However, if the speed with which the pointer device is moved is increased, the amplitude of the displacement vector will become larger than a predefined threshold (in the example of FIG. 31c larger than 0), in which case the displacement is forced to be horizontal or vertical or diagonal. This behaviour is highly desirable to keep almost horizontal movements perfectly horizontal, which is difficult to achieve manually, especially at relatively high speed.

But of course, the present invention does not require this feature to be present (it can be enabled or disabled by a user). Furthermore, if present, the present invention is not limited to the specific routine or algorithm shown in FIG. 31(c), and other algorithms for reorienting the pointer movements are also contemplated, for example as described in the following variants.

FIG. 31(d) and FIG. 31(e) show a variant of the displacement transformation routine, where near-horizontal movements are transformed into pure horizontal movements.

More specifically, FIG. 31(d) shows a graphical representation of the displacement vector V corresponding to the physical movement of the pointer device, associated with the displacement values (dx, dy). The displacement vector V forms an angle α relative to the X-axis. If this angle lies in the segments indicated in gray color, meaning that the angle α lies in the range [−α max+α max] or in the range [180°−α max 180°+α max], then the displacement vector is transformed into a pure horizontal displacement, by setting the value for dy equal to zero. Rather than working with angles, this can be codified by calculating the absolute value of the tangent of the angle, which is abs(dy/dx), and testing whether this value is smaller than, or smaller or equal to a predefined constant. For example, α max=30° corresponds to abs(dy/dx)<0.577, or as another example, testing whether abs(dy/dx)<0.5 corresponds to testing whether the angle α lies in the range from about [−26° to +26° ] or about [154° to 206], but of course, the present invention is not limited to only this range, and other ranges can be used as well.

FIG. 31(e) shows exemplary lines of pseudo-code implementing the “displacement transformation” described above, which may be used in the “position update routine” (see for example step g) of FIG. 5(e), when updating Pos1 and Pos2). But of course another angular range can be used, or in other words, the invention will also work with other values for MAXTAN, for example values in the range from 0.2 to 0.75, for example smaller than 0.25=¼, or smaller than 0.33=⅓, or smaller than 0.5=½, or smaller than 0.66=⅔, or smaller than 0.75=¾. The skilled person having the benefit of the present invention can easily define other suitable ranges.

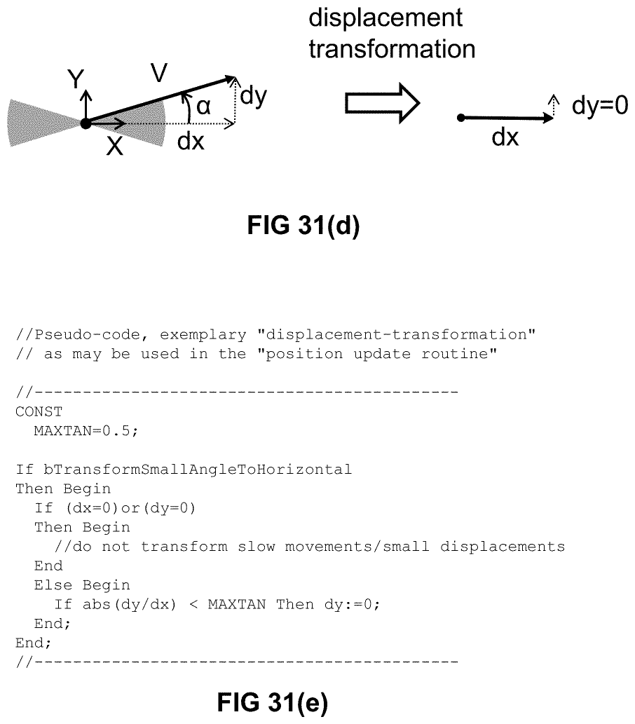

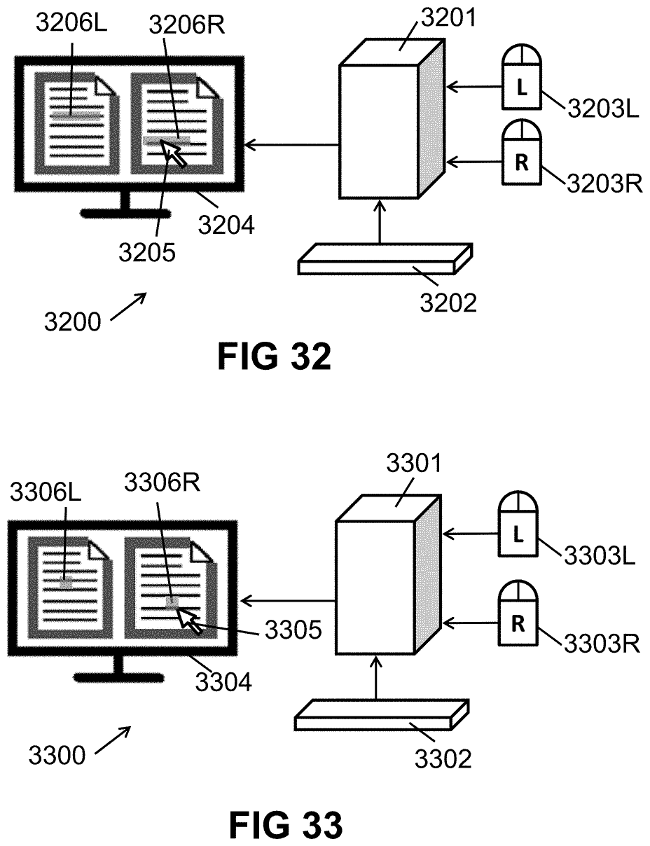

FIG. 32 shows a computer system 3200 according to an embodiment of the present invention, comprising a computer device 3201 according to an embodiment of the present invention, running an overlay application according to an embodiment of the present invention, and two pointer devices, e.g. mouse devices 3203L, 3203R connected to the computer device, and optionally a keyboard 3202. The mouse devices may be classical mouse devices, or may be special mouse devices with the “move-before-click” feature and/or the “move before scroll” feature as explained in FIG. 22(a) and FIG. 22(b). The mouse devices may be connected to the computer device directly (e.g. as shown in FIG. 11 and FIG. 23(a)), or via a classical hub or adaptor or dongle (e.g. as shown in FIG. 12 and FIG. 24) or via a special hub (e.g. as shown in FIG. 25).

The overlay application used in the system of FIG. 32 allows the O/S and GUI (e.g. Windows 7 or Windows 10 from Microsoft Corporation, or mac OS Sierra or mac OS High Sierra from Apple Inc.) to show the native mouse cursor 3205, but adapts, e.g. overrides its position. The overlay application further provides a second visible object 3206L and a third visible object 3206R, in the example of FIG. 32 being two lines or rectangular regions. These rectangular regions may be opaque or semi-transparent. They may have a single color, or a color gradient, or may contain a perforated bitmap. The other pixels of the overlay window may be fully transparent pixels, or may all be semi-transparent pixels, or the overlay window may comprise a perforated bitmap or a texture bitmap as explained in the co-pending “perforated bitmap application”.

In case the overlay application is designed for (e.g. hardcoded) or configured in display mode 2860(h), thus in the RightHanded input mode, the object 3206L follows movements of the left pointer device 3203L (or rather the pointer device configured or indicated as the left pointer device) and the native mouse cursor 3205 and the object 3206R follow movements of the right pointer device 3203R (or rather the pointer device configured or indicated as the right pointer device).

In case the overlay application is designed for (e.g. hardcoded) or configured in display mode 2870(h), thus in the BothHanded input mode, the object 3206L follows movements of the left pointer device 3203L (or rather the pointer device configured or indicated as the left pointer device) and the object 3206R follows movements of the right pointer device 3203R (or rather the pointer device configured or indicated as the right pointer device), and the native mouse cursor 3205 will move and/or jump depending on which pointer device is most recently moved and/or clicked and/or scrolled.

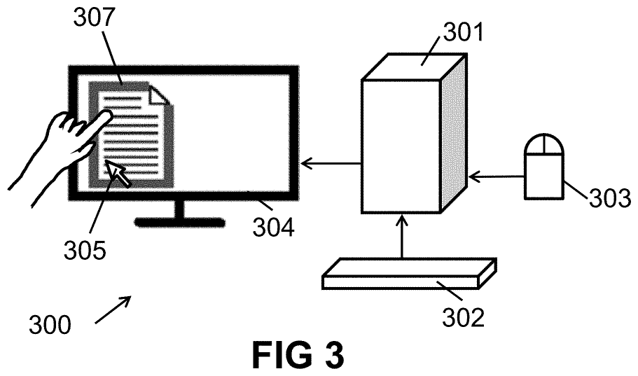

The embodiment illustrated in FIG. 32, and variants thereof, optionally using a wired or wireless hub or adaptor or dongle, and optionally using a movement transformation as explained in FIG. 31(b) and FIG. 31(c) may be especially useful for addressing the problem described in FIG. 1 and FIG. 3, where it is desired to underline two text fragments.

FIG. 33 illustrates embodiments of the present invention implementing display mode 2850(g), 2860(g) and 2870(g), where the O/S and GUI show the native mouse cursor 3305, the shape of which can and typically will change depending on the context, and the overlay application additionally shows two visible and movable squares 3306L, 3306R. Display mode 2860(g) and 2870(g) seem to be especially suitable for any of the cases shown in FIG. 1 to FIG. 4 for right-handed people, while display mode 2850(g) and 2870(g) seems to be especially suitable for similar problems as shown in FIG. 1 to FIG. 4 but for left-handed people.

FIG. 34 illustrates embodiments of the present invention implementing display mode 2870(b), where the O/S and GUI show the native mouse cursor 3405 (in the example a white arrow), and the overlay application additionally shows two visible objects, a second object 3406L being or containing a bitmap or image of a left hand, and a third object 3406R being or containing a bitmap or image of a right hand. Also this mode seems to be especially suitable for all the cases shown in FIG. 1 to FIG. 4, especially in combination with a movement transformation routine as explained in FIG. 31(b) and FIG. 31(c) to help the user easily make horizontal movements, and especially if the hands are semi-transparent. Preferably in this case, the position of the bitmap containing the image of the hand is slightly offset relative to the position of the native mouse cursor 3405, such that the native mouse cursor is located at or near the tip of the respective forefingers. Tests have shown that the two hands may be extremely helpful when proofreading.

While the present invention can also be used with bitmaps other than a hand, it is noted that the shape of a hand, especially a hand with a stretched forefinger feels very natural and intuitive, and does not seem to distract the user's attention, may be because it looks very much like the real hand and finger shown in FIG. 1 to FIG. 3. That said, a triangular shape, or a polygonal shape, preferably having a tip at the top, can also be used.

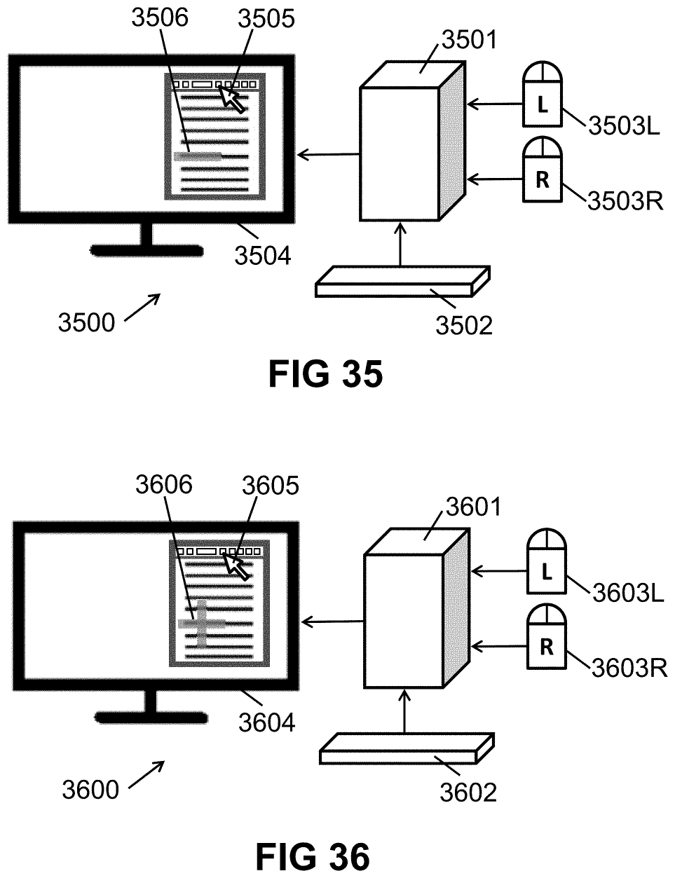

FIG. 35 illustrates embodiments of the present invention implementing display modes 2850(d) and 2860(d) showing the native mouse cursor 3505 as a first visible and movable object, and one line 3506 or rectangle as the second visible and movable object. These modes may be especially useful for addressing the problem shown in FIG. 2 and FIG. 3. It may be an advantage of this embodiment that there is no third object following the native mouse cursor, which could be slightly distracting or slightly annoying when selecting menus or colors or the like.

FIG. 36 illustrates embodiments of the present invention implementing display modes 2850(e) and 2860(e) showing the native mouse cursor 3605 as a first visible and movable object and one small cross 3606 as a second visible and movable object. These modes may also be especially useful for addressing the problem shown in FIG. 2 and FIG. 3.

Display modes 2850(j) and 2860(j) showing a large cross which extending over the entire height and width of the overlay window, can be seen as a variant of the embodiment shown in FIG. 36. These modes may be especially useful when reading or extracting information from a spreadsheet with the non-dominant hand, while working with the native mouse cursor in another document, for example a text document. The large cross in overlay offers the advantage that a specific cell can be easily found, and that the row headers and column headers of a particular cell are extremely easy to find as well, as explained in more detail in the co-pending “perforated bitmap application”.

For completeness it is noted that the mode 2840(f) with a single mouse may be better suitable when editing a spreadsheet, because in this embodiment the native mouse cursor is located at the crossing of the large cross. That said, the skilled person having the benefit of the present disclosure can easily add a display mode where the cross of display mode 2840(f) is used as the third visible object, and another object, for example a line or a square or a hand is added as a second visible object.

FIG. 37 is a variant of FIG. 32 implementing the same modes, but used to underline different portions of a single document.

FIG. 38 illustrates embodiments of the present invention implementing display modes 2850(i) to 2870(i) showing the native mouse cursor and two small crosses 3806L, 3806R.

FIG. 39 illustrates embodiments of the present invention wherein the overlay application is configured in any of the display modes 2850(j), 2860(j) and 2870(j). The horizontal line or bar 3906L located on the left side of the vertical line 3907 is automatically moved up/down when moving the left pointer device 3903L. The horizontal line or bar 3906R located on the right side of the vertical line 3907 is automatically moved up/down when moving the right pointer device 3903R. Depending on which input mode is selected or implemented, the native mouse cursor 3905 follows movements of the left pointer device 3903L (in the LeftHanded input mode), or the right pointer device 3903R (in the RightHanded input mode), or the pointer device which is most recently moved and/or clicked and/or scrolled (in the BothHanded input mode). An advantage of this embodiment for proofreaders is that the non-dominant hand does not require accurate positioning, since an entire text line can be underlined by merely moving the non-dominant pointer device up/down. Left and right movements of the non-dominant pointer device are not required. This is true especially for “easy texts” which can be read relatively fast, where it is not required or desirable to underline each word individually, in contrast to for example translations of claims, where each word needs to be carefully checked.

FIG. 40 illustrates a variant of the embodiments shown in FIG. 39, where, in addition to the horizontal line or bar on the left and right side of the vertical line 4007, the overlay application also shows two blocks or squares or rectangles 4009L, 4009R inside said horizontal line or bar 4006L, 4006R, which blocks move along with the lines in vertical direction (up/down), but are also movable in horizontal direction (left/right) in accordance with movements of the respective pointer devices 4003L, 4003R. The line or bar would typically have another color than the blocks or squares or rectangles inside the line or bar, so that they are clearly visible. In a particular embodiment or configuration, the lines have a monochrome color and the blocks are fully transparent, giving a visual impression of a bar with a “hole”.

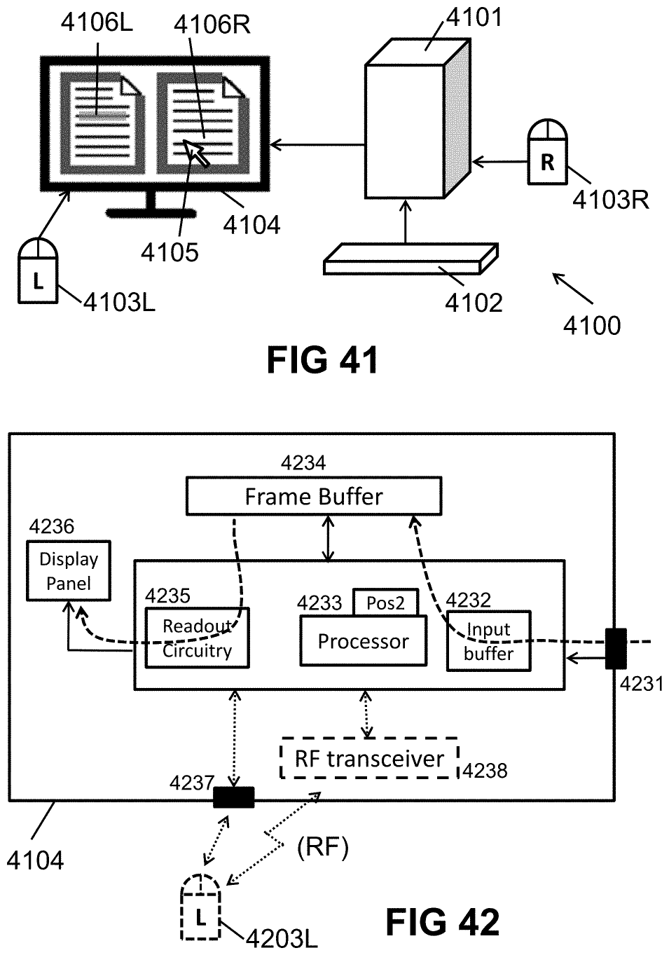

The inventors also came to the idea to solve the problem illustrated in FIG. 1 to FIG. 3 in a completely different manner, namely, outside of the computer device, for example in a special display device 4104, as illustrated in FIG. 41.

FIG. 41 shows a computer system 4100 according to an embodiment of the present invention comprising a special monitor or display 4104 according to an embodiment of the present invention, and a computer device 4101, which may be a classical computer device. The computer system 4100 comprises at least two pointer devices, including a first pointer device 4103R connected to the classical computer device 4101, and a second pointer device 4103L connected to the special display 4104, in a wired or wireless manner.

Stated in simple terms, the display device 4104 has a processor which is adapted for communicating with the pointer device 4103L and for maintaining a position xL, yL corresponding to movements of said pointer device 4103L, and is adapted for overlaying the graphical image received from the computer device 4101 with a locally generated visible object 4106L, for example having the shape of a square or a rectangle or a rectangle with rounded edges or rounded corners, or a circle or an arrow or a hand or a small cross or a large cross extending over the entire height and width of the display, or any other suitable shape, and for moving said object in accordance with movements of the pointer device 4103L by positioning said object 4106L at the maintained position xL, yL. In other words, in this embodiment the display device 4104 generates the object 4106L and shows it on the screen at a location which is movable by the left pointer device 4103L, while the computer device handles movements of the right pointer device 4103R as usual.

FIG. 42 shows an exemplary block-diagram of an embodiment of the display device 4104 as can be used in the computer system 4100 of FIG. 41. The display device 4104 comprises:
an input port 4231, e.g. a VGA port or a HDMI port or a DVI port or any other suitable port for receiving graphical image data from a computer device 4101;
an interface or port for communicating with the pointer device 4203L, e.g. a physical connector 4237 such as a USB connector, or a wireless RF interface 4238;
a display panel 4236, e.g. an LCD panel for generating a visual image;
an input buffer 4232 for storing at least a portion of said graphical image data received at the input port 4231;
a frame buffer 4234 for storing at least a portion of the image data to be shown on said display panel 4236;
and a processor adapted for:
   communicating with the pointer device 4203L for receiving displacement values dx, dy related to movements of said pointer device;
   maintaining a position xL, yL based on said received displacement values dx, dy;
   generating image data of the visible object 4106L;
   generating the image data to be stored in the frame buffer 4234 by overlaying the graphical image data received at its input port with the generated image data of the visible object 4106L at said maintained position xL,yL.

In case of a VGA or other analog input, the incoming signal needs to be digitized by means of one or more ADC (analog-to-digital) convertors, in manners known per se in the art. Likewise, if the outgoing signal is analog, the digital signal leaving the output buffer needs to be converted into analog signals using one or more DAC (digital-to-analog) convertors, in manners known per se in the art. The display device may optionally comprise input signal conversion circuitry for converting analog signals to digital signals, and/or may optionally comprise output signal conversion circuitry for converting digital signals into analog output signals.

The pointer device 4203L may be a wired mouse device or a wireless mouse device. The pointer device 4203L may be a HID-compatible pointer device, e.g. a HID-compatible mouse device. The pointer device may be directly connected to the physical connector via wires, or via a classical hub (not shown).

The pointer device may be a wireless pointer device, e.g. a wireless mouse device, which communicates via a dongle connected to, e.g. inserted in the physical connector of the display.

The display may comprise an internal or external wireless RF transceiver 4238 for communicating with a wireless pointer device, e.g. via a Bluetooth protocol.

The generated visible object 4106L may have the shape of a square, or a square with rounded edges or rounded corners, or a rectangle, or a rectangle with rounded edges or rounded corners, or an elongated object, or an arrow or a hand, or any other suitable shape.

The object 4106L may consist of monochrome pixels, e.g. red or blue or black or yellow pixels, or any other suitable color. Alternatively, the object may have exactly two color, for example an inner color and a peripheral color (e.g. black), for example for forming a larger contrast. But the visible objects may also contain more than two colors.

The object 4106L may be opaque, meaning that the user cannot see-through the object 4106L. In this case, the processor can generate the overlaid image by simply replacing some of the graphical image data from the computer by image data of the locally generated visible object, without having to mix data.

The object 4106L may be a semi-transparent monochrome object, e.g. having an alpha-transparency a in the range from 10% to 90%, e.g. about 25% or about 50% or about 75%. In this case the processor would alpha-blend or mix the graphical image data with the object data. In the case of 50% alpha-blending, the red, blue and green color components R1, G1, B1 of the graphical image data and the red, blue and green color components R2, G2, B2 of the pixels of the movable object can simply be averaged, which is an easy arithmetic operation, for example equivalent to the following calculation: R:=(R1 shr 1)+(R2 shr 1), and likewise for the other color components.

The object 4106L may be or may comprise a so called “perforated bitmap”, as explained in the co-pending “perforated bitmap application”. This bitmap may comprise a first plurality of fully transparent pixels and a second plurality of monochrome pixels, the first plurality of pixels and the second plurality of pixels are interleaved, for example according to a chessboard pattern.

This perforated bitmap can be overlaid in an opaque manner, as follows: In case a graphical image pixel from the computer image is to be overlaid by a fully transparent pixel, the result would be the original graphical image pixel. In case a graphical image pixel would be overlaid by a monochrome pixel, the result would be the monochrome pixel of the movable object.

This perforated bitmap can be overlaid in a semi-transparent manner, as follows: In case a graphical image pixel is to be overlaid by a fully transparent pixel, the result would be the original graphical image pixel. In case a graphical image pixel would be overlaid by a monochrome pixel, the result would be the alpha-blending or mix of the graphical image pixel from the computer image and the monochrome pixel of the movable object.

It is also possible to make the object 4106L appear semi-transparent by time-multiplexing between the graphical image pixels (coming from the computer device), and the image pixels of the movable object (generated inside the display). For example by using/displaying the monochrome pixels of the object 4106L at a first moment in time (e.g. at even frame numbers) and by using/displaying the graphical image data at a second moment in time (e.g. at odd frame numbers). This would mean for example that half of the frames would effectively show the visible object 4106L, and half of the frames would not, creating the impression of being “semi-transparent” (time averaged).

Comparison of FIG. 41 with FIG. 5(a) and FIG. 5(b) learns that the images on the screen may look exactly the same or very similar (assuming the same color and/or semi-transparency level are used). Thus, the embodiment of FIG. 41 also addresses the problem described in FIG. 1 to FIG. 3, but the computer device 4101 does not require the special overlay application and/or the special mouse and/or the special hub described above, only the display device 4104 needs to be “special”.

The computer system 4100 of FIG. 41 allows the user to move the left pointer device 4103L in order to move the position of the visible object 4106 on the screen, but of course clicking on that pointer device or scrolling the wheel thereof will not have the effect of selecting text or scrolling a document up or down. In other words, the embodiment of FIG. 41 does not solve the problem illustrated in FIG. 4.

In a variant of the display device shown in FIG. 42, the display device comprises at least two connectors for connecting to at least two pointer devices, and the processor 4233 is adapted for maintaining two pointer positions Pos1, Pos2, and for generating two visible objects, for example two lines similar to FIG. 32, or two squares similar to FIG. 33 or two hands similar to FIG. 34, and for positioning these two objects at said two maintained locations. With a computer system comprising such a display device, a user could use for example two dedicated pointer devices for comparing two text documents (e.g. when proofreading a translation), and use a third pointer device connected to the computer for editing or correcting.

The display device may have a further connector for connection to a removable non-volatile memory device, such as a memory-card or a USB-stick or the like, which may contain a file and a bitmap of the one or more visible objects to be displayed.

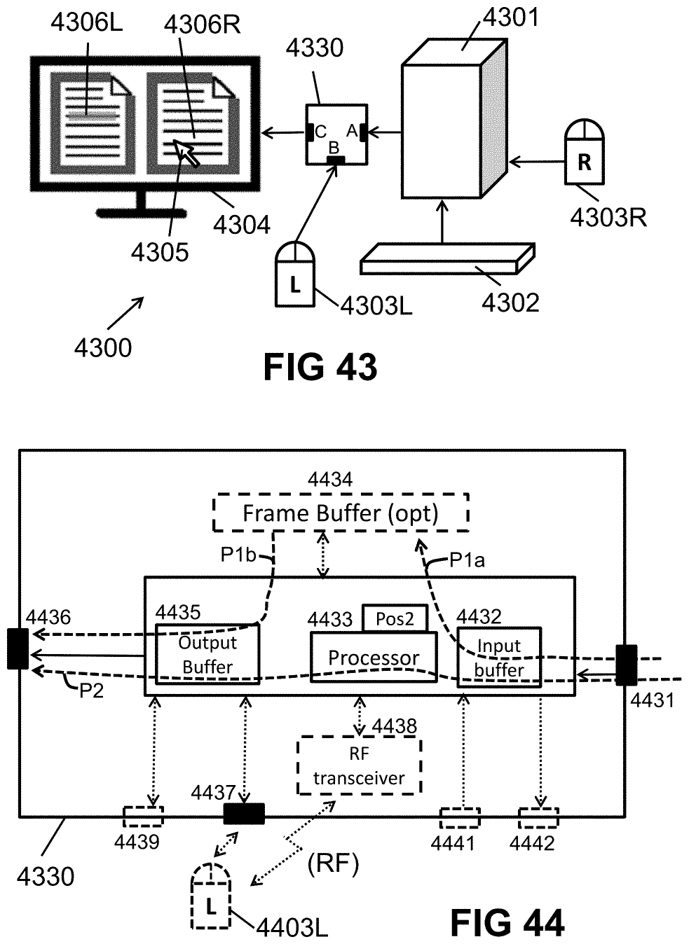

The inventors came to yet another idea to solve the problem illustrated in FIG. 1 to FIG. 3, also outside of the computer device 4301, namely by providing a special video adapter or video interface device 4330, connected between the computer device 4301 and the display device 4304, as illustrated in FIG. 43 and FIG. 44.

Many kinds of video adapters are known in the art, for example a video adapter for converting a HDMI signal into a VGA signal or vice versa. The video adapter may include one or more high-speed analog to digital converters ADC and/or one or more high speed digital-to-analog convertors DAC.

None of the existing video adapters maintains a position related to movements of a pointer device connected to said adapter, and none of these shows a visible object movable in accordance with these movements. And preferably, the video adapter 4330 according to embodiments of the present invention comprises a digital video input connector (e.g. a HDMI input connector) and a digital video output connector (e.g. a HDMI output connector), in which case the incoming video or graphical image data is digital, and also the outgoing video or graphical image data is digital, and the DAC(s) and the ADC(s) can be omitted.

FIG. 43 shows a computer system 4300 according to an embodiment of the present invention comprising a video adapter device 4330 according to an embodiment of the present invention. The video adapter 4330 has a video input port A, 4431 (for example a DVI or a HDMI port or a VGA port) for receiving first graphical image data from a computer device 4301. The computer device 4301 is connected to a first pointer device 4303R. The video adapter 4330 further comprises a video output port C, 4436 (for example a DVI or a HDMI port or a VGA port) for providing second graphical image data to a monitor or display 4304. The video adapter 4330 further comprises at least one interface (for example a physical connector such as a USB port, or an RF transceiver) for communicating with a second pointer device 4303L operatively connected to the video adapter. The video adapter 4330 is adapted for generating at least one visible object 4306L, for example having the shape of a square or a rectangle or a rectangle with rounded edges or rounded corners, or a circle or an arrow or a hand or a small cross or a large cross extending over the entire height and width of the display, or any other suitable shape, and for generating the second graphical image (to be sent to the display) by overlaying the first graphical image data (coming from the computer device) with said at least one visible object 4306L (generated internally), and for moving said at least one visible object 4306L in accordance with movements of said second pointer device 4303L.

The at least one visible object 4306L may have a monochrome color. The monochrome color may be predefined, for example red or green or blue or black or any other suitable color. Optionally the video adapter 4330 may have one or more buttons 4441 for selecting the monochrome color from a number of predefined colors.

The video adapter is adapted for generating at least one visible object 4306L and for overlaying the at least one visible object with the incoming graphical image data, e.g. by alpha-blending or otherwise mixing or combining the first graphical image data from the computer with the image data of the movable object. The at least one visible object may be an opaque or a semi-transparent object, or may have a so called perforated bitmap, as described in more detail in the co-pending “perforated bitmap application”. It can be understood by comparing FIG. 41 and FIG. 43 that also the embodiment of FIG. 43 solves the problems described in FIG. 1 to FIG. 3.

FIG. 44 shows an exemplary hardware block diagram of a video adapter 4330 as can be used in the computer system 4300 of FIG. 43, but the invention is not limited thereto. The video adapter 4330 of FIG. 44 comprises the following components:
a video input port 4431 for receiving first graphical image data from a computer device;
a video output port 4436 for providing second graphical image data to a display device;
an input buffer 4432 for storing at least a portion of said first graphical image data received at the input port;
a processor 4433 connected to said input buffer 4432, and adapted for generating second graphical image data based on said first graphical image data;
a wired and/or a wireless interface 4437, 4438 for communicating with a wired or a wireless pointer device 4403L;
the processor 4433 being further adapted for:
   communicating with said pointer device 4403L for receiving displacement information dx, dy related to movements of said pointer device 4403L;
   updating a position Pos2 based on said received displacement information dx, dy;
   generating a visible object 4306L;
   generating said second graphical image data by overlaying the first graphical image data with said generated visible object 4306L at said position Pos2.

The video adapter may further comprise a frame buffer 4434 operatively connected to said processor 4433, adapted for storing at least a portion of the first graphical image data received from the input buffer 4432, and for storing at least a portion of the second graphical data to be transmitted to the output buffer 4435. A frame buffer is however not absolutely required, e.g. in case the incoming video stream and the outgoing video stream has the same frame rate and resolution.

Optionally the video adapter 4330 may further comprise one or more buttons 4441, for example to allow the user to select a color and/or shape and/or size of the movable object 4306L.

Optionally the video adapter 4330 may further comprise one or more indicators, for example in the form of LEDs 4442 to provide information to the user.

The video adapter 4330 may comprise a memory device (not shown) comprising the input buffer and the output buffer and (if present also) the frame buffer.

However, the present invention is not limited to this specific embodiment, because other architectures may fulfil the same functionality. For example, if the clock-rate of the incoming video data and the outgoing video data is the same, the second graphical image can be generated in real-time, and the frame buffer may be omitted, and the generation of the visible object 4306L can in practice be implemented in real-time, together with the overlaying or alpha-blending operation. The person skilled in the art of designing video chips knows how this functionality can be implemented.

The video interface device 4330 may have additional interfaces, for example an additional USB port 4439 for connection to for example a USB memory stick which may for example comprise a bitmap of the movable object, and/or may further comprise a texture bitmap to be overlaid with the incoming video data, for example in a manner as described in the co-pending “perforated bitmap application”.

In an embodiment, the video interface device 4330 has an embedded RF transceiver 4438 for communicating with a wireless mouse and/or for communicating with the personal computer device, for example for configuring the video adapter device 4330, and/or for selecting said size or color of the object, etc. But such transceiver may also be provided externally, e.g. as a dongle connected to the connector 4437 or 4439.

In a variant of the video adapter device shown in FIG. 43 and FIG. 44, the video adapter comprises at least two connectors for connecting to at least two pointer devices, and the processor 4433 is adapted for maintaining two pointer positions Pos1, Pos2, and for generating two visible objects, for example two lines similar to FIG. 32, or two squares similar to FIG. 33 or two hands similar to FIG. 34, and for positioning these two objects at said two maintained locations. With a computer system comprising such a video adapter, a user could use for example two dedicated pointer devices for comparing two text documents (e.g. when proofreading a translation), and use a third pointer device connected to the computer for editing or correcting.

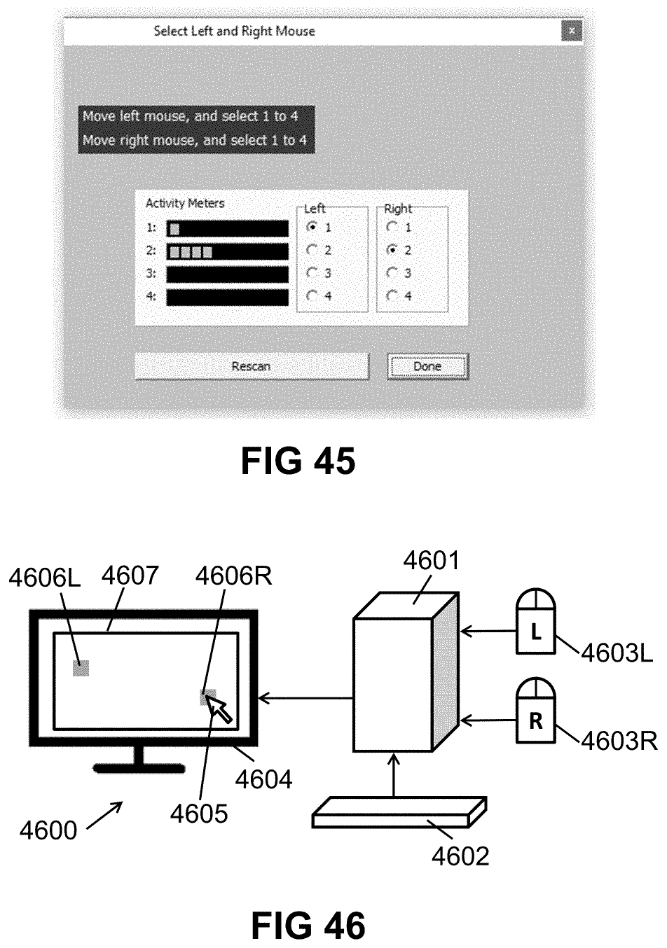

FIG. 45 shows a user-interface window which may be shown when starting the overlay-application. It allows a user to indicate which pointer devices connected to the computer are to be considered as the “left” and the “right” pointer device respectively, because, as described above, the Operating System may (and typically does) assign different device handles to the pointer devices after each restart of the computer device, even if the devices are not unplugged.

The user-interface window of FIG. 45 may be used instead of, or in combination with the activity meters shown in block XXXI of FIG. 29, also shown in FIG. 31(a) and FIG. 31(b). Allowing or forcing the user to select the pointer devices at the start-up of the program is easier and more convenient, especially for novel users.

The process works as follows: when the overlay-application starts, or when the “Rescan” button is pressed, the overlay application requests the Operating System to provide a list of input devices (e.g. in the case of Windows, using the function “GetlnputDeviceList”), and the list is filtered for pointer devices (e.g. in the case of Windows, by checking if the type is “RIM_TYPEMOUSE”), for example to remove keyboard devices. For each of these devices the corresponding “handle” assigned by Windows is stored in an array or list. When the user moves a particular pointer device, the pointer device sends movement messages to the computer device, the operating system sends raw messages to the overlay application, the message handler of the overlay application receives these raw messages, requests the operating system for the corresponding handle, and increments a counter related to this handle. The activity meters shown in FIG. 45 light up as a function of these counter values. The user does not need to know the value of the handle assigned by the O/S, but only needs to click in the column ‘left” or “right” which activity meter lighted up when moving a particular pointer device by the left hand, and the right hand respectively. Preferably the counters are periodically reset (e.g. every 500 ms).

The inventors are of the opinion that this way of indicating which pointer device is controlled by the left hand, and which pointer device is controlled by the right hand, using a plurality of graphical interface elements (e.g. “activity-meters”) related to counters, which counters are updated by the message handler, is not a trivial solution. Alternative solutions may for example be to show a list of pointer devices by name of manufacturer, and ask the user to select a particular name from the list.

In the example of FIG. 45, four “activity meters” are used, for example for a computer device having a touchpad and two mouse devices and a stylus connected thereto, or having a touchpad and three mouse devices connected thereto, etc. But of course, the invention is not limited to only four activity meters, and more than four or less than four activity meters may also be used.

The button “rescan” is useful for example if only a single pointer device was connected to the computer device when starting the overlay-application, and a second pointer device is connected after the overlay application has already been started.

Most of the embodiments described above describe computer systems with an overlay application which can be used in combination with an O/S and GUI to extend the functionality of the O/S and GUI for dual mouse support. These overlay applications show as least two visible objects, one of which is the windows native mouse cursor, which objects are individually movable in accordance with movements of two pointer devices.

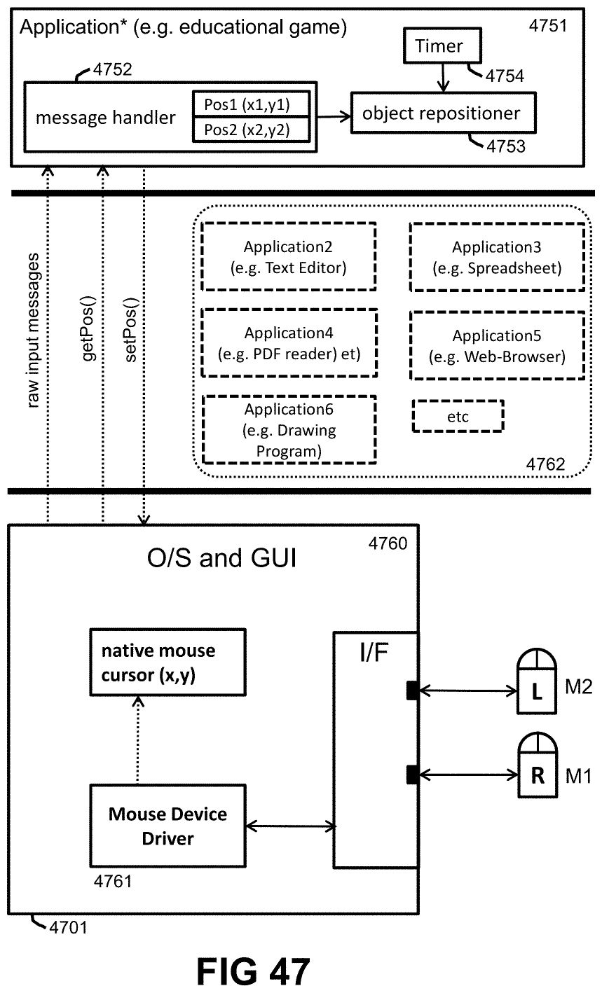

But the techniques described above for providing dual mouse support can also be used in a computer application as described next and as illustrated in FIG. 46 and FIG. 47. In some of these embodiments the native mouse is one of the at least two visible and movable objects. In some other of these embodiments, the native mouse cursor is hidden, and the application provides at least two other visible objects, which are movable in accordance with movements of two pointer devices.

FIG. 46 shows a computer system 4600 according to an embodiment of the present invention comprising a computer device 4601, which computer device 4601 runs said application that supports two pointer devices 4603L, 4603R.

This application may have at least one, for example a single window 4607, which is configured as opaque (not as semi-transparent), and is configured in non-click-through mode, and uses a message handler identical to or similar to the one shown in FIG. 5(g) or FIG. 7(e) or FIG. 9(c) or FIG. 13 or FIG. 18(a) or FIG. 18(b) or FIG. 18(c) to maintain two cursor positions Pos1, Pos2 in accordance with movements of two pointer devices 4703L, 4703R.

The application maintains a first pointer position in accordance with movements of the first pointer device, and maintains a second pointer position in accordance with movements of the second pointer device. In addition, the application adjusts, e.g. overrides the position of the native mouse pointer/cursor in accordance with movements of only the left pointer device (if configured for left handed people) or in accordance with movements of only the right pointer device (if configured for right handed people), or in according with the pointer device which is most recently moved (if configured for both-handed people), in a manner as described above. It is noted that the position of the native mouse cursor is also overriden in case the native mouse cursor is hidden, because the O/S and GUI will still process the pointer events, not only the movements (these are less important if the native mouse cursor is invisible), but also clicks and scrolls. Since the application is not configured in click-through mode, the native mouse cursor needs to be correctly positioned for correctly interpreting the clicks, even when the mouse cursor itself is invisible.

Such an application can for example be used as:
an educational game where a user (e.g. a child) has to indicate two corresponding objects, one with the left hand using the left pointer device, and a corresponding one with the right hand using the right pointer device, such as e.g. a flag and a country name, or a name of a capital city and a country name, or an image of an animal and the name of the animal,
an educational game to learn to read, where for example on the left side of the screen a plurality of pictures is shown, and on the right side of the screen a plurality of words is shown, and the person learning to read needs to indicate an object and the corresponding word, e.g. by moving a left pointer device over a rectangular box containing said picture and by moving the right pointer device over a rectangular box containing said word, and by optionally clicking on one of the pointer devices. The application may optionally show an image of a lamp which is illuminated when corresponding objects are indicated,
an educational game to learn a different language, where a word or text fragment is displayed in a first language for example on the left side of the screen, and a corresponding word or text fragment in a second language is displayed elsewhere on the screen, for example on the right side of the screen, and the user needs to move both visible objects over corresponding words or text fragments, an application for revalidation to practice motor skills,
a web-browser or a PDF document reader or a PDF document editor or a text document editor or a text document reader or a worksheet editor, supporting two pointer devices in much the same way as described in the embodiments shown in FIG. 1 to FIG. 40.

It is noted that the movements of the objects 4606L, 4606R may be based on a timer, but that is not absolutely required, and other ways to move the objects can also be used.

FIG. 47 shows a simplified high-level block diagram of hardware and software components situated in the exemplary computer system 4600 according to an embodiment of the present invention, comprising a computer device 4601 according to an embodiment of present invention with a special application (e.g. an educational game) according to an embodiment of the present invention. In the embodiment shown in FIG. 47 two classical pointer devices M1, M2 are operatively connected to the computer device 4601.

In a variant of the embodiment of FIG. 47, two classical mouse devices are connected to the computer device via a classical hub, or via a special hub having the “move before click” feature as described above.

In a further or another variant of the embodiment of FIG. 47, two special mouse devices having the “move before click” feature as described above are connected to the computer device, directly, wired or wirelessly, or via a hub or dongle.

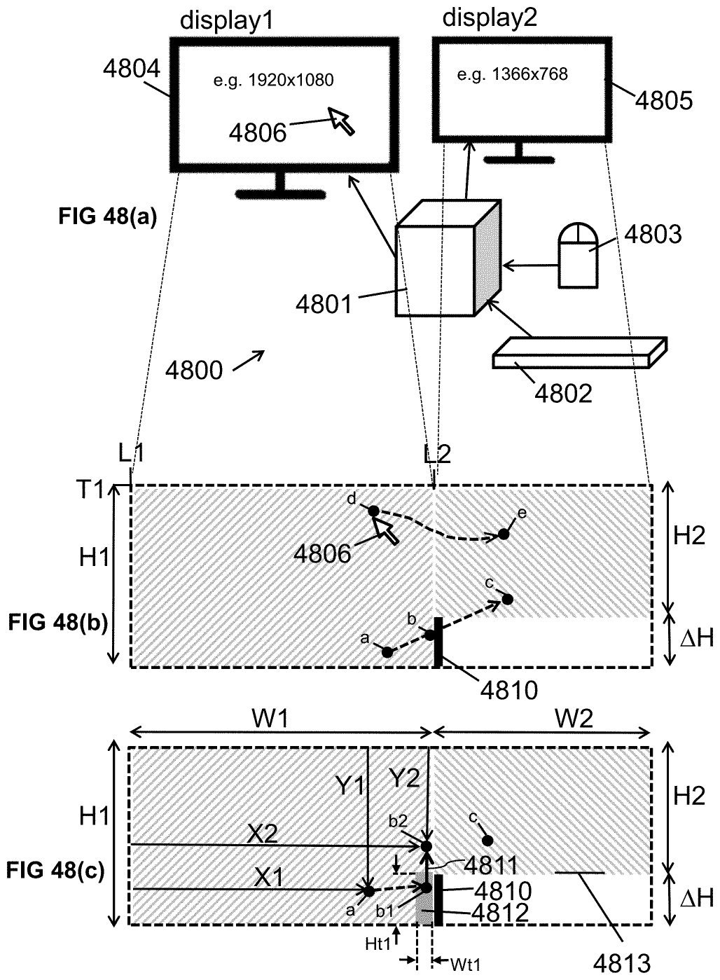

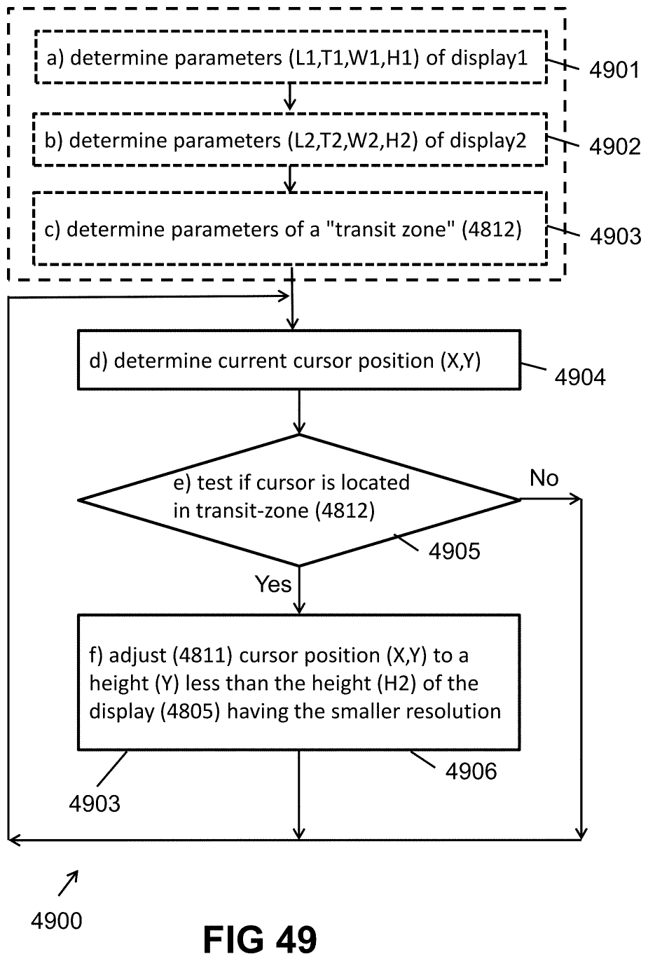

FIG. 48 to FIG. 49 illustrate another aspect of the present invention, related to a computer system 4800 comprising a computer device 4801 operatively connected to a first monitor or display or screen or display panel 4804 and a second monitor or display or screen or display panel 4805, further simply referred to as “display panels”. The two display panels having a different screen resolution, at least a different vertical screen resolution (also simply referred to as “height”).

FIG. 48(a) shows an exemplary computer system 4800 comprises a desktop computer 4801 having for example a first and a second HDMI output connector, the first HDMI connector connected to a first display panel 4804 having for example a resolution of 1920×1080 pixels, the second HDMI connector connected to a second display panel 4805 having for example a resolution of 1366×768 pixels, but of course the present invention is not limited thereto, and display panels with different resolutions can also be used.

Another example is a laptop computer (not shown) having an internal display panel with a resolution of 1366×768 pixels, and having a VGA or an HDMI output connector connected to an external display panel 4805 having for example a resolution of 1920×1080 pixels or 2560×1440 pixels, or 3840×2160 pixels, or another suitable resolution.

The computer device 4801 of FIG. 48(a) runs an operating system (for example a version of Microsoft Windows or another suitable Operating System) that is configured to combine the two display areas as a single (extended) display area. As is known in the art, this allows a user to show larger objects, for example to show a larger portion of an excel sheet.

FIG. 48(b) shows a first movement path of a mouse cursor 4806 from a position “d” physically located on the first display panel 4804, to a point “e” physically located on the second display panel 4805. This movement goes “smoothly” at a logical level (in memory space), but of course, if the two display panels are physically spaced apart, the mouse cursor “jumps” in “real space” from one display to the other. The latter aspect is not relevant for the present invention.

FIG. 48(b) also shows a very annoying problem typically encountered by users of such a computer system 4800 when trying to move the mouse cursor 4806 from a position “a” near the bottom of the larger display area (with height or vertical resolution H1) to a position “c” near the bottom of the smaller display area (with height H2 smaller than H1). When the mouse pointer 4806 is moved along the dotted line or curve from point “a” to “b”, the mouse cursor seems to encounter a virtual wall 4810, preventing the cursor 4810 from moving further along the dotted line. Many users do not immediately realize that the mouse cursor 4806 has stalled, inter alia because the mouse cursor image is typically very small, and because users are expecting the mouse cursor 4806 to appear on the second display area 4805 and are already watching the second display panel 4805. It often takes a while before the user realises the mouse cursor 4806 is not coming, and before he looks back to the first panel 4806 to see the mouse cursor 4806 cannot pass the virtual wall 4810. This is annoying and time consuming.

This problem already exists for many decades, and millions of users face this problem every day, yet no solution seems to be available.

The inventors of the present invention found a solution illustrated in FIG. 48(c), by making use of a “forbidden zone” or “transit zone” 4812 located in the direct vicinity of the virtual wall 4810. The transition zone 4812 is indicated in dark gray color, and the virtual wall is indicated as a thick black line, for illustrative purposes

FIG. 49 shows a flow chart of a computer implemented method, where in step 4905 it is tested whether the mouse cursor 4806 is located in said “transition zone” 4812, and if the outcome of this test is TRUE, the position X,Y of the mouse cursor 4806 is adjusted to a position outside the transition zone, preferably to a position “b2” higher than the bottom 4813 of the second display panel 4805 having the smaller vertical screen resolution H2, preferably my means of a pure vertical shift.

Referring to FIG. 48(c), the typical effect of this automatic upward movement or shift outside the forbidden zone 4812 is that, when the mouse cursor 4806 is being moved by the user from position “a” to position “b1” (between “a” and “c”), the mouse cursor 4806 will automatically jump (see arrow 4811) to position “b2”, such that, when the user further moves the pointer device 4803 to the right, the mouse cursor 4806 will indeed move further to the right onto the second display panel 4805, rather than being blocked by the virtual wall 4810.

The jump or shift 4811 is preferably pure vertical, meaning that the X-coordinate can be left unchanged. The vertical position Y2 of the point “b2” may be a predefined number of pixels above the bottom 4813 of the display panel 4805 with the smaller vertical resolution H2, as can be expressed by:

Y2=H2−A,

where H2 is the vertical resolution of the smaller display panel, and A is a predefined constant, for example A being a value in the range from 0 to 100, for example equal to about 10 or about 20 or about 30 or about 40 or about 50 or about 60 or about 70 or about 80 or about 90. Alternatively, the vertical position Y2 of the point “b2” may depend on the vertical position Y1 of the point “b1” inside the forbidden zone 4812 before the jump took place, for example as expressed by the following formula:

Y2=Y1−ΔH,

where ΔH=H2−H1, H2 is the smaller vertical resolution and H1 is the larger display resolution. Or more generally, the position Y2 may be determined based on a linear combination of the values Y1 and H1 and H2, as may be expressed by the following formula:

Y2=A*Y1+B*H2+C*H2

where A, B and C are predefined constants.

The transition zone 4812 is preferably a relatively narrow rectangular zone. The height Ht1 of this rectangular zone 4812 is preferably equal to or optionally slightly larger than the height ΔH=H1−H2 of the virtual wall 4810, for example from 1 to 50 pixels larger, for example from 1 to 40 pixels larger or from 1 to 30 pixels larger, or from 1 to 20 pixels larger. The width Wt1 of this rectangular zone 4812 is preferably less than 10 pixels, for example less than 5 pixels, for example less than 4 pixels, for example less than 3 pixels, for example less than 2 pixels. In the example of FIG. 48(c), the location of the transition zone 4812 is at the bottom right corner of the larger display panel 4804, but that is not absolutely required, and the transition zone 4812 may also be located at the bottom left corner of the larger display, as would be the case if the smaller display panel 4805 were logically located (in memory space) at the left of the larger display panel 4804.

Tests have shown that a transition zone 4812 having a width Wt1 even as small as only 1 pixel or only 2 pixels or only 3 pixels is sufficient to allow smooth displacement of the mouse cursor 4806 from point “a” to point “c”, via point “b1” and point “b2”, thanks to the automatic jump or shift 4811 outside of the transition zone 4812, thereby preventing the mouse cursor 4806 from stalling in point “b1”.

In contrast to the prior art, this gives the impression to the user that there is no virtual wall 4810. It is an advantage of choosing the width Wt1 of the transition zone 4812 relatively small because it allows the user to reach pixels located near the bottom right corner of the first display zone 4804 (in the example of FIG. 48c), or near the bottom left corner in another example (not shown) where the second panel 4805 is logically located on the left side of the first display panel 4804.

In a variant of the embodiment shown in FIG. 48(c), the transition zone 4812 does not overlap with the “taskbar”, but is located above the taskbar, when the taskbar is located at the bottom of the first display panel. The region 4812 may for example have the same left edge, top edge and right edge as the grey zone 4812 shown in FIG. 48c, thus also the same width Wt1, but the bottom edge would be located above the taskbar (e.g. about 30 to 100 pixels higher than the bottom of the first display panel. This has the advantage that the mouse pointer can be moved to the right bottom corner of the first display panel (if the taskbar of the operating system is located there), without the risk of being automatically moved upwards.

From a software implementation point of view, this “automatic jump outside of the forbidden zone” functionality may be implemented in the overlay application described above, as an additional feature, but that is not absolutely required, and the solution can also be implemented in a stand-alone overlay application, or even in a stand-alone non-overlay application, such as e.g. a desktop application, or as a software module part of the operating system, or in any other suitable way.

This solution can be used in a computer system having only a single pointer device 4803.

The solution can also be used in a computer device having or connected to multiple pointer devices, as described above. In these embodiments, the “automatic jump out of the forbidden zone” functionality can also be applied to one or both of the maintained positions Pos1 and/or Pos2 associated with the left and right pointer device. For example, in cases where a perforated bitmap or textured bitmap is overlaying only one of the display panels but not the other, the “automatic jump” functionality may be applied only to movements of the dominant pointer device (which moves along with the native mouse cursor), but not to movements of the non-dominant pointer device (e.g. associated with a visible rectangle which is only visible on one of said display panels).

FIG. 49 shows a flow diagram of a computer implemented method 4900 for addressing this problem. This method can for example be executed periodically, for example based on a timer interrupt having a period in the range from about 1 ms to about 200 ms, or in the range from about 5 ms to about 100 ms, for example having a period of about 10 ms or about 16.66 ms (60 Hz) or about 20 ms (50 Hz) or about 30 ms or about 40 ms or about 50 ms or about 75 ms, or about 100 ms. The smaller this period, the faster the routine detects that the mouse cursor 4806 is inside the transit zone, and moves the mouse cursor out of this zone, but tests have shown that this period is not critical. And even a small delay (e.g. less than 100 ms) or hick-up is much less annoying than a complete blockage against the virtual wall 4810.

In step a) parameters of the first display 4804 are determined, for example its left position L1, its top position T2, its width W1, its height H1, in the example above, respectively equal to the value 0, 0, 1920 and 1080.

In step b) parameters of the second display 4805 are determined, for example its left position L2, its top position T2, its width W2, its height H2, in the example above, respectively equal to the value 1920, 0, 1366 and 768. It is assumed that the height (or vertical resolution) H2 is different from the height (or vertical resolution) H1, in the example 1080 is indeed larger than 768.

In step c) parameters of a “forbidden zone” or “transition zone” 4812 are determined, for example the coordinates of the upper left corner and bottom right corner. In the example show in FIG. 48(c) where the first display panel 4804 has a resolution of 1920×1080 pixels, and the second display panel 4805 has a resolution of 1366×768 pixels, and where the first display panel 4804 is located on the left side of the second display panel 4805 (since L1=0<L2=1920), a suitable transition zone 4812 can for example be defined as a rectangular area having a width Wt1 in the range from 1 to 10 pixels, and having a height Ht1 of at least 1080−768=312 pixels, or slightly more, for example at most 50 pixels more, thus having a height in the range from 312 to 362 pixels.

In an embodiment the width Wt1=1 or 2 or 3 pixels and the height Ht1=ΔH=H1−H2.

The following steps are performed at least once, preferably repeatedly:

In step d) the current position X,Y of the mouse cursor 4806 is determined 4904.

In step e) it is tested 4905 whether the determined position is located in the transition zone (also referred to herein as “forbidden zone”) 4812.

If the outcome of the test is TRUE, step f) is performed, wherein the position X,Y of the mouse cursor 4806 is adjusted, e.g. overruled to a position outside the transit zone 4812, higher than the virtual wall 4810. Preferably the X-coordinate of the point “b2” is identical to the X-coordinate of the position “b1”, although the invention would also work with a slightly different value.

Step d), e) and optionally f) are preferably repeated.

An advantage of choosing the width Wt1 equal to only 1 pixel is that the risk of unintentionally triggering the automatic jump is minimized.

An advantage of choosing the position “b2” somewhat higher than the bottom 4813 of the second display panel 4805, e.g. 20 to 50 pixels higher, is that a larger portion of the bitmap of the mouse cursor 4806 will become visible, or the entire bitmap, and thus is easier to see and track.

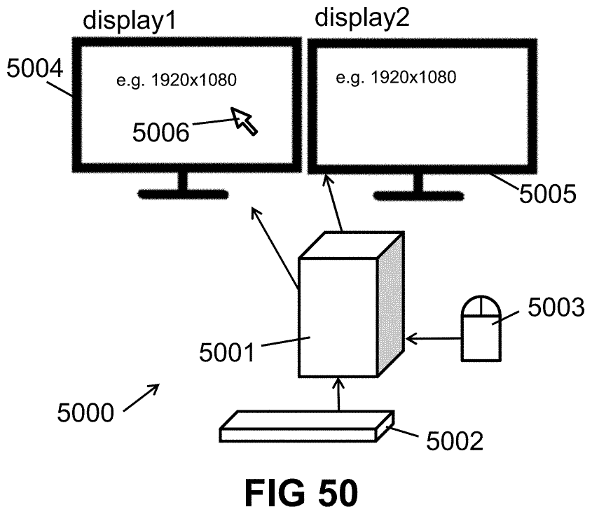

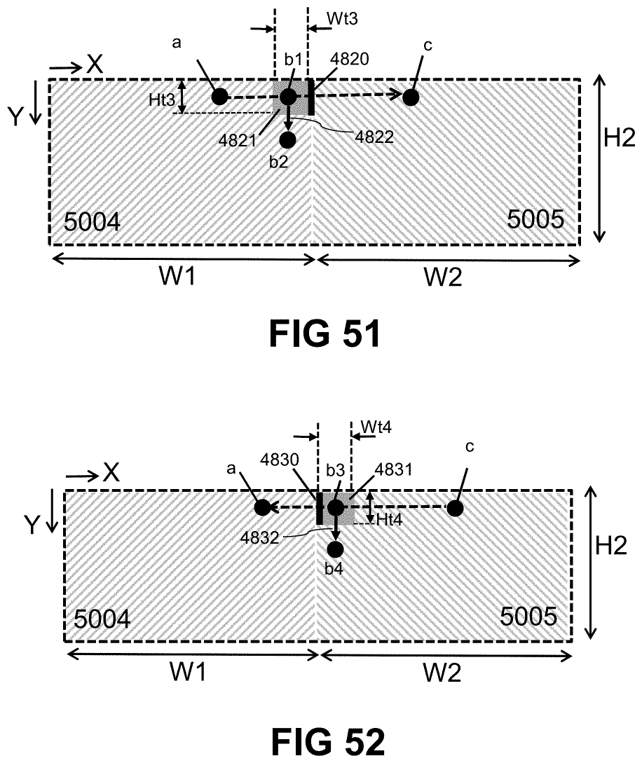

FIG. 50 to FIG. 53 illustrate another aspect of the present invention, related to a computer system 5000 comprising a computer device 5001 operatively connected to two display panels 5004, 5005 having the same screen resolution or having a different screen resolution. It is noted that FIG. 51 and FIG. 52 are not drawn to scale for illustrative purposes.

FIG. 51 illustrates a virtual wall 4820 encountered at the top right corner of the first display panel 5004, which is typically encountered when trying to move the mouse cursor 5006 from point “a” located near the top on the first display panel to point “c” located near the top on the second display panel (from left to right in FIG. 51). This problem occurs at least in Microsoft Windows 10. Further investigation of this problem has revealed that the height Ht3 of the virtual wall 4820 is about 5 or 6 pixels high. This problem not only occurs with display panels 5004, 5005 having different vertical resolutions, but also occurs when the display panels have the same vertical resolution. This is annoying and time-consuming for a user.

The solution proposed by the present invention is to provide a computer implemented method similar to the one shown in FIG. 49, wherein it is tested whether the mouse cursor 5006 is located in a third forbidden zone 4821 (shown in dark gray in FIG. 51), and if the outcome of that test is TRUE, to adjust the Y-coordinate of the mouse cursor 5006 to a value larger than the height Ht3 of the virtual wall 4820, for example to a value Y of at least 6 or at least 7. While these values work for Windows 10, of course the present invention is not limited thereto.

The forbidden zone 4821 preferably has a width Wt3 of about 1 to 10 pixels, for example a width of only 1 pixel, or only 2 pixels, or only 3 pixels, or less than 5 pixels, or less than 8 pixels. The forbidden zone 4821 preferably has a height Ht3 of about five or about six pixels.

Preferably the mouse cursor is moved outside the forbidden zone 4821 while leaving the X-coordinate of the mouse cursor 4822 unchanged. This will cause a vertical jump of shift from point “b1” inside the forbidden zone 4821 to point “b2” underneath the forbidden zone. The automatic jump outside of the forbidden zone 4820 has the technical effect that the mouse cursor 5006 is no longer blocked by the virtual wall 4820, although a small delay or hick-up may still appear, but that is much less annoying than a complete blockage.

FIG. 52 illustrates a similar problem when moving the mouse cursor from the second display panel 5005 (on the right of FIG. 52) to the display panel 5004 (on the left of FIG. 52). When trying to move the mouse cursor from point “c” to point “a”, another virtual wall 4830 located near the top left corner of the second display panel 5004 is encountered, and the cursor is blocked.

This problem is very similar to that described in FIG. 51, namely that the mouse cursor 5006 is blocked by a virtual wall having a height of about 5 or about 6 pixels. The proposed solution is also very similar, namely by repeatedly testing whether the mouse cursor is located in a fourth forbidden zone 4831 (indicated in gray color), and if the outcome of this test is TRUE, to adjust the Y-coordinate of the mouse pointer 5006 to a value larger than the height Ht4 of the virtual wall 4830, for example to a value of at least 6 or at least 7, for example a value in the range from 8 to 15, somewhat larger than the value of 6 to provide some margin. In preferred embodiments, the width Wt4 may be a value in the range from 1 to 10 pixels, for example from 1 to 5 pixels, for example equal to 1 pixel, or equal to 2 pixels, or 3 pixels or 4 pixels. The height Ht4 of the forbidden zone 4831 may be at least 5 or at least 6 pixels, for example equal to 5 pixels or equal to 6 pixels or equal to 8 pixels.

The problem of FIG. 51 and FIG. 52 can be solved simultaneously by defining one larger forbidden zone having a width of about 1 to 10 pixels, for example equal to 2 pixels, or 4 pixels, or 6 pixels, or 8 pixels, or 10 pixels, and by testing whether the mouse cursor is located in this combined forbidden zone, and if the outcome is TRUE, to set the Y-coordinate of the mouse cursor to a value of at least 6, or at least 7 or at least 8, for example to a value equal to 6 or 7 or 8 or 9 or 10.

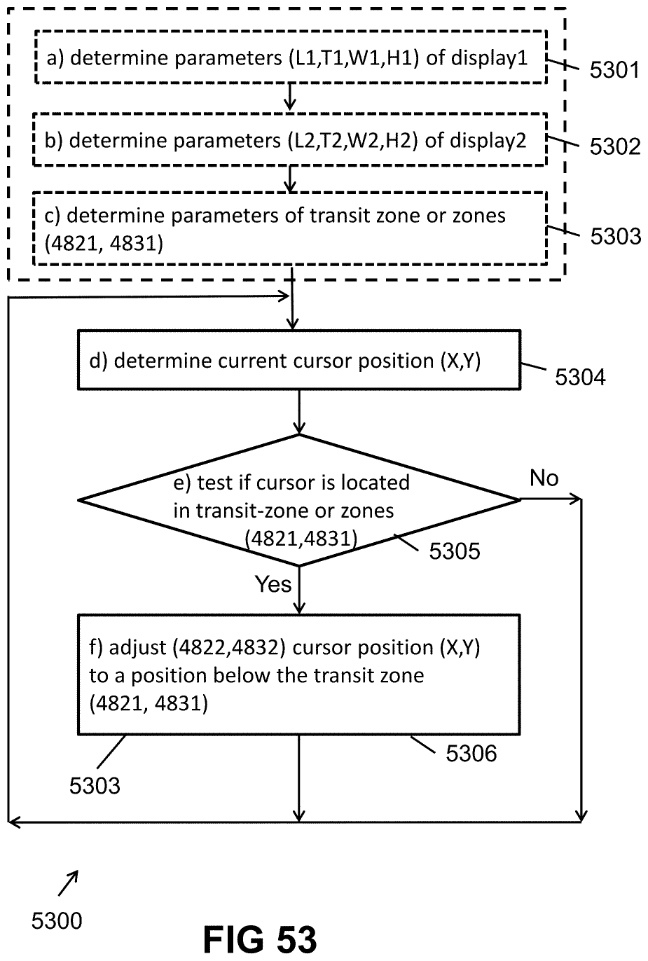

FIG. 53 shows a computer implemented method implementing this behaviour. This method can be seen as a variant of the method of FIG. 49.

In step a) parameters of the first display panel 5004 are determined, for example its logical position (left and top) and its horizontal and vertical resolution (also called height and width).

In step b) parameters of the second display panel 5005 are determined.

In step c) parameters of a “forbidden zone(s)” or “transition zone(s)” 4821, 4831 is/are determined, for example the coordinates of the upper left corner and bottom right corner.

In the example shown in FIG. 51 where the display panels both have a resolution of 1920×1080 pixels, a suitable transition zone 4821 can for example be defined as a rectangular area having a width Wt3 in the range from 1 to 10 pixels, for example 1 or 2 or 3 pixels wide, and having a height Ht3 from 5 to 10 pixels, for example a height Ht3 of about 6 or about 8 or about 10 pixels.

The following steps are performed at least once, preferably repeatedly:

In step d) the current position X,Y of the mouse cursor 5006 is determined.

In step e) it is tested 5305 whether the determined position X,Y is located in the transition zone or zones 4821, 4331.

If the outcome of the test is TRUE, step f) is performed, wherein the position X,Y of the mouse cursor 5006 is adjusted, e.g. overruled to a position outside the transit zone(s) 4821, 4831, higher than the height Ht3 of the virtual wall 4820, 4830. Preferably the X-coordinate of the point “b2” respectively “b4” is identical to the X-coordinate of the position “b1” respectively “b3”, although the invention would also work with a slightly different value.

Step d), e) and optionally f) are preferably repeated.

An advantage of choosing the width Wt3, Wt4 equal to only 1 pixel is that the risk of unintentionally triggering the automatic jump is minimized.

An advantage of choosing the position “b2” respectively “b4” somewhat lower than the bottom of the transition zone(s) 4821, 4831 is that the risk of inadvertently re-entering the transition zone is reduced.

Of course the method of FIG. 49 (avoiding the virtual wall at the bottom of the screen) and the method of FIG. 53 (avoiding the virtual wall at the top of the screen) can be combined.

In summary, the present invention provides inter alia:

A computer implemented method for providing at least a first visible object 505 movable by a first pointer device 503R, and at least one other visible object 506L separately movable by a second pointer device 503L, said first and second pointer device being connected to a computer device running an operating system O/S with a graphical user interface GUI that provides a native mouse cursor 505, the method comprising: a) configuring the O/S and GUI to provide said native mouse cursor as the first visible object; b) providing a graphical overlay window 584 comprising said at least one other visible object; c) configuring said graphical overlay window 584 in click-through mode; e) adjusting a position of the first/second visible object in accordance with movements of the first/second pointer device. A computer program product for performing said method. A computer device comprising said computer program product. A computer system.

A pointer device for use in a computer system that provides dual mouse support. The pointer device (M2*) comprising: a movement detection mechanism; and a controller connected to said movement detection mechanism, and adapted for sending a movement message (mov2) including displacement parameters (dx, dy) when a movement is detected; at least one button (M2b1) and a button detection mechanism for detecting if the at least one button (M2b1) is pressed or released; and optionally a scrollwheel and a scrollwheel-mechanism to detect if the scrollwheel is rotated; the controller being connected to said button detection mechanism and if present also to the scrollwheel-mechanism and being adapted to first send a dummy movement message (dmov) before sending a button-press message (press2) or a scrollwheel-rotation message. The dummy displacement parameters dx, dy are preferably very small. The pointer device may be a wired USB mouse or a wireless mouse.

A hub for use in a computer system that provides dual mouse support. A hub (2520) configured for exchanging messages between two pointer devices and a computer device, the hub comprising a processor that, upon receipt of a button-press message (press1, press2) from a pointer device, first sends a dummy movement message (dmov1) to the computer device before some time (ΔT) later sending the button-press message (press1) to the computer device, and that, upon receipt of a scrollwheel-rotation message from a pointer device, first sends a dummy movement message (dmov1) to the computer device before some time (ΔT) later sending the scrollwheel-rotation message to the computer device. The hub may discard messages from one pointer device when a button of the other pointer device is pressed. The dummy displacement parameters dx, dy are preferably very small. The hub may have connectors and/or an RF transceiver.

A display device (4104) for use in a computer system that provides dual mouse support, the display device (4101) comprising: a video input port for receiving first graphical image data from a computer device (4101); a display panel for generating a visual image; an input buffer and optionally a frame buffer; an interface for communicating with a pointer device (4103L), and a processor adapted for: receiving movement information (dx, dy) from the pointer device; for updating a position (Pos2) based on the received movement information (dx, dy); for generating visible object data (4106L); and for generating second graphical image data to be shown on the display panel by overlaying the first graphical image data with said generated visible object data (4106L) at said position (Pos2).

A video adapter device (4330) for use in a computer system (4300) that provides dual mouse support, the video adapter device comprising: a video input port (A) for receiving first graphical image data from a computer device (4301); a video output port (C) for providing second graphical image data to a display device (4304); an input buffer and optionally a frame buffer; an interface for communicating with a pointer device (4303L); and a processor adapted for: receiving movement information (dx, dy) from the pointer device; for updating a position (Pos2) based on the received movement information (dx, dy); for generating visible object data (4306L); and for generating second graphical image data to be shown on the display panel by overlaying the first graphical image data with said generated visible object data (4306L) at said position (Pos2).

A computer implemented method for providing at least a first visible object (4606R) and a second visible object (4606L) in a computer device (4601) comprising: an operating system (O/S) with a graphical user interface (GUI) that maintains only a single mouse or cursor position, such that the first visible object (4606R) is movable by a first pointer device (4606R) and the second visible object (4606L) is separately movable by a second pointer device (4603L); comprising the steps of: a) providing a graphical window (4607) with said first and second visible object; b) configuring the Operating System to send raw input messages related to the first and second pointer device, and providing a message handler (4712) to process these raw input messages; c) adjusting a position (Pos1) of the first visible object (4604R) in accordance with movements of the first pointer device (4603R) based on said raw input messages, and adjusting a position (Pos2) of the second visible object (4606L) in accordance with movement of the second pointer device (4603L) based on said raw input messages. A computer program product implementing this method. A computer device comprising this computer program product. A computer system comprising this computer device. A kit of parts comprising this computer program product and at least one of the following: one or two classical pointer device; or one or two special mouse devices; a classical hub; a special hub as described above (having the “move before click”-feature or the “move before scroll” feature).

A computer implemented method (4900) for allowing a smooth transition of a mouse cursor from a position (a) on a first display panel (4804) to a second position (c) on a second display panel (4805), the first and second display panel being operatively connected to a computer device (4801), the first display (4804) having a first vertical resolution (H1), and the second display (4805) having a second vertical resolution (H2) smaller than the first vertical resolution (H1), the computer device running an operating system (OS) with a graphical user interface (GUI) that provides a native mouse cursor (4805), by adjusting the position of the native mouse cursor when entering a forbidden zone near a virtual wall at a lower corner of the display panel having the higher vertical resolution, to a new position which is higher than the bottom of the display panel having the lower vertical resolution. A computer program product for performing this method. A computer device adapted for performing this method. A computer system comprising the computer device.

Finally, while individual features are explained in different drawings and in different embodiments of the present invention, it is contemplated that features of different embodiments can be combined, as would be obvious to the skilled person, when reading this document.

Even though the drawings are shown with only one display or monitor, the present invention also works with multiple monitors, where the first position Pos1 may be situated on a first monitor, and the second position Pos2 may be situated on a second monitor. In this way a user can easily switch back and forth between two documents shown on different screens.

It is explicitly pointed out that embodiments of the present invention (mainly directed to movable visible objects controlled by multiple pointer devices) can be combined with embodiments of the co-pending “perforated bitmap application”, (mainly directed to graphical overlay with a perforated bitmap, textured bitmap, movable line, movable cross, etc.) in any suitable way.

For example, the overlay window 584 of FIG. 5c & the overlay window 884 of FIG. 8c of the present application may further comprise a “perforated bitmap” or a semi-transparent “textured bitmap” as explained in the co-pending application.

As another example, the movable object(s) in embodiments of the present application may contain a perforated bitmap as explained in the co-pending application (e.g. FIG. 37 and FIG. 39).

While the present invention is explained for systems having only two pointer devices, the present invention will also work with more than two pointer devices connected to the same computer, for example with three pointer devices arranged so as to move two or three visible objects, in addition to the native mouse cursor.

1.-100. (canceled)

101. A computer implemented method for providing at least two visible objects comprising a first visible object (505) and at least one other visible object (506L; 706L, 706R) in a display device,
the first visible object (505) movable by a first pointer device (503R; 703R) and the at least one other visible object (706L) separately movable by a second pointer device (503L; 703L),
said first pointer device (503R; 703R) and said second pointer device (503L; 703L) being connected to a computer device having a processor running an operating system (O/S) with a graphical user interface that provides a native mouse cursor (505; 705);
the method comprising the steps of:
a) the processor configuring (571) the operating system (O/S) with the graphical user interface to provide said native mouse cursor as the first visible object (505) in the display device;
b) the processor providing (572) a graphical overlay window (584) comprising said at least one other visible object (506L; 706L, 706R) in the display device;
c) the processor configuring (573; 773) said graphical overlay window (584) in click-through mode;
e) the processor adjusting a position of the first visible object (505; 705) in accordance with movements of the first pointer device (503R; 703R);
and the processor adjusting a position of the at least one other visible object (506L; 706L) in accordance with movement of the second pointer device (503L; 703L).

102. The computer implemented method according to claim 101, the method further providing:
a third visible object (706R) movable by the first pointer device (703R);
the at least one other visible object comprising a second visible object (706L) separately movable by a second pointer device (703L);
the first visible object (705) selectively movable by a most recently moved and/or asserted pointer device chosen between the first pointer device (703R) and the second pointer device (703L);
wherein step b) comprises: the processor providing (772) a graphical overlay window comprising said second visible object (706L) and said third visible object (706R) in the display device.

103. The computer implemented method according to claim 102, wherein step e) comprises:
the processor adjusting a position of the first visible object (705) in accordance with movements and/or assertions of the most recently moved and/or asserted pointer device (703R; 703L);
the processor adjusting a position of the second visible object (706L) in accordance with movements of the second pointer device (703L);
the processor adjusting a position of the third visible object (703R) in accordance with movements of the first pointer device (703R).

104. The computer implemented method (570; 770) according to claim 101, further comprising step d) of:
d) the processor configuring (574; 774) the operating system (O/S) to send raw input messages related to the first and the second pointer device (503R, 503L), and the processor providing a message handler (552; 1152; 1252; 2352; 2452; 2552) to process these raw input messages; and
wherein step e) comprises:
the processor adjusting a position of the first visible object (505) based on said raw input messages; and
the processor adjusting a position of the at least one other visible object (506L; 706L, 706R) based on said raw input messages.

105. The computer implemented method (570; 770) according to claim 101, wherein step e) comprises:
the processor receiving (575; 775) an input message;
the processor updating a first pointer position (Pos1) in response to determining that the input message is related to the first pointer device (503R; 703R); and the processor updating a second pointer position (Pos2) in response to determining that the received input message is related to the second pointer device (503L; 703L);
the processor adjusting (577; 777) a position of the native mouse cursor (505; 705) and a position of the at least one other visible object (506L; 706L) in one of the following ways:
α) adjusting the position of the native mouse cursor (505) in accordance with the first pointer position (Pos1), and adjusting (578) the position of the at least one other visible object (506L) in accordance with the second pointer position (Pos2); or
β) adjusting the position of the native mouse cursor (505) in accordance with the second pointer position (Pos2), and adjusting (578) the position of the at least one other visible object (506L) in accordance with the first pointer position (Pos1); or
γ) adjusting the position of the native mouse cursor and the position of the at least one other visible object depending on whether the input message is related to the first pointer device (703R) or the second pointer device (703L), said adjusting the position of the native mouse cursor and the position of the at least one other visible object depending on whether the input message is related to the first pointer device (703R) or the second pointer device (703L) comprising:
adjusting the position of the native mouse cursor (705) in accordance with the first pointer position (Pos1) and adjusting (778) the position of the at least one other visible object (706L) in accordance with the second pointer position (Pos2) in response to determining that the input message is related to the first pointer device; and
adjusting the position of the native mouse cursor (705) in accordance with the second pointer position (Pos2) and adjusting (778) the position of the at least one other visible object (706R) in accordance with the first pointer position (Pos1) in response to determining that the input message is related to the second pointer device.

106. The computer implemented method according to claim 101,
wherein step e) comprises:
the processor receiving an input message, and the processor obtaining displacement values (dx, dy) related to said input message in response to determining that the input message comprises a movement message.

107. The computer implemented method according to claim 101, further comprising:
the processor configuring said graphical overlay window (584) as a semi-transparent window having an alpha-blending value (α) in the range from 1% to 99%.

108. The computer implemented method according to claim 101,
wherein the at least one other visible object comprises a second visible object; and
wherein only a minor portion of the area of the overlay window (584) is occupied by the second visible object (506L), and a major portion of the area of the overlay window (584) is occupied by fully transparent pixels; and/or
wherein the second visible object (3406L) and/or each further visible object (3406R) each occupies 1000 to 20000 pixels.

109. The computer implemented method according to claim 101,
the method being implemented by the processor in an overlay application; and
wherein the overlay application has an input mode selected from or selectable from a first input mode (RightHanded) and/or a second input mode (LeftHanded) and/or a third input mode (BothHanded); and
wherein step e) comprises at least one of the following options:
the processor adjusting the position of the native mouse cursor (505) in accordance with a first pointer position (Pos1) in response to determining that the overlay application is configured in the first input mode (RightHanded);
the processor adjusting the position of the native mouse cursor (505) in accordance with a second pointer position (Pos2) in response to determining that the overlay application is configured in the second input mode (LeftHanded); or
the processor selectively adjusting the position of the native mouse cursor (505) in response to determining that the overlay application is configured in the third input mode, said selectively adjusting the position of the native mouse cursor (505) comprising:
the processor adjusting the position of the native mouse cursor (505) in accordance with the first pointer position (Pos1) in response to determining that the received input message is related to a movement message (mov1) from the first pointer device (503R), and adjusting said position in accordance with the second pointer position (Pos2) in response to determining that the received input message is related to a movement message (mov2) from the second pointer device (503L).

110. The computer implemented method according to claim 109,
wherein the overlay application has a display mode selected from or selectable from a first group of display modes (2860) associated with the first input mode (RightHanded), and/or a second group of display modes (2850) associated with the second input mode (LeftHanded), and a third group of display modes (2870) associated with the third input mode (BothHanded); and
wherein step e) comprises performing at least one of the following steps:
the processor adjusting a position of the second visible object (506L) in accordance with the second position (Pos2) in response to determining that the display mode of the overlay application is selected from the first or third group of display modes (2060, 2070);
the processor adjusting a position of the second visible object (506L) in accordance with the first position (Pos1) in response to determining that the display mode of the overlay application is selected from the second group of display modes (2050).

111. The computer implemented method according to claim 109, wherein said at least one other visible object comprises a second visible object, step b) further comprising:
providing a third visible object (606R) comprised in the graphical overlay window; and
wherein step e) comprises performing the following steps at least once:
the processor adjusting a position of the second visible object (606L) in accordance with the second pointer position (Pos2) and adjusting a position of the third visible object (606R) in accordance with the first pointer position (Pos1).

112. A computer implemented method according to claim 109,
wherein the first pointer device (M1) comprises at least one button (M1b1) which can be pressed or released by a user, and wherein the second pointer device (M2) comprises at least one button (M2b1) which can be pressed or released by the user; and
wherein step e) comprises:
the processor testing if the received input message is related to a movement message (mov1) from the first pointer device (M1), and in response to determining that an outcome of this test is true, obtaining displacement information (dx, dy) and updating the first pointer position (Pos1); and
the processor testing if the received input message is related to a movement message (mov2) from the second pointer device (M2), and in response to determining that an outcome of this test is true, obtaining displacement information (dx, dy) and updating the second pointer position (Pos2); and
the processor testing if the received input message is related to the at least one button (M1b1) of the first pointer device (M1) being pressed, and in response to determining that an outcome of this test is true, setting a first button-state-variable (M1B1pressed) to TRUE; and
the processor testing if the received input message is related to the at least one button (M1b1) of the first pointer device (M1) being released, and in response to determining that an outcome of this test is true, setting a first button-state-variable (M1B1pressed) to FALSE; and
the processor testing if the received input message is related to the at least one button (M2b1) of the second pointer device (M2) being pressed, and in response to determining that an outcome of this test is true, setting a second button-state variable (M2B1pressed) to TRUE; and
the processor testing if the received input message is related to the at least one button (M2b1) of the second pointer device (M2) being released, and in response to determining that an outcome of this test is true, setting a second button-state variable (M2B1pressed) to FALSE; and
wherein step e) further comprises:
the processor adjusting a position of the native mouse cursor (505) in accordance with the first position (Pos1) in response to determining that the overlay application is configured in the first input mode (RightHanded);
the processor adjusting a position of the native mouse cursor (505) in accordance with the second position (Pos2) in response to determining that the overlay application is configured in the second input mode (LeftHanded);
the processor adjusting a position of the native mouse cursor (505) in accordance with the first position (Pos1) in response to determining that the overlay application is configured in the third input mode (BothHanded) and the received input message (mov1) is related to a movement of the first pointer device (M1) and the second button-state-variable (M2B1pressed) is FALSE;
the processor adjusting a position of the native mouse cursor (505) in accordance with the second position (Pos2) in response to determining that the overlay application is configured in the third input mode (BothHanded) and the received input message (mov2) is related to a movement of the second pointer device (M2) and the first button-state variable (M1B1pressed) is FALSE.

113. The computer implemented method according to claim 101, wherein step b) further comprises:
the processor providing a vertical visible line (3907; 4007) comprised in the graphical overlay window;
and wherein step c) comprises:
repeatedly performing the following steps:
the processor testing whether a position of the native mouse cursor (3905) is located on the vertical visible line (3907); and the processor configuring said graphical overlay window in click-through mode in response to determining that an outcome of the test is false; and the processor configuring the graphical overlay window in non-click-through mode in response to determining that the outcome of the test is true.

114. The computer implemented method according to claim 106, wherein step e) comprises:
the processor transforming the displacement values (dx, dy) so as to correspond with a displacement in a direction selected from a limited group of directions; or
wherein step e) comprises:
the processor transforming the displacement values (dx, dy) so as to correspond with a horizontal displacement or a vertical displacement; or
wherein step e) comprises:
the processor testing whether an angular distance between a displacement vector defined by the displacement values (dx, dy) and a horizontal line is smaller than a predefined angle, and transforming the displacement values (dx, dy) into horizontal displacement values in response to determining that an outcome of this test is true; or
the processor testing whether a ratio (rico) of the vertical displacement value (dy) and the horizontal displacement value (dx) is smaller than a predefined value, and transforming the displacement values (dx, dy) into horizontal displacement values in response to determining that an outcome to this test is true.

115. The computer implemented method according to claim 105,
wherein the first and second pointer device (503R, 503L) are HID compatible devices, and
wherein step d) comprises: the processor configuring the operating system (O/S) to send raw input data to the overlay application.

116. The computer implemented method according to claim 101,
wherein the operating system is Windows 7 or Windows 10 from Microsoft Corporation, or a later Windows version having the same or similar functionality regarding graphical overlay; or
wherein the operating system is mac OS Sierra or mac OS High Sierra or a later mac OS version from Apple Inc, or a later mac OS version having the same or similar functionality regarding graphical overlay.

117. A computer program product containing executable instructions which perform the method of claim 101, when being executed by a processor on a computer device (501; 601; 701; 801; 901; 1001; 1101; 1201; 2301; 2401; 2501; 3201; 3301; 3401; 3501; 3601; 3701; 3801; 3901; 4001) having or being connected to a display (504), and having or being connected to a first pointer device (503R) and having or being connected to a second pointer device (503L), the computer device (501) further comprising an operating system (O/S) with a graphical user interface (560; 1160; 1260; 2360; 2460; 2560) that provides said native mouse cursor (505).

118. A computer device (501; 601; 701; 801; 901; 1001; 1101; 1201; 2301; 2401; 2501; 3201; 3301; 3401; 3501; 3601; 3701; 3801; 3901; 4001), comprising:
an operating system with a graphical user interface (560) providing a native mouse cursor (505); and
a computer program product according to claim 117.

119. A computer-implemented method of discovering which device handles are assigned by an operating system (O/S) to a first pointer device movable by a left hand of a user, and a second pointer movable by a right hand of a user, said first and second pointer device being connected to a computer device having a processor running said operating system (O/S) and running an overlay application performing a method according to claim 101,
the method of discovering comprising the steps of:
a) the processor requesting the operating system to provide a list of pointer devices;
b) the processor filtering the list so as to keep only pointer devices;
c) the processor requesting the operating system to provide for each pointer device in the list a corresponding handle;
d) the processor configuring the operating system (O/S) to send raw input messages;
e) the processor providing a message handler to process these raw input messages, the message handler comprising a plurality of counter values, and adapted for, when a raw movement message is detected, requesting the operating system for the handle associated with said raw movement message, and for increasing a counter value associated with said handle;
f) the processor showing a plurality of graphical elements indicative of said counter values in a display device;
g) the processor allowing a user to indicate which graphical element represents movements of the first pointer device movable by the left hand, and considering the handle corresponding to the graphical element indicated by the user as the handle assigned by the operating system to the first pointer device;
h) the processor allowing a user to indicate which graphical element represents movements of the second pointer device movable by the right hand, and considering the handle corresponding to the graphical element indicated by the user as the handle assigned by the operating system to the second pointer device.
